(19) United States
(12) Patent Application Publication
(10) Pub. No.: US 2012/0088687 A1
(43) Pub. Date: Apr. 12, 2012

(54) MicroRNAs (miRNA) as Biomarkers for the Identification of Familial and Non-Familial Colorectal Cancer

(75) Inventors: Ajay Goel, Dallas, TX (US); C. Richard Boland, Dallas, TX (US); Francesc Balaguer, Barcelona (ES); Meritxell Gironella i Cos, Barcelona (ES); Antoni Castells i Garangou, Barcelona (ES); Leticia Moreira Ruiz, Barcelona (ES); Juan Jose Lozano Salvatella, Barcelona (ES)

(73) Assignees: Baylor Research Institute, Dallas, TX (US); Centro de Investigacion en Red de Enfermedades Hepaticas y Digestivas (CIBEREHD), Barcelona (ES); Hospital Clinic de Barcelona, Barcelona (ES)

(21) Appl. No.: 13/269,059

(22) Filed: Oct. 7, 2011

Related U.S. Application Data
(60) Provisional application No. 61/391,585, filed on Oct. 8, 2010.

(51) Int. Cl. C40B 30/04; C40B 40/06

(52) U.S. Cl. 506/9; 506/16

(57) ABSTRACT

A technique for the analysis of global miRNA signatures including a larger panel of miRNAs in various groups of well-characterized colorectal cancers (CRCs) is described in the instant invention. The results presented herein provide a large list of miRNAs that are dysregulated in CRC compared to the normal colonic tissue, and, more importantly, the present invention shows for the first time that Lynch syndrome and sporadic MSI tumors exhibit a different miRNA signature that distinguishes them.

### CROSS-REFERENCE TO RELATED APPLICATIONS

This application is a non-provisional application of U.S. provisional patent application No. 61/391,585 filed on Oct. 8, 2010 and entitled “MICRORNAs (miRNA) AS BIOMARKERS FOR THE IDENTIFICATION OF FAMILIAL AND NON-FAMILIAL COLORECTAL CANCER” the entire contents of which is incorporated herein by reference.

### STATEMENT OF FEDERALLY FUNDED RESEARCH

This invention was made with U.S. Government support under Contract Nos. R01 CA72851 and CA129286 awarded by the National Cancer Institute (NCI)/National Institutes of Health (NIH). The government has certain rights in this invention.

### TECHNICAL FIELD OF THE INVENTION

The present invention relates in general to biomarkers for cancer detection, and more particularly, to the analysis of global microRNA (miRNA) signatures in various groups of well-characterized colorectal cancers (CRCs) based on the presence of microsatellite instability (MSI).

### REFERENCE TO A SEQUENCE LISTING

None.

### BACKGROUND OF THE INVENTION

Without limiting the scope of the invention, its background is described in connection with methods involving microRNAs (miRNAs) and other genetic markers for detecting colorectal cancer and other gastroenterological cancers.

WIPO Publication No. WO/2008/008430 (Croce et al. 2008) discloses a method of diagnosing whether a subject has, is at risk for developing or has a decreased survival prognosis for, a colon cancer related disease, comprising measuring the level of at least one miR gene product in a test sample from the subject, wherein an alteration in the level of the miR gene product in the test sample, relative to the level of a corresponding miR gene product in a control sample, is indicative of the subject either having, or being at risk for developing, the colon cancer related disease. At least one miR gene product is selected from the group consisting of miR20a, miR21, miR106a, miR181b, miR203 and combinations thereof. The sample comprises one or more of tissue, blood, plasma, serum, urine, and feces.

WIPO Publication No. WO/2008/127587 (Shi et al. 2008) provides an isolated nucleic acid molecule corresponding to miR145 that is useful in treating colon cancer. The disclosed miR145 nucleic acid specifically binds the 3′ UTR within endogenous IRS-I such as to suppress or inhibit colon cell proliferation.

U.S. Pat. No. 6,844,152 (Bacher et al. 2005) discloses methods and kits for use in the analysis of microsatellite instability in genomic DNA. Methods and kits are also disclosed which can be used to detect microsatellite instability DNA present in biological materials, such as tumors. The methods and kits of the present invention can be used to detect or diagnose diseases associated with microsatellite instability, such as certain types of cancerous tumors of the gastro-intestinal system and of the endometrium.

U.S. Pat. No. 7,326,778 (De La et al. 2008) describes the identification of the human MSH2 gene, responsible for hereditary non-polyposis colorectal cancer, by virtue of its homology to the MutS class of genes, which are involved in DNA mismatch repair. The sequence of cDNA clones of the human gene are provided and the sequence of the gene can be used to demonstrate the existence of germ line mutations in hereditary non-polyposis colorectal cancer (HNPCC) kindreds, as well as in replication error+ (RER+) tumor cells.

### SUMMARY OF THE INVENTION

The present invention describes the analysis of miRNA signatures in colorectal cancers (CRC) and provides a method of distinguishing between Lynch syndrome and sporadic microsatellite instability (MSI) based on the different miRNA signatures.

In one embodiment the instant invention provides a method for diagnosing a colorectal cancer (CRC) in a human subject comprising the steps of: i) identifying the subject suspected of having CRC, ii) obtaining one or more biological samples from the subject, wherein the biological samples are selected from the group consisting of a tissue sample, a fecal sample, a cell homogenate, and one or more biological fluids comprising blood, plasma, lymph, urine, cerebrospinal fluid, amniotic fluid, pus or tears, iii) obtaining expression patterns of one or more microRNAs (miRNAs) in the biological samples using a microarray, wherein the one or more miRNAs are either upregulated or downregulated in the tissue sample of the subject suspected of having the CRC, and iv) comparing the expression pattern of the miRNAs from the biological sample of the subject suspected of having the CRC, with a miRNA expression pattern in a tissue of a normal subject, wherein the normal subject is a healthy subject not suffering from CRC.

In one aspect of the instant invention an upregulation of one or more miRNAs is determined and the miRNAs are selected from the group consisting of miR-1238, miR-938, miR-1290, and miR-622 in the biological samples of the subject is indicative of the presence of the CRC. More specifically, the upregulation of 10, 20, 30, 40, 50 or more miRNAs selected from the group consisting of HS_{—}78, hsa-miR-1826, hsa-miR-647, hsa-miR-603, hsa-miR-622, HS_{—}33, HS_{—}19, hsa-miR-300, HS_{—}111, hsa-miR-1238, hsa-miR-1290, HS_{—}276.1, hsa-miR-544, HS_{—}79.1, solexa-4793-177, hsa-miR-196a*, solexa-8048-104, HS_{—}149, hsa-miR-938, HS_{—}239, hsa-miR-1321, hsa-miR-1183, hsa-miR-583, hsa-miR-302b*, solexa-9578-86, HS_{—}128, hsa-miR-220b, HS_{—}22.1, hsa-miR-1184, solexa-7764-108, hsa-miR-940, hsa-miR-923, hsa-miR-1228*, HS_{—}120, hsa-miR-18b*, solexa-9655-85, hsa-miR-801:9.1, hsa-miR-302d, HS_{—}72, HS_{—}38.1, hsa-miR-512-5pm, HS_{—}215, hsa-miR-31, hsa-miR-423-5p, hsa-miR-576-3p, hsa-miR-612, HS_{—}43.1, hsa-miR-7-1*, hsa-miR-346, hsa-miR-1268, hsa-miR-892a, HS_{—}208, hsa-miR-623, HS_{—}86, HS_{—}170, hsa-miR-563, hsa-miR-1181, hsa-miR-1289, HS_{—}241.1, hsa-miR-183*, hsa-miR-1269, HS_{—}9, hsa-miR-512-3p, hsa-miR-587, HS_{—}202.1, HS_{—}37, hsa-miR-936, hsa-miR-1231, HS_{—}250, hsa-miR-202*:9.1, HS_{—}254, hsa-miR-518b, hsa-miR-19a*, HS_{—}116, hsa-miR-450b-3p, HS_{—}48.1, hsa-miR-591, hsa-miR-25*, hsa-miR-665, hsa-miR-654-3p, HS_{—}74, HS_{—}217, HS_{—}71.1, hsa-miR-550*, hsa-miR-1291, hsa-miR-371-3p, hsa-miR-1245, hsa-miR-520e, hsa-miR-135a*, HS_{—}51, hsa-miR-298, HS_{—}228.1, solexa-15-44487, HS_{—}110, hsa-miR-1255b, hsa-miR-1285, HS_{—}44.1, HS_{—}29, hsa-miR-198, hsa-miR-551a, solexa-9081-91, HS_{—}35, HS_{—}167.1, hsa-miR-1225-5p, HS_{—}56, hsa-miR-654-5p, hsa-miR-1207-3p, hsa-miR-631, hsa-miR-920, hsa-miR-515-3p, hsa-miR-661, hsa-miR-508-5p, hsa-miR-566, solexa-8926-93, HS_{—}65, hsa-miR-218-2*, HS_{—}2, hsa-miR-509-5p, hsa-miR-1254, HS_{—}163, hsa-miR-135b*, HS_{—}205.1, hsa-miR-31*, hsa-miR-1273, HS_{—}106, HS_{—}4.1, HS_{—}23, hsa-miR-1304, HS_{—}139, HS_{—}287, HS_{—}46, HS_{—}155, hsa-miR-187*, hsa-miR-193b*, HS_{—}147, HS_{—}187, HS_{—}17, HS_{—}87, hsa-miR-935, HS_{—}244, hsa-miR-1197, HS_{—}216, solexa-9124-90, hsa-miR-1324, hsa-miR-548g, hsa-miR-619, hsa-miR-302b, hsa-miR-632, hsa-miR-380*, hsa-miR-572, hsa-miR-668, hsa-miR-767-3p, hsa-miR-520d-5p, hsa-miR-1248, hsa-miR-380, HS_{—}101, HS_{—}150, solexa-578-1915, hsa-miR-549, HS_{—}189.1, HS_{—}80, HS_{—}264.1, hsa-miR-614, HS_{—}76, HS_{—}21, hsa-miR-182*, hsa-miR-1182, HS_{—}126, hsa-miR-1244, hsa-miR-1250, hsa-miR-602, hsa-miR-518a-5p, hsa-miR-527, hsa-miR-518f, hsa-miR-124a:9.1, hsa-miR-944, hsa-miR-517*, HS_{—}109, hsa-miR-1303, HS_{—}94, hsa-miR-1247, hsa-miR-588, hsa-miR-675, hsa-miR-645, hsa-miR-1300, hsa-miR-767-5p, hsa-miR-1180, HS_{—}68, hsa-miR-1204, hsa-miR-560:9.1, solexa-3044-295, hsa-miR-1295, hsa-miR-616, HS_{—}206, HS_{—}58, hsa-miR-671:9.1, solexa-5620-151, hsa-miR-519d, solexa-826-1288, hsa-miR-608, hsa-miR-509-3p, HS_{—}45.1, HS_{—}32, HS_{—}174.1, HS_{—}200, HS_{—}243.1, HS_{—}284.1, HS_{—}89, HS_{—}77, hsa-miR-1234, HS_{—}242, hsa-miR-663b, solexa-2952-306, hsa-miR-1274a, hsa-miR-890, hsa-miR-1243, hsa-miR-95, solexa-555-1991, hsa-miR-222*, HS_{—}121, hsa-miR-554, hsa-miR-1246, hsa-miR-1207-5p, solexa-3927-221, HS_{—}100, hsa-miR-574-5p, hsa-miR-1202, HS_{—}199, hsa-miR-1260, hsa-miR-943, and HS_{—}262.1 in the biological samples of the subject is indicative of the presence of the CRC.

In another aspect a downregulation of one or more miRNAs is determined and the miRNAs are selected from the group consisting of miR-133b, miR-490-3p, miR-490-5p, miR-138, and miR-1 in the biological samples of the subject is indicative of the presence of the CRC. More specifically, the downregulation of 10, 20, 30, 40, 50 or more miRNAs selected from the group consisting of solexa-5169-164, hsa-miR-129*, hsa-miR-101*, hsa-miR-138, hsa-miR-598, hsa-miR-490-3p, hsa-miR-29b-2*, hsa-miR-365, hsa-miR-30c-2*, hsa-miR-133b, hsa-miR-133a, hsa-miR-551b, hsa-miR-192*, hsa-miR-337-3p, hsa-miR-125b-2*, hsa-miR-20b*, hsa-miR-137, hsa-miR-214*, hsa-miR-582-3p, hsa-miR-132*, hsa-miR-582-5p, hsa-miR-24-1*, hsa-miR-130a, hsa-miR-149, hsa-miR-1, hsa-miR-656, hsa-miR-139-5p, hsa-miR-490-5p, hsa-miR-181c, hsa-miR-30a*, hsa-miR-187, hsa-miR-33b, hsa-miR-145*, hsa-miR-20b, hsa-miR-340, HS_{—}209.1, hsa-miR-363, hsa-miR-570, hsa-miR-9, hsa-miR-340*, hsa-miR-497, hsa-miR-579, hsa-miR-545, hsa-miR-744*, hsa-miR-30e, hsa-miR-142-5p, hsa-let-71*, hsa-miR-323-3p, hsa-miR-642, hsa-miR-99a, hsa-miR-195*, hsa-miR-181a-2*, hsa-miR-26b*, hsa-miR-362-5p, hsa-miR-885-5p, hsa-miR-26a-1*, hsa-miR-628-3p, hsa-miR-136, hsa-miR-148b, hsa-let-7g*, hsa-miR-135a, hsa-miR-338-3p, hsa-miR-376a*, hsa-miR-454, hsa-miR-106b, hsa-miR-154*, hsa-let-7f-1*, hsa-miR-148a*, hsa-miR-27b*, hsa-miR-381, hsa-miR-212, hsa-miR-153, hsa-miR-34a*, hsa-miR-577, hsa-miR-144*, hsa-miR-127-5p, hsa-miR-411, hsa-miR-590-3p, hsa-miR-519a, hsa-miR-487b, hsa-miR-455-3p, hsa-miR-345, hsa-miR-199b-5p, hsa-miR-92b, hsa-let-7e*, hsa-miR-361-3p, hsa-miR-548p hsa-miR-502-3p, hsa-miR-500*, hsa-miR-186, hsa-miR-151:9.1, hsa-miR-30a, hsa-miR-221*, hsa-miR-9*, hsa-miR-136*, hsa-miR-26a-2*, hsa-miR-143*, hsa-miR-140-5p, hsa-miR-189:9.1, hsa-miR-130b, hsa-miR-374a, hsa-miR-128, hsa-miR-616*, solexa-3126-285, hsa-miR-766, hsa-miR-548e, hsa-miR-154, hsa-miR-486-5p, hsa-miR-597, HS_{—}194, hsa-miR-361-5p, hsa-miR-421, hsa-miR-127-3p, hsa-miR-195, hsa-miR-99a*, hsa-miR-337-5p, hsa-let-7a*, solexa-2580-353, hsa-miR-409-5p, hsa-miR-34b*, hsa-miR-16-2*, hsa-miR-30d*, hsa-miR-10b, hsa-miR-499-5p, hsa-miR-548c-5p, hsa-miR-148b*, hsa-miR-193a-3p, hsa-miR-342-3p, hsa-miR-410, hsa-miR-425*, hsa-miR-29c*, hsa-miR-495, hsa-miR-330-3p, hsa-miR-219-5p, hsa-miR-185, hsa-miR-329, hsa-miR-592, hsa-miR-433, hsa-miR-181c*, hsa-miR-193a-5p, hsa-miR-34c-5p, hsa-miR-124, HS_{—}49, HS_{—}282, hsa-miR-100, hsa-miR-299-5p, hsa-miR-128a:9.1, hsa-miR-455-5p, hsa-miR-101, hsa-miR-409-3p, hsa-miR-326, hsa-miR-379*, hsa-miR-328, hsa-miR-539, hsa-miR-331-3p, hsa-miR-1272, HS_{—}168, hsa-miR-374b*, hsa-miR-548m, hsa-miR-378*, hsa-miR-202*, hsa-miR-339-3p, hsa-miR-660, hsa-miR-576-5p, hsa-miR-296-5p, hsa-miR-451, hsa-miR-17*, hsa-miR-141*, hsa-miR-190b, hsa-miR-511, hsa-miR-20a*, hsa-miR-204, hsa-miR-1185, hsa-miR-624*, hsa-miR-655, hsa-miR-34b, hsa-miR-411*, hsa-miR-505, hsa-miR-15a, hsa-miR-454*, hsa-miR-22*, hsa-miR-18b, hsa-miR-144:9.1, hsa-miR-99b, hsa-miR-100*, hsa-miR-873, hsa-miR-10a*, hsa-miR-1537, hsa-miR-19b-1*, hsa-miR-505*, hsa-miR-29a*, hsa-miR-147, hsa-miR-485-3p, solexa-539-2056, hsa-miR-193b, HS_{—}42, hsa-miR-218, hsa-miR-19b, hsa-miR-106a:9.1, hsa-miR-378, hsa-miR-376c, hsa-miR-24-2*, hsa-miR-32, hsa-miR-197, hsa-miR-744, hsa-miR-7-2*, hsa-miR-335, hsa-miR-627, hsa-miR-139-3p, hsa-miR-629, hsa-miR-15b*, hsa-miR-107, hsa-miR-383, hsa-miR-147b, hsa-miR-19a, HS_{—}108.1, hsa-miR-301a, hsa-let-7b*, hsa-miR-345:9.1, hsa-miR-331-5p, hsa-miR-552, hsa-miR-1271, hsa-miR-550, hsa-miR-1296, HS_{—}20, hsa-miR-487a, hsa-miR-491-5p, solexa-3695-237, hsa-miR-374a*, solexa-7534-111, hsa-miR-128b:9.1, hsa-miR-188-3p, hsa-miR-33a, hsa-miR-129-3p, hsa-miR-23b*, hsa-miR-362-3p, hsa-miR-496, HS_{—}40, HS_{—}64, HS_{—}201, hsa-miR-1227, hsa-miR-125a-3p, hsa-miR-99b*, hsa-miR-542-3p, hsa-miR-142-3p, hsa-miR-571, hsa-miR-376a*:9.1, hsa-miR-493, solexa-2526-361, hsa-miR-585, hsa-miR-93*, hsa-miR-502-5p, hsa-miR-30e*, hsa-miR-145, hsa-miR-126, hsa-miR-222, hsa-let-7e, hsa-miR-30d, hsa-miR-28-5p, hsa-miR-30c, hsa-miR-199a*:9.1, hsa-miR-29c, HS_{—}275, hsa-miR-143, hsa-miR-125b, hsa-miR-26a, hsa-miR-141, hsa-miR-140-3p, hsa-miR-30b, and hsa-miR-338-5p in the biological samples of the subject is indicative of the presence of the CRC. In another aspect the CRC comprises Lynch syndrome, sporadic microsatellite instability (MSI) tumors or microsatellite stable (MSS) tumors. In yet another aspect the biological sample is a tissue sample, a fecal sample or a blood sample.

Another embodiment of the instant invention discloses a method for diagnosing a colorectal cancer (CRC) in a human subject comprising the steps of: identifying the subject suspected of having CRC, obtaining one or more biological samples from the subject, wherein the biological samples are selected from the group consisting of a tissue sample, a fecal sample, a cell homogenate, and one or more biological fluids comprising blood, plasma, lymph, urine, cerebrospinal fluid, amniotic fluid, pus or tears, and diagnosing the CRC by determining an expression of one or more microRNAs (miRNAs) in the biological sample of the subject suspected of having the CRC using a microarray, wherein the miRNAs are selected from the group consisting of hsa-miR-1238, hsa-miR-938, hsa-miR-622, hsa-miR-1290, hsa-miR-490-3p, hsa-miR-133b, hsa-miR-139-5p, hsa-miR-1, hsa-miR-138, hsa-miR-130a, hsa-miR-582-5p, hsa-miR-9, hsa-miR-149, hsa-miR-132*, hsa-miR-20b, hsa-miR-29-b2*hsa-miR-30a*, hsa-miR-598, hsa-miR-365, hsa-miR-24-1*, hsa-miR-99a, hsa-miR-192, hsa-miR-125b-2*, hsa-miR-337-3p, hsa-miR-340, hsa-miR-181c, hsa-miR-656, hsa-miR-454, hsa-miR-129*, hsa-miR-20b*, hsa-miR-363, hsa-miR-30c-2*, hsa-miR-137, hsa-miR-582-3p, hsa-miR-603, hsa-miR-647, hsa-miR-220b, hsa-miR-1228*, hsa-miR-1826, hsa-miR-583, hsa-miR-300, hsa-miR-214*, hsa-miR-101*, hsa-miR-1321, hsa-miR-1183, hsa-miR-1184, hsa-miR-302b*, hsa-miR-544, and hsa-miR-612, wherein the one or more miRNAs are absent in a biological sample of a normal or healthy subject not suffering from the CRC. In one aspect of the method disclosed hereinabove the CRC comprises Lynch syndrome, sporadic microsatellite instability (MSI) tumors or microsatellite stable (MSS) tumors. In another aspect the biological sample is a tissue sample, a fecal sample or a blood sample.

In yet another embodiment the instant invention provides a method for distinguishing between one or more types of colorectal cancers (CRC) characterized by microsatellite instability (MSI) in a human subject comprising the steps of: identifying the human subject having the CRC characterized by MSI, obtaining one or more biological samples from the subject, wherein the biological samples are selected from the group consisting of a tissue sample, a fecal sample, a cell homogenate, and one or more biological fluids comprising blood, plasma, lymph, urine, cerebrospinal fluid, amniotic fluid, pus or tears, and determining a differential expression signature for one or more microRNAs (miRNAs) in the biological samples using a microarray, wherein the one or more miRNAs are selected from the group consisting of hsa-miR-30a*, hsa-miR-16-2*, hsa-miR-362-5p, hsa-miR-486-5p, hsa-miR-337-3p, hsa-miR-642, hsa-miR-411, hsa-miR-214*, hsa-miR-187, hsa-miR-628-3p, hsa-miR-142-5p, hsa-miR-29b-1*, hsa-miR-361-3p, hsa-miR-501-3p, hsa-miR-139-5p, hsa-miR-192*, hsa-miR-128, hsa-miR-29b-2*, hsa-miR-26b*, hsa-miR-432, hsa-miR-92b, hsa-miR-502-3p, hsa-miR-34a*, hsa-miR-200c*, hsa-miR-130b, hsa-miR-598, hsa-miR-151:9.1, hsa-miR-130b*, hsa-miR-421, hsa-miR-1238, and hsa-miR-622, wherein an upregulation, a downregulation or both of the one or more miRNAs is indicative of the presence of Lynch syndrome or a sporadic microsatellite instability (MSI) tumor.

In one aspect of the method disclosed above the upregulation of 10, 20, 30, 40, 50 or more miRNAs is determined and the miRNAs are selected from the group consisting of hsa-miR-198, hsa-miR-31*, hsa-miR-183*, hsa-miR-935, hsa-miR-183, hsa-miR-891a, hsa-miR-182, hsa-miR-1275, hsa-miR-886-3p, hsa-miR-155*, hsa-miR-503, hsa-miR-664, hsa-miR-424*, HS_{—}303_b, hsa-miR-18a*, hsa-miR-594:9.1, hsa-miR-452*:9.1, hsa-miR-223, hsa-miR-625*, hsa-miR-29b-1*, hsa-miR-17-5p:9.1, hsa-miR-196b, hsa-miR-151-3p, solexa-51-13984, hsa-miR-200b*, hsa-miR-342-5p, hsa-miR-425, hsa-miR-203, hsa-miR-768-5p:11.0, hsa-miR-200a*, hsa-miR-30e*, hsa-miR-942, hsa miR-28-5p, hsa-miR-429, hsa-miR-30c, hsa-miR-126, hsa-miR-486-3p, hsa-let-7d, hsa-miR-382, hsa-miR-92a-1*, hsa-miR-224, hsa-miR-222, hsa-let-7e, hsa-miR-181a, hsa-miR-146b-5p, hsa-let-7c, hsa-miR-450b-5p, hsa-miR-370, hsa-miR-450a, hsa-miR-146a, hsa-miR-223*, hsa-miR-501-5p, hsa-miR-106b*, hsa-miR-181b, hsa-miR-134, hsa-miR-98, hsa-miR-106a, hsa-miR-889, hsa-miR-96, hsa-miR-132, hsa-miR-195, hsa-miR-1237, hsa-miR-451, hsa-miR-628-5p, hsa-miR-532-5p, hsa-miR-342-3p, hsa-miR-558, hsa-miR-10a, hsa-miR-215, hsa-miR-210, hsa-miR-10a*, hsa-miR-424, hsa-miR-432, hsa-miR-125a-5p, hsa-miR-500, hsa-miR-200c*, hsa-miR-130b*, hsa-miR-361-5p, hsa-miR-874, hsa-miR-374a, hsa-miR-32*, hsa-miR-335*, hsa-miR-100, hsa-miR-152, hsa-miR-652, hsa-miR-193a-5p, hsa-miR-34a, hsa-miR-10b, hsa-miR-15a, hsa-miR-106b, hsa-miR-574-3p, hsa-miR-455-3p, hsa-miR-499-5p, hsa-miR-335, hsa-miR-151:9.1, hsa-miR-23b*, hsa-miR-185, hsa-miR-941, hsa-miR-331-3p, hsa-miR-550, hsa miR-330-3p, hsa-miR-421, hsa-miR-744, hsa-let-7f-1*, hsa-miR-629, hsa-miR-433, hsa-miR-505*, hsa-miR-22*, hsa-miR-130b, hsa-miR-345, hsa-miR-532-3p, hsa-miR-542-5p, hsa-miR-339-5p, hsa-miR-193b, hsa-let-7d*, hsa-miR-199b-5p, hsa-miR-409-3p, hsa miR-148b, hsa-miR-190b, hsa-miR-18a, hsa-miR-29a*, hsa-miR-409-5p, hsa-miR-197, hsa-miR-708, hsa-miR-99a, hsa-miR-576-5p, hsa-miR-629*, hsa-miR-502-3p, hsa-miR-500*, hsa-miR-501-3p, hsa-miR-128, hsa-miR-19b-1*, hsa-miR-27b*, HS_{—}194, hsa-miR-92b, hsa-miR-130a, hsa-miR-577, HS_{—}108.1, hsa-miR-30e, hsa-miR-26a-1*, hsa-miR-32, hsa-miR-132*, hsa-miR-511, hsa-miR-145*, hsa-miR-221*, hsa-miR-454, hsa-miR-212, hsa-miR-34c-5p, hsa-miR-99b, hsa-miR-192*, hsa-miR-486-5p, hsa-miR-148a*, hsa-miR-30a, hsa-miR-16-2*, hsa-miR-107, hsa-miR-17*, hsa-miR-127-3p, hsa-let-7g*, hsa-miR-135a, hsa-miR-133a, hsa-miR-181a-2*, hsa-miR-101, hsa-miR-378*, hsa-miR-34a*, solexa-2580-353, hsa-miR-660, hsa-miR-154*, hsa-miR-497, hsa-miR-655, hsa-miR-144*, hsa-miR-362-5p, hsa-miR-339-3p, solexa-3126-285, hsa-miR-29c*, hsa-miR-30c-2*, hsa-miR-766, hsa-miR-26a-2*, hsa-miR-425*, hsa-miR-329, hsa-miR-323-3p, hsa-miR-338-3p, hsa-miR-186, hsa-miR-33b, hsa-miR-214*, hsa-miR-340, hsa-let-71*, hsa-miR-598, hsa-miR-26b*, hsa-miR-125b-2*, hsa-miR-29b-2*, hsa-miR-411, hsa-miR-487b, hsa-miR-361-3p, hsa-miR-181c, hsa-miR-628-3p, hsa-miR-326, hsa-miR-139-5p, HS_{—}209.1, hsa-miR-642, hsa-miR-616*, hsa-miR-505, hsa-miR-365, hsa-miR-656, hsa-miR-154, hsa-miR-20b, hsa-miR-363, hsa-miR-340*, hsa-let-7a*, hsa-miR-582-5p, hsa-miR-328, hsa-miR-337-3p, hsa-miR-30a*, hsa-miR-9, hsa-miR-24-1*, hsa-miR-187, hsa-miR-149, hsa-miR-142-5p, hsa-miR-101*, hsa-miR-1, hsa-miR-133b, hsa-miR-490-3p, hsa-let-7f, hsa-miR-15b, hsa-miR-199a*:9.1, and hsa-miR-30d in the biological samples of the subject is indicative of the presence of Lynch syndrome.

In another aspect of the method disclosed above the downregulation of 10, 20, 30, 40, 50 or more miRNAs is determined and the miRNAs are selected from the group consisting of hsa-miR-938, hsa-miR-1238, hsa-miR-1183, hsa-miR-892a, hsa-miR-622, solexa-7764-108, hsa-miR-1290, hsa-miR-623, hsa-miR-302d, hsa-miR-18b*, hsa-miR-603, hsa-miR-520e, hsa-miR-1268, HS_{—}217, hsa-miR-202*:9.1, HS_{—}202.1, hsa-miR-512-5p, hsa-miR-612, HS_{—}215, hsa-miR-302b*, HS_{—}111, hsa-miR-1197, HS_{—}149, hsa-miR-346, hsa-miR-1181, HS_{—}33, hsa-miR-647, HS_{—}78, hsa-miR-632, hsa-miR-1304, HS_{—}228.1, HS_{—}116, HS_{—}241.1, HS_{—}72, hsa-miR-196a*, HS_{—}276.1, hsa-miR-1184, hsa-miR-1225-5p, HS_{—}17, hsa-miR-654-3p, hsa-miR-124a:9.1, HS_{—}74, hsa-miR-518b, HS_{—}120, hsa-miR-654-5p, HS_{—}44.1, HS_{—}239 hsa-miR-380*, hsa-miR-1321, solexa-9081-91, hsa-miR-631, hsa-miR-423-5p, hsa-miR-936, hsa-miR-550*, hsa-miR-7-1*, HS_{—}37, HS_{—}79.1, hsa-miR-19a*, HS_{—}86, solexa-578-1915, hsa-miR-450b-3p, HS_{—}9, HS_{—}250, HS_{—}56, HS_{—}208, HS_{—}205.1, HS_{—}128, HS_{—}170, HS_{—}38.1, hsa-miR-576-3p, hsa-miR-583, hsa-miR-923, hsa-miR-940, HS_{—}19, hsa-miR-300, solexa-9655-85, hsa-miR-130a*, HS_{—}106, HS_{—}23, hsa-miR-220b, hsa-miR-187*, hsa-miR-1255b, hsa-miR-515-3p, hsa-miR-1289, solexa-15-44487, hsa-miR-563, hsa-miR-661, HS_{—}264.1, hsa-miR-135a*, hsa-miR-587, hsa miR-548g, HS_{—}51, hsa-miR-512-3p, hsa-miR-1254, HS_{—}71.1, hsa-miR-920, hsa-miR-371-3p, hsa-miR-665, hsa-miR-591, HS_{—}176, HS_{—}188, HS_{—}139, HS_{—}244, HS_{—}12, hsa-miR-1204, solexa-9578-86, hsa-miR-298, hsa-miR-551a, hsa-miR-520d-5p, hsa-miR-508-5p, hsa-miR-1231, hsa-miR-302b, HS_{—}101, HS_{—}48.1, hsa-miR-1228*, hsa-miR-498, hsa-miR-602, HS_{—}150, HS_{—}80, hsa-miR-518d-3p, HS_{—}216, hsa-miR-222*, hsa-miR-890, hsa-miR-1297, HS_{—}52, hsa-miR-554, HS_{—}93, hsa-miR-1243, hsa-miR-1202, HS_{—}97, hsa-miR-518e:9.1, hsa-miR-372, HS_{—}121, hsa-miR-1205, HS_{—}122.1, hsa-miR-525-5p, solexa-555-1991, hsa-miR-302c*, hsa-miR-1262, hsa-miR-518c*, hsa-miR-1233, hsa-miR-888, hsa-miR-33a*, hsa-miR-146a*, hsa-miR-412, hsa-miR-615-5p, hsa-miR-367*, hsa-miR-146b-3p, hsa-miR-1257, hsa-miR-1286, hsa-miR-609, hsa-miR-643, hsa-miR-519b-3p, hsa-miR-657, hsa-miR-384, hsa-miR-887, HS_{—}113, hsa-miR-1284, HS_{—}138, HS_{—}25, hsa-miR-488*, HS_{—}152, hsa-miR-1208, HS_{—}219, hsa-miR-607, hsa-miR-516a-3p, hsa-miR-516b*, hsa-miR-369-5p, hsa-miR-548b-3p, hsa-miR-548a-3p, hsa-miR-567, hsa-miR-1267, hsa-miR-578, HS_{—}184, hsa-miR-1206, hsa-miR-620, hsa-miR-186*, hsa-miR-596, hsa-miR-548c-3p, hsa-miR-1224-3p, hsa-miR-19b-2*, hsa-miR-218-1*, hsa-miR-1323, hsa-miR-876-3p, hsa-miR-1305, hsa-miR-1225-3p, hsa-miR-504, hsa-miR-650, hsa-miR-1179, hsa-miR-190, hsa-miR-376c, HS_{—}168, hsa-miR-144:9.1, hsa-miR-1826, and hsa-miR-544 in the biological samples of the subject is indicative of the presence of Lynch syndrome.

In yet another aspect the upregulation of 10, 20, 30, 40, 50 or more miRNAs is determined and the miRNAs are selected from the group consisting of hsa-miR-938, hsa-miR-1238, hsa-miR-1183, hsa-miR-892a, hsa-miR-622, solexa-7764-108, hsa-miR-1290, hsa-miR-623, hsa-miR-302d, hsa-miR-18b*, hsa-miR-603, hsa-miR-520e, hsa-miR-1268, HS_{—}217, hsa-miR-202*:9.1, HS_{—}202.1, hsa-miR-512-5p, hsa-miR-612, HS_{—}215, hsa-miR-302b*, HS_{—}111, hsa-miR-1197, HS_{—}149, hsa-miR-346, hsa-miR-1181, HS_{—}33, hsa-miR-647, HS_{—}78, hsa-miR-632, hsa-miR-1304, HS_{—}228.1, HS_{—}116, HS_{—}241.1, HS_{—}72, hsa-miR-196a*, HS_{—}276.1, hsa-miR-1184, hsa-miR-1225-5p, HS_{—}17, hsa-miR-654-3p, hsa-miR-124a:9.1, HS_{—}74, hsa-miR-518b, HS_{—}120, hsa-miR-654-5p, HS_{—}44.1, HS_{—}239 hsa-miR-380*, hsa-miR-1321, solexa-9081-91, hsa-miR-631, hsa-miR-423-5p, hsa-miR-936, hsa-miR-550*, hsa-miR-7-1*, HS_{—}37, HS_{—}79.1, hsa-miR-19a*, HS_{—}86, solexa-578-1915, hsa-miR-450b-3p, HS_{—}9, HS_{—}250, HS_{—}56, HS_{—}208, HS_{—}205.1, HS_{—}128, HS_{—}170, HS_{—}38.1, hsa-miR-576-3p, hsa-miR-583, hsa-miR-923, hsa-miR-940, HS_{—}19, hsa-miR-300, solexa-9655-85, hsa-miR-130a*, HS_{—}106, HS_{—}23, hsa-miR-220b, hsa-miR-187*, hsa-miR-1255b, hsa-miR-515-3p, hsa-miR-1289, solexa-15-44487, hsa-miR-563, hsa-miR-661, HS_{—}264.1, hsa-miR-135a*, hsa-miR-587, hsa miR-548g, HS_{—}51, hsa-miR-512-3p, hsa-miR-1254, HS_{—}71.1, hsa-miR-920, hsa-miR-371-3p, hsa-miR-665, hsa-miR-591, HS_{—}176, HS_{—}188, HS_{—}139, HS_{—}244, HS_{—}12, hsa-miR-1204, solexa-9578-86, hsa-miR-298, hsa-miR-551a, hsa-miR-520d-5p, hsa-miR-508-5p, hsa-miR-1231, hsa-miR-302b, HS_{—}101, HS_{—}48.1, hsa-miR-1228*, hsa-miR-498, hsa-miR-602, HS_{—}150, HS_{—}80, hsa-miR-518d-3p, HS_{—}216, hsa-miR-222*, hsa-miR-890, hsa-miR-1297, HS_{—}52, hsa-miR-554, HS_{—}93, hsa-miR-1243, hsa-miR-1202, HS_{—}97, hsa-miR-518e:9.1, hsa-miR-372, HS_{—}121, hsa-miR-1205, HS_{—}122.1, hsa-miR-525-5p, solexa-555-1991, hsa-miR-302c*, hsa-miR-1262, hsa-miR-518c*, hsa-miR-1233, hsa-miR-888, hsa-miR-33a*, hsa-miR-146a*, hsa-miR-412, hsa-miR-615-5p, hsa-miR-367*, hsa-miR-146b-3p, hsa-miR-1257, hsa-miR-1286, hsa-miR-609, hsa-miR-643, hsa-miR-519b-3p, hsa-miR-657, hsa-miR-384, hsa-miR-887, HS_{—}113, hsa-miR-1284, HS_{—}138, HS_{—}25, hsa-miR-488*, HS_{—}152, hsa-miR-1208, HS_{—}219, hsa-miR-607, hsa-miR-516a-3p, hsa-miR-516b*, hsa-miR-369-5p, hsa-miR-548b-3p, hsa-miR-548a-3p, hsa-miR-567, hsa-miR-1267, hsa-miR-578, HS_{—}184, hsa-miR-1206, hsa-miR-620, hsa-miR-186*, hsa-miR-596, hsa-miR-548c-3p, hsa-miR-1224-3p, hsa-miR-19b-2*, hsa-miR-218-1*, hsa-miR-1323, hsa-miR-876-3p, hsa-miR-1305, hsa-miR-1225-3p, hsa-miR-504, hsa-miR-650, hsa-miR-1179, hsa-miR-190, hsa-miR-376c, HS_{—}168, hsa-miR-144:9.1, hsa-miR-1826, and hsa-miR-544 in the biological samples of the subject is indicative of the presence of sporadic MSI tumor.

In yet another aspect the downregulation of 10, 20, 30, 40, 50 or more miRNAs is determined and the miRNAs are selected from the group consisting of hsa-miR-198, hsa-miR-31*, hsa-miR-183*, hsa-miR-935, hsa-miR-183, hsa-miR-891a, hsa-miR-182, hsa-miR-1275, hsa-miR-886-3p, hsa-miR-155*, hsa-miR-503, hsa-miR-664, hsa-miR-424*, HS_{—}303b, hsa-miR-18a*, hsa-miR-594:9.1, hsa-miR-452*:9.1, hsa-miR-223, hsa-miR-625*, hsa-miR-29b-1*, hsa-miR-17-5p:9.1, hsa-miR-196b, hsa-miR-151-3p, solexa-51-13984, hsa-miR-200b*, hsa-miR-342-5p, hsa-miR-425, hsa-miR-203, hsa-miR-768-5p:11.0, hsa-miR-200a*, hsa-miR-30e*, hsa-miR-942, hsa miR-28-5p, hsa-miR-429, hsa-miR-30c, hsa-miR-126, hsa-miR-486-3p, hsa-let-7d, hsa-miR-382, hsa-miR-92a-1*, hsa-miR-224, hsa-miR-222, hsa-let-7e, hsa-miR-181a, hsa-miR-146b-5p, hsa-let-7c, hsa-miR-450b-5p, hsa-miR-370, hsa-miR-450a, hsa-miR-146a, hsa-miR-223*, hsa-miR-501-5p, hsa-miR-106b*, hsa-miR-181b, hsa-miR-134, hsa-miR-98, hsa-miR-106a, hsa-miR-889, hsa-miR-96, hsa-miR-132, hsa-miR-195, hsa-miR-1237, hsa-miR-451, hsa-miR-628-5p, hsa-miR-532-5p, hsa-miR-342-3p, hsa-miR-558, hsa-miR-10a, hsa-miR-215, hsa-miR-210, hsa-miR-10a*, hsa-miR-424, hsa-miR-432, hsa-miR-125a-5p, hsa-miR-500, hsa-miR-200c*, hsa-miR-130b*, hsa-miR-361-5p, hsa-miR-874, hsa-miR-374a, hsa-miR-32*, hsa-miR-335*, hsa-miR-100, hsa-miR-152, hsa-miR-652, hsa-miR-193a-5p, hsa-miR-34a, hsa-miR-10b, hsa-miR-15a, hsa-miR-106b, hsa-miR-574-3p, hsa-miR-455-3p, hsa-miR-499-5p, hsa-miR-335, hsa-miR-151:9.1, hsa-miR-23b*, hsa-miR-185, hsa-miR-941, hsa-miR-331-3p, hsa-miR-550, hsa miR-330-3p, hsa-miR-421, hsa-miR-744, hsa-let-7f-1*, hsa-miR-629, hsa-miR-433, hsa-miR-505*, hsa-miR-22*, hsa-miR-130b, hsa-miR-345, hsa-miR-532-3p, hsa-miR-542-5p, hsa-miR-339-5p, hsa-miR-193b, hsa-let-7d*, hsa-miR-199b-5p, hsa-miR-409-3p, hsa miR-148b, hsa-miR-190b, hsa-miR-18a, hsa-miR-29a*, hsa-miR-409-5p, hsa-miR-197, hsa-miR-708, hsa-miR-99a, hsa-miR-576-5p, hsa-miR-629*, hsa-miR-502-3p, hsa-miR-500*, hsa-miR-501-3p, hsa-miR-128, hsa-miR-19b-1*, hsa-miR-27b*, HS_{—}194, hsa-miR-92b, hsa-miR-130a, hsa-miR-577, HS_{—}108.1, hsa-miR-30e, hsa-miR-26a-1*, hsa-miR-32, hsa-miR-132*, hsa-miR-511, hsa-miR-145*, hsa-miR-221*, hsa-miR-454, hsa-miR-212, hsa-miR-34c-5p, hsa-miR-99b, hsa-miR-192*, hsa-miR-486-5p, hsa-miR-148a*, hsa-miR-30a, hsa-miR-16-2*, hsa-miR-107, hsa-miR-17*, hsa-miR-127-3p, hsa-let-7g*, hsa-miR-135a, hsa-miR-133a, hsa-miR-181a-2*, hsa-miR-101, hsa-miR-378*, hsa-miR-34a*, solexa-2580-353, hsa-miR-660, hsa-miR-154*, hsa-miR-497, hsa-miR-655, hsa-miR-144*, hsa-miR-362-5p, hsa-miR-339-3p, solexa-3126-285, hsa-miR-29c*, hsa-miR-30c-2*, hsa-miR-766, hsa-miR-26a-2*, hsa-miR-425*, hsa-miR-329, hsa-miR-323-3p, hsa-miR-338-3p, hsa-miR-186, hsa-miR-33b, hsa-miR-214*, hsa-miR-340, hsa-let-71*, hsa-miR-598, hsa-miR-26b*, hsa-miR-125b-2*, hsa-miR-29b-2*, hsa-miR-411, hsa-miR-487b, hsa-miR-361-3p, hsa-miR-181c, hsa-miR-628-3p, hsa-miR-326, hsa-miR-139-5p, HS_{—}209.1, hsa-miR-642, hsa-miR-616*, hsa-miR-505, hsa-miR-365, hsa-miR-656, hsa-miR-154, hsa-miR-20b, hsa-miR-363, hsa-miR-340*, hsa-let-7a*, hsa-miR-582-5p, hsa-miR-328, hsa-miR-337-3p, hsa-miR-30a*, hsa-miR-9, hsa-miR-24-1*, hsa-miR-187, hsa-miR-149, hsa-miR-142-5p, hsa-miR-101*, hsa-miR-1, hsa-miR-133b, hsa-miR-490-3p, hsa-let-7f, hsa-miR-15b, hsa-miR-199a*:9.1, and hsa-miR-30d in the biological samples of the subject is indicative of the presence of a sporadic MSI tumor. In a specific aspect of the method the biological sample is a tissue sample, a fecal sample or a blood sample.

One embodiment of the present invention provides a method for confirming a diagnosis of one or more tumors characterized by DNA mismatch repair (MMR) deficiency in a human subject comprising the steps of: identifying the human subject diagnosed of having the tumor characterized by the MMR deficiency and confirming the diagnosis of the tumor by a method comprising the steps of: (a) obtaining one or more biological samples from the subject, wherein the biological samples are selected from the group consisting of a tissue sample, a fecal sample, a cell homogenate, and one or more biological fluids comprising blood, plasma, lymph, urine, cerebrospinal fluid, amniotic fluid, pus or tears, (b) analyzing for a presence, a level or both of one or more genes associated with the MMR deficiency in the biological samples of the subject, wherein the genes are selected from the group consisting of MLH1, MSH2, MSH6, and PMS2, (c) comparing the results of the analysis with a first panel of markers, wherein the first set comprises BAT25, BAT26, D2S123, D5S346, and D17S250, (d) comparing the results of the analysis with a second panel of markers, wherein the second set comprises BAT25, BAT26, NR21, NR24, and NR27, and (e) determining the presence of the MMR deficiency by comparison of the results of the biological sample analysis with the first and second panel of markers, wherein a presence of ≧2 markers in the first panel and ≧3 markers in the second panel confirms the presence of the tumor characterized by MMR deficiency. In one aspect the tumors characterized by the MMR deficiency comprise Lynch syndrome or sporadic microsatellite instability (MSI) tumor. In another aspect an absence of one or more genes associated with the MMR deficiency in the tissue samples confirms the presence of a microsatellite stable (MSS) tumor. In yet another aspect the biological sample is a tissue sample, a fecal sample or a blood sample.

In another embodiment the present invention describes a method for distinguishing between one or more types of colorectal cancers (CRC), wherein the CRCs comprise microsatellite instability (MSI) tumor and microsatellite stable (MSS) tumors in a human subject comprising the steps of: identifying the human subject having the MSI or the MSS tumor, obtaining one or more biological samples from the subject, wherein the biological samples are selected from the group consisting of a tissue sample, a fecal sample, a cell homogenate, and one or more biological fluids comprising blood, plasma, lymph, urine, cerebrospinal fluid, amniotic fluid, pus or tears, and determining a differential expression signature for one or more microRNAs (miRNAs) in the biological sample using a microarray, wherein the one or more miRNAs are selected from the group consisting of, hsa-miR-938, hsa-miR-615-5p, hsa-miR-1184, hsa-miR-551a, hsa-miR-622, hsa-miR-17-5p:9.1, hsa-miR-192*, hsa-miR-337-3p, hsa-miR-338-3p, hsa-miR-187, hsa-miR-224, hsa-miR-411, hsa-miR-362-5p, hsa-miR-891a, hsa-miR-16-2*, hsa-miR-214*, hsa-miR-335*, hsa-miR-30a*, hsa-miR-30a, hsa-miR-660, hsa-miR-26a-2*, hsa-miR-199b-5p, hsa-miR-361-3p, hsa-miR-1, hsa-miR-497, hsa-miR-99a, hsa-miR-542-5p, hsa-miR-29b-1*, hsa-miR-328, hsa-miR-152, hsa-miR-133b, hsa-miR-146a, hsa-miR-432, hsa-miR-490-3p, hsa-miR-20a*, hsa-miR-200c*, hsa-miR-106a, hsa-miR-331-3p, hsa-miR-642, hsa-miR-139-5p, hsa-miR-424*, hsa-miR-149, hsa-miR-592, hsa-miR-339-3p, hsa-miR-502-3p, hsa-miR-500*, hsa-miR-26b*, hsa-miR-154, hsa-miR-181a-2*, hsa-miR-34a*, hsa-miR-409-3p, hsa-miR-532-5p, hsa-miR-106b, hsa-miR-203, hsa-miR-145*, hsa-miR-455-3p, hsa-miR-132*, hsa-miR-133a, hsa-miR-196b, and hsa-miR-550, wherein an upregulation, a downregulation or both of the one or more miRNAs in the biological samples of the subject is indicative of the presence of a MSI or a MSS tumor.

In one aspect of the method above the upregulation of 10, 20, 30, 40, 50 or more miRNAs is determined and the miRNAs are selected from the group consisting of solexa-9578-86, solexa-7764-108, solexa-5874-144, hsa-miR-940, hsa-miR-938, hsa-miR-936, hsa-miR-920, hsa-miR-890, hsa-miR-888, hsa-miR-887, hsa-miR-876-5p, hsa-miR-876-3p, hsa-miR-875-5p, hsa-miR-873, hsa-miR-769-5p, hsa-miR-7-2*, hsa-miR-7-1*, hsa-miR-657, hsa-miR-654-3p, hsa-miR-653:9.1, hsa-miR-653, hsa-miR-646, hsa-miR-641, hsa-miR-632, hsa-miR-625*, hsa-miR-625, hsa-miR-623, hsa-miR-622, hsa-miR-620, hsa-miR-618, hsa-miR-617, hsa-miR-615-5p, hsa-miR-609, hsa-miR-607, hsa-miR-602, hsa-miR-596, hsa-miR-590-3p, hsa-miR-583, hsa-miR-578, hsa-miR-573, hsa-miR-567, hsa-miR-563, hsa-miR-551a, hsa-miR-550*, hsa-miR-548j, hsa-miR-548g, hsa-miR-548c-3p, hsa-miR-548b-3p, hsa-miR-548a-3p, hsa-miR-525-5p, hsa-miR-525-3p, hsa-miR-522, hsa-miR-520e, hsa-miR-518f, hsa-miR-518e:9.1, hsa-miR-518d-3p, hsa-miR-518c*, hsa-miR-518b, hsa-miR-518a-5p, hsa-miR-527, hsa-miR-517c, hsa-miR-517a, hsa-miR-517*, hsa-miR-516a-5p hsa-miR-516a-3p, hsa-miR-516b*, hsa-miR-515-3p, hsa-miR-513a-5p, hsa-miR-512-5p, hsa-miR-512-3p, hsa-miR-508-5p, hsa-miR-488*, hsa-miR-485-5p, hsa-miR-450b-3p, hsa-miR-449b, hsa-miR-423-5p, hsa-miR-412, hsa-miR-411*, hsa-miR-384, hsa-miR-380*, hsa-miR-380, hsa-miR-376b, hsa-miR-372, hsa-miR-371-5p, hsa-miR-371-3p, hsa-miR-369-5p, hsa-miR-367*, hsa-miR-346, hsa-miR-33b*, hsa-miR-33a*, hsa-miR-325, hsa-miR-30d*, hsa-miR-302d, hsa-miR-302c*, hsa-miR-302b*, hsa-miR-302b, hsa-miR-302a*, hsa-miR-300, hsa-miR-298, hsa-miR-297, hsa-miR-25*, hsa-miR-222*, hsa-miR-220c hsa-miR-218-1*, hsa-miR-216b, hsa-miR-202*:9.1, hsa-miR-202*, hsa-miR-19b-2*, hsa-miR-19a*, hsa-miR-196a*, hsa-miR-190, hsa-miR-18b*, hsa-miR-187*, hsa-miR-146b-3p, hsa-miR-144:9.1, hsa-miR-138-2*, hsa-miR-135a*, hsa-miR-1324, hsa-miR-1323, hsa-miR-1321, hsa-miR-130a*, hsa-miR-1305, hsa-miR-1304, hsa-miR-1297, hsa-miR-1289, hsa-miR-1286, hsa-miR-1284, hsa-miR-1267, hsa-miR-1263, hsa-miR-1262, hsa-miR-1257, hsa-miR-1254, hsa-miR-124a:9.1, hsa-miR-1243, hsa-miR-1238, hsa-miR-1233, hsa-miR-1226, hsa-miR-1225-5p, hsa-miR-1224-3p, hsa-miR-1208, hsa-miR-1206, hsa-miR-1205, hsa-miR-1184, hsa-miR-1183, hsa-miR-1181, hsa-miR-1180, hsa-miR-1179, HS_{—}97, HS_{—}93, HS_{—}9, HS_{—}85.1, HS_{—}52, HS_{—}48.1, HS_{—}303a, HS_{—}280a, HS_{—}279a, HS_{—}268, HS_{—}264.1, HS_{—}25, HS_{—}244, HS_{—}239, HS_{—}231, HS_{—}228.1, HS_{—}219, HS_{—}216, HS_{—}203, HS_{—}202.1, HS_{—}199, HS_{—}19, HS_{—}176, HS_{—}170, HS_{—}160, HS_{—}145.1, HS_{—}138, HS_{—}128, HS_{—}122.1, HS_{—}121, HS_{—}119, HS_{—}114, HS_{—}106, HS_{—}105, HS_{—}101, and hsa-miR-1228* in the biological samples of the subject is indicative of the presence of the MSI tumor.

In another aspect of the method described above the downregulation of 10, 20, 30, 40, 50 or more miRNAs is determined and the miRNAs are selected from the group consisting of solexa-51-13984, solexa-499-2217, solexa-3126-285, solexa-2580-353, hsa-miR-99b, hsa-miR-99a, hsa-miR-96, hsa-miR-92a-1*, hsa-miR-891a, hsa-miR-886-3p, hsa-miR-874, hsa-miR-768-5p:11.0, hsa-miR-768-3p:11.0, hsa-miR-708, hsa-miR-675, hsa-miR-660, hsa-miR-652, hsa-miR-642, hsa-miR-638, hsa-miR-629*, hsa-miR-628-3p, hsa-miR-603, hsa-miR-598, hsa-miR-592, hsa-miR-582-5p, hsa-miR-577, hsa-miR-574-3p, hsa-miR-566, hsa-miR-558, hsa-miR-552, hsa-miR-548d-5p, hsa-miR-542-5p, hsa-miR-532-5p, hsa-miR-532-3p, hsa-miR-503, hsa-miR-502-3p, hsa-miR-500*, hsa-miR-501-3p, hsa-miR-500, hsa-miR-499-5p, hsa-miR-497, hsa-miR-494, hsa-miR-492, hsa-miR-490-5p, hsa-miR-490-3p, hsa-miR-455-3p, hsa-miR-454, hsa-miR-450b-5p, hsa-miR-450a, hsa-miR-432, hsa-miR-429, hsa-miR-425, hsa-miR-424*, hsa-miR-424, hsa-miR-421, hsa-miR-411, hsa-miR-409-3p, hsa-miR-378, hsa-miR-374a, hsa-miR-370, hsa-miR-365, hsa-miR-362-5p, hsa-miR-361-5p, hsa-miR-361-3p, hsa-miR-34c-5p, hsa-miR-34a*, hsa-miR-34a, hsa-miR-342-5p, hsa-miR-339-3p, hsa-miR-338-3p, hsa-miR-337-3p, hsa-miR-335*, hsa-miR-331-3p, hsa-miR-328, hsa-miR-326, hsa-miR-32*, hsa-miR-30e*, hsa-miR-30e, hsa-miR-30a*, hsa-miR-30a, hsa-miR-29c*, hsa-miR-29b-2*, hsa-miR-29b-1*, hsa-miR-29a*, hsa-miR-28-3p, hsa-miR-27b, hsa-miR-26b*, hsa-miR-26a-2*, hsa-miR-26a-1*, hsa-miR-24-1*, hsa-miR-224, hsa-miR-22, hsa-miR-215, hsa-miR-214*, hsa-miR-212, hsa-miR-20b, hsa-miR-20a*, hsa-miR-203, hsa-miR-200c*, hsa-miR-19b, hsa-miR-199b-5p, hsa-miR-198, hsa-miR-196b, hsa-miR-196a, hsa-miR-195, hsa-miR-193b, hsa-miR-193a-5p, hsa-miR-192*, hsa-miR-192, hsa-miR-191, hsa-miR-187, hsa-miR-186, hsa-miR-185, hsa-miR-181c, hsa-miR-181b, has, miR-181a-2*, hsa-miR-181a, hsa-miR-17-5p:9.1, hsa-miR-17, hsa-miR-16-2*, hsa-miR-15a, hsa-miR-154, hsa-miR-152, sa-miR-151-3p, hsa-miR-151:9.1, hsa-miR-149, hsa-miR-148b, hsa-miR-146b-5p, hsa-miR-146a, hsa-miR-145*, hsa-miR-143*, hsa-miR-139-5p, hsa-miR-135b, hsa-miR-134, hsa-miR-133b, hsa-miR-133am, hsa-miR-132*, hsa-miR-132, hsa-miR-130b, hsa-miR-130a, hsa-miR-1291, hsa-miR-128, hsa-miR-1275, hsa-miR-127-3p, hsa-miR-125b-2*, hsa-miR-125a-5p, hsa-miR-1248, hsa-miR-10b, hsa-miR-10a, hsa-miR-106b, hsa-miR-106a:9.1, hsa-miR-106a, hsa-miR-101, hsa-miR-100, hsa-miR-1, hsa-let-7f-1*, hsa-let-7d, hsa-let-7c, HS_{—}76, HS_{—}31.1, HS_{—}303 b, HS_{—}287, HS_{—}282, HS_{—}257, HS_{—}221, HS_{—}209.1, HS_{—}192.1, HS_{—}147, hsa-miR-30d, hsa-miR-200a, hsa-miR-199a*:9.1, hsa-miR-126, and hsa-let-7g in the biological samples of the subject is indicative of the presence of the MSI tumor. In yet another aspect the biological sample is a tissue sample, a fecal sample or a blood sample.

In yet another embodiment the present invention describes a system for diagnosing a colorectal cancer (CRC) in a human subject comprising: a microRNA (miRNA) microarray comprising a plurality of miRNA probes on a solid support, wherein the miRNA probes detect an expression pattern of one or more complementary miRNAs in a tissue sample, a fecal sample, a blood sample or all of a subject suspected of having the CRC.

In one aspect an upregulation, a downregulation or both of 10, 20, 30, 40, 50 or more miRNAs selected from the group consisting of HS_{—}78, hsa-miR-1826, hsa-miR-647, hsa-miR-603, hsa-miR-622, HS_{—}33, HS_{—}19, hsa-miR-300, HS_{—}111, hsa-miR-1238, hsa-miR-1290, HS_{—}276.1, hsa-miR-544, HS_{—}79.1, solexa-4793-177, hsa-miR-196a*, solexa-8048-104, HS_{—}149, hsa-miR-938, HS_{—}239, hsa-miR-1321, hsa-miR-1183, hsa-miR-583, hsa-miR-302b*, solexa-9578-86, HS_{—}128, hsa-miR-220b, HS_{—}22.1, hsa-miR-1184, solexa-7764-108, hsa-miR-940, hsa-miR-923, hsa-miR-1228*, HS_{—}120, hsa-miR-18b*, solexa-9655-85, hsa-miR-801:9.1, hsa-miR-302d, HS_{—}72, HS_{—}38.1, hsa-miR-512-5pm, HS_{—}215, hsa-miR-31, hsa-miR-423-5p, hsa-miR-576-3p, hsa-miR-612, HS_{—}43.1, hsa-miR-7-1*, hsa-miR-346, hsa-miR-1268, hsa-miR-892a, HS_{—}208, hsa-miR-623, HS_{—}86, HS_{—}170, hsa-miR-563, hsa-miR-1181, hsa-miR-1289, HS_{—}241.1, hsa-miR-183*, hsa-miR-1269, HS_{—}9, hsa-miR-512-3p, hsa-miR-587, HS_{—}202.1, HS_{—}37, hsa-miR-936, hsa-miR-1231, HS_{—}250, hsa-miR-202*:9.1, HS_{—}254, hsa-miR-518b, hsa-miR-19a*, HS_{—}116, hsa-miR-450b-3p, HS_{—}48.1, hsa-miR-591, hsa-miR-25*, hsa-miR-665, hsa-miR-654-3p, HS_{—}74, HS_{—}217, HS_{—}71.1, hsa-miR-550*, hsa-miR-1291, hsa-miR-371-3p, hsa-miR-1245, hsa-miR-520e, hsa-miR-135a*, HS_{—}51, hsa-miR-298, HS_{—}228.1, solexa-15-44487, HS_{—}110, hsa-miR-1255b, hsa-miR-1285, HS_{—}44.1, HS_{—}29, hsa-miR-198, hsa-miR-551a, solexa-9081-91, HS_{—}35, HS_{—}167.1, hsa-miR-1225-5p, HS_{—}56, hsa-miR-654-5p, hsa-miR-1207-3p, hsa-miR-631, hsa-miR-920, hsa-miR-515-3p, hsa-miR-661, hsa-miR-508-5p, hsa-miR-566, solexa-8926-93, HS_{—}65, hsa-miR-218-2*, HS_{—}2, hsa-miR-509-5p, hsa-miR-1254, HS_{—}163, hsa-miR-135b*, HS_{—}205.1, hsa-miR-31*, hsa-miR-1273, HS_{—}106, HS_{—}4.1, HS_{—}23, hsa-miR-1304, HS_{—}139, HS_{—}287, HS_{—}46, HS_{—}155, hsa-miR-187*, hsa-miR-193b*, HS_{—}147, HS_{—}187, HS_{—}17, HS_{—}87, hsa-miR-935, HS_{—}244, hsa-miR-1197, HS_{—}216, solexa-9124-90, hsa-miR-1324, hsa-miR-548g, hsa-miR-619, hsa-miR-302b, hsa-miR-632, hsa-miR-380*, hsa-miR-572, hsa-miR-668, hsa-miR-767-3p, hsa-miR-520d-5p, hsa-miR-1248, hsa-miR-380, HS_{—}101, HS_{—}150, solexa-578-1915, hsa-miR-549, HS_{—}189.1, HS_{—}80, HS_{—}264.1, hsa-miR-614, HS_{—}76, HS_{—}21, hsa-miR-182*, hsa-miR-1182, HS_{—}126, hsa-miR-1244, hsa-miR-1250, hsa-miR-602, hsa-miR-518a-5p, hsa-miR-527, hsa-miR-518f, hsa-miR-124a:9.1, hsa-miR-944, hsa-miR-517*, HS_{—}109, hsa-miR-1303, HS_{—}94, hsa-miR-1247, hsa-miR-588, hsa-miR-675, hsa-miR-645, hsa-miR-1300, hsa-miR-767-5p, hsa-miR-1180, HS_{—}68, hsa-miR-1204, hsa-miR-560:9.1, solexa-3044-295, hsa-miR-1295, hsa-miR-616, HS_{—}206, HS_{—}58, hsa-miR-671:9.1, solexa-5620-151, hsa-miR-519d, solexa-826-1288, hsa-miR-608, hsa-miR-509-3p, HS_{—}45.1, HS_{—}32, HS_{—}174.1, HS_{—}200, HS_{—}243.1, HS_{—}284.1, HS_{—}89, HS_{—}77, hsa-miR-1234, HS_{—}242, hsa-miR-663b, solexa-2952-306, hsa-miR-1274a, hsa-miR-890, hsa-miR-1243, hsa-miR-95, solexa-555-1991, hsa-miR-222*, HS_{—}121, hsa-miR-554, hsa-miR-1246, hsa-miR-1207-5p, solexa-3927-221, HS_{—}100, hsa-miR-574-5p, hsa-miR-1202, HS_{—}199, hsa-miR-1260, hsa-miR-943, HS_{—}262.1, solexa-5169-164, hsa-miR-129*, hsa-miR-101*, hsa-miR-138, hsa-miR-598, hsa-miR-490-3p, hsa-miR-29b-2*, hsa-miR-365, hsa-miR-30c-2*, hsa-miR-133b, hsa-miR-133a, hsa-miR-551b, hsa-miR-192*, hsa-miR-337-3p, hsa-miR-125b-2*, hsa-miR-20b*, hsa-miR-137, hsa-miR-214*, hsa-miR-582-3p, hsa-miR-132*, hsa-miR-582-5p, hsa-miR-24-1*, hsa-miR-130a, hsa-miR-149, hsa-miR-1, hsa-miR-656, hsa-miR-139-5p, hsa-miR-490-5p, hsa-miR-181c, hsa-miR-30a*, hsa-miR-187, hsa-miR-33b, hsa-miR-145*, hsa-miR-20b, hsa-miR-340, HS_{—}209.1, hsa-miR-363, hsa-miR-570, hsa-miR-9, hsa-miR-340*, hsa-miR-497, hsa-miR-579, hsa-miR-545, hsa-miR-744*, hsa-miR-30e, hsa-miR-142-5p, hsa-let-71*, hsa-miR-323-3p, hsa-miR-642, hsa-miR-99a, hsa-miR-195*, hsa-miR-181a-2*, hsa-miR-26b*, hsa-miR-362-5p, hsa-miR-885-5p, hsa-miR-26a-1*, hsa-miR-628-3p, hsa-miR-136, hsa-miR-148b, hsa-let-7g*, hsa-miR-135a, hsa-miR-338-3p, hsa-miR-376a*, hsa-miR-454, hsa-miR-106b, hsa-miR-154*, hsa-let-7f-1*, hsa-miR-148a*, hsa-miR-27b*, hsa-miR-381, hsa-miR-212, hsa-miR-153, hsa-miR-34a*, hsa-miR-577, hsa-miR-144*, hsa-miR-127-5p, hsa-miR-411, hsa-miR-590-3p, hsa-miR-519a, hsa-miR-487b, hsa-miR-455-3p, hsa-miR-345, hsa-miR-199b-5p, hsa-miR-92b, hsa-let-7e*, hsa-miR-361-3p, hsa-miR-548p hsa-miR-502-3p, hsa-miR-500*, hsa-miR-186, hsa-miR-151:9.1, hsa-miR-30a, hsa-miR-221*, hsa-miR-9*, hsa-miR-136*, hsa-miR-26a-2*, hsa-miR-143*, hsa-miR-140-5p, hsa-miR-189:9.1, hsa-miR-130b, hsa-miR-374a, hsa-miR-128, hsa-miR-616*, solexa-3126-285, hsa-miR-766, hsa-miR-548e, hsa-miR-154, hsa-miR-486-5p, hsa-miR-597, HS_{—}194, hsa-miR-361-5p, hsa-miR-421, hsa-miR-127-3p, hsa-miR-195, hsa-miR-99a*, hsa-miR-337-5p, hsa-let-7a*, solexa-2580-353, hsa-miR-409-5p, hsa-miR-34b*, hsa-miR-16-2*, hsa-miR-30d*, hsa-miR-10b, hsa-miR-499-5p, hsa-miR-548c-5p, hsa-miR-148b*, hsa-miR-193a-3p, hsa-miR-342-3p, hsa-miR-410, hsa-miR-425*, hsa-miR-29c*, hsa-miR-495, hsa-miR-330-3p, hsa-miR-219-5p, hsa-miR-185, hsa-miR-329, hsa-miR-592, hsa-miR-433, hsa-miR-181c*, hsa-miR-193a-5p, hsa-miR-34c-5p, hsa-miR-124, HS_{—}49, HS_{—}282, hsa-miR-100, hsa-miR-299-5p, hsa-miR-128a:9.1, hsa-miR-455-5p, hsa-miR-101, hsa-miR-409-3p, hsa-miR-326, hsa-miR-379*, hsa-miR-328, hsa-miR-539, hsa-miR-331-3p, hsa-miR-1272, HS_{—}168, hsa-miR-374b*, hsa-miR-548m, hsa-miR-378*, hsa-miR-202*, hsa-miR-339-3p, hsa-miR-660, hsa-miR-576-5p, hsa-miR-296-5p, hsa-miR-451, hsa-miR-17*, hsa-miR-141*, hsa-miR-190b, hsa-miR-511, hsa-miR-20a*, hsa-miR-204, hsa-miR-1185, hsa-miR-624*, hsa-miR-655, hsa-miR-34b, hsa-miR-411*, hsa-miR-505, hsa-miR-15a, hsa-miR-454*, hsa-miR-22*, hsa-miR-18b, hsa-miR-144:9.1, hsa-miR-99b, hsa-miR-100*, hsa-miR-873, hsa-miR-10a*, hsa-miR-1537, hsa-miR-19b-1*, hsa-miR-505*, hsa-miR-29a*, hsa-miR-147, hsa-miR-485-3p, solexa-539-2056, hsa-miR-193b, HS_{—}42, hsa-miR-218, hsa-miR-19b, hsa-miR-106a:9.1, hsa-miR-378, hsa-miR-376c, hsa-miR-24-2*, hsa-miR-32, hsa-miR-197, hsa-miR-744, hsa-miR-7-2*, hsa-miR-335, hsa-miR-627, hsa-miR-139-3p, hsa-miR-629, hsa-miR-15b*, hsa-miR-107, hsa-miR-383, hsa-miR-147b, hsa-miR-19a, HS_{—}108.1, hsa-miR-301a, hsa-let-7b*, hsa-miR-345:9.1, hsa-miR-331-5p, hsa-miR-552, hsa-miR-1271, hsa-miR-550, hsa-miR-1296, HS_{—}20, hsa-miR-487a, hsa-miR-491-5p, solexa-3695-237, hsa-miR-374a*, solexa-7534-111, hsa-miR-128b:9.1, hsa-miR-188-3p, hsa-miR-33a, hsa-miR-129-3p, hsa-miR-23b*, hsa-miR-362-3p, hsa-miR-496, HS_{—}40, HS_{—}64, HS_{—}201, hsa-miR-1227, hsa-miR-125a-3p, hsa-miR-99b*, hsa-miR-542-3p, hsa-miR-142-3p, hsa-miR-571, hsa-miR-376a*:9.1, hsa-miR-493, solexa-2526-361, hsa-miR-585, hsa-miR-93*, hsa-miR-502-5p, hsa-miR-30e*, hsa-miR-145, hsa-miR-126, hsa-miR-222, hsa-let-7e, hsa-miR-30d, hsa-miR-28-5p, hsa-miR-30c, hsa-miR-199a*:9.1, hsa-miR-29c, HS_{—}275, hsa-miR-143, hsa-miR-125b, hsa-miR-26a, hsa-miR-141, hsa-miR-140-3p, hsa-miR-30b, and hsa-miR-338-5p in the tissue sample, fecal sample or both of the subject is indicative of the presence of the CRC. In another aspect the CRC comprises Lynch syndrome, sporadic microsatellite instability (MSI) tumors or microsatellite stable (MSS) tumors.

In one embodiment the present invention discloses a system for detecting one or more colorectal cancers (CRC) in a human subject suspected of having the CRC comprising: a microRNA (miRNA) microarray comprising a plurality of miRNA probes on a solid support, wherein the miRNA probes detect an expression pattern of one or more complementary miRNAs in a biological sample of the subject suspected of having the CRC. In one aspect the biological sample is a tissue sample, a fecal sample or a blood sample. In another aspect an upregulation, a downregulation or both of one or more miRNAs is indicative of the presence of the CRC. In yet another aspect the CRC types comprise comprises Lynch syndrome, sporadic microsatellite instability (MSI) tumors or microsatellite stable (MSS) tumors.

Finally, the present invention describes a method of identifying a subject suspected of having Lynch syndrome comprising the steps of: obtaining one or more biological samples from the subject, wherein the biological samples are selected from the group consisting of a tissue sample, a fecal sample, a cell homogenate, and one or more biological fluids comprising blood, plasma, lymph, urine, cerebrospinal fluid, amniotic fluid, pus or tears, and determining a differential expression signature for one or more MicroRNAs (miRNAs) in the biological samples using a microarray, wherein the one or more miRNAs are selected from the group consisting of hsa-miR-30a*, hsa-miR-16-2*, hsa-miR-362-5p, hsa-miR-486-5p, hsa-miR-337-3p, hsa-miR-642, hsa-miR-411, hsa-miR-214*, hsa-miR-187, hsa-miR-628-3p, hsa-miR-142-5p, hsa-miR-29b-1*, hsa-miR-361-3p, hsa-miR-501-3p, hsa-miR-139-5p, hsa-miR-192*, hsa-miR-128, hsa-miR-29b-2*, hsa-miR-26b*, hsa-miR-432, hsa-miR-92b, hsa-miR-502-3p, hsa-miR-34a*, hsa-miR-200c*, hsa-miR-130b, hsa-miR-598, hsa-miR-151:9.1, hsa-miR-130b*, hsa-miR-421, hsa-miR-1238, and hsa-miR-622, wherein an upregulation, a downregulation or both of the one or more miRNAs is indicative of the presence of Lynch syndrome in the subject.

In one aspect of the method hereinabove the upregulation of 10, 20, 30, 40, 50 or more miRNAs selected from the group consisting of hsa-miR-198, hsa-miR-31*, hsa-miR-183*, hsa-miR-935, hsa-miR-183, hsa-miR-891a, hsa-miR-182, hsa-miR-1275, hsa-miR-886-3p, hsa-miR-155*, hsa-miR-503, hsa-miR-664, hsa-miR-424*, HS_{—}303b, hsa-miR-18a*, hsa-miR-594:9.1, hsa-miR-452*:9.1, hsa-miR-223, hsa-miR-625*, hsa-miR-29b-1*, hsa-miR-17-5p:9.1, hsa-miR-196b, hsa-miR-151-3p, solexa-51-13984, hsa-miR-200b*, hsa-miR-342-5p, hsa-miR-425, hsa-miR-203, hsa-miR-768-5p:11.0, hsa-miR-200a*, hsa-miR-30e*, hsa-miR-942, hsa miR-28-5p, hsa-miR-429, hsa-miR-30c, hsa-miR-126, hsa-miR-486-3p, hsa-let-7d, hsa-miR-382, hsa-miR-92a-1*, hsa-miR-224, hsa-miR-222, hsa-let-7e, hsa-miR-181a, hsa-miR-146b-5p, hsa-let-7c, hsa-miR-450b-5p, hsa-miR-370, hsa-miR-450a, hsa-miR-146a, hsa-miR-223*, hsa-miR-501-5p, hsa-miR-106b*, hsa-miR-181b, hsa-miR-134, hsa-miR-98, hsa-miR-106a, hsa-miR-889, hsa-miR-96, hsa-miR-132, hsa-miR-195, hsa-miR-1237, hsa-miR-451, hsa-miR-628-5p, hsa-miR-532-5p, hsa-miR-342-3p, hsa-miR-558, hsa-miR-10a, hsa-miR-215, hsa-miR-210, hsa-miR-10a*, hsa-miR-424, hsa-miR-432, hsa-miR-125a-5p, hsa-miR-500, hsa-miR-200c*, hsa-miR-130b*, hsa-miR-361-5p, hsa-miR-874, hsa-miR-374a, hsa-miR-32*, hsa-miR-335*, hsa-miR-100, hsa-miR-152, hsa-miR-652, hsa-miR-193a-5p, hsa-miR-34a, hsa-miR-10b, hsa-miR-15a, hsa-miR-106b, hsa-miR-574-3p, hsa-miR-455-3p, hsa-miR-499-5p, hsa-miR-335, hsa-miR-151:9.1, hsa-miR-23b*, hsa-miR-185, hsa-miR-941, hsa-miR-331-3p, hsa-miR-550, hsa miR-330-3p, hsa-miR-421, hsa-miR-744, hsa-let-7f-1*, hsa-miR-629, hsa-miR-433, hsa-miR-505*, hsa-miR-22*, hsa-miR-130b, hsa-miR-345, hsa-miR-532-3p, hsa-miR-542-5p, hsa-miR-339-5p, hsa-miR-193b, hsa-let-7d*, hsa-miR-199b-5p, hsa-miR-409-3p, hsa miR-148b, hsa-miR-190b, hsa-miR-18a, hsa-miR-29a*, hsa-miR-409-5p, hsa-miR-197, hsa-miR-708, hsa-miR-99a, hsa-miR-576-5p, hsa-miR-629*, hsa-miR-502-3p, hsa-miR-500*, hsa-miR-501-3p, hsa-miR-128, hsa-miR-19b-1*, hsa-miR-27b*, HS_{—}194, hsa-miR-92b, hsa-miR-130a, hsa-miR-577, HS_{—}108.1, hsa-miR-30e, hsa-miR-26a-1*, hsa-miR-32, hsa-miR-132*, hsa-miR-511, hsa-miR-145*, hsa-miR-221*, hsa-miR-454, hsa-miR-212, hsa-miR-34c-5p, hsa-miR-99b, hsa-miR-192*, hsa-miR-486-5p, hsa-miR-148a*, hsa-miR-30a, hsa-miR-16-2*, hsa-miR-107, hsa-miR-17*, hsa-miR-127-3p, hsa-let-7g*, hsa-miR-135a, hsa-miR-133a, hsa-miR-181a-2*, hsa-miR-101, hsa-miR-378*, hsa-miR-34a*, solexa-2580-353, hsa-miR-660, hsa-miR-154*, hsa-miR-497, hsa-miR-655, hsa-miR-144*, hsa-miR-362-5p, hsa-miR-339-3p, solexa-3126-285, hsa-miR-29c*, hsa-miR-30c-2*, hsa-miR-766, hsa-miR-26a-2*, hsa-miR-425*, hsa-miR-329, hsa-miR-323-3p, hsa-miR-338-3p, hsa-miR-186, hsa-miR-33b, hsa-miR-214*, hsa-miR-340, hsa-let-7i*, hsa-miR-598, hsa-miR-26b*, hsa-miR-125b-2*, hsa-miR-29b-2*, hsa-miR-411, hsa-miR-487b, hsa-miR-361-3p, hsa-miR-181c, hsa-miR-628-3p, hsa-miR-326, hsa-miR-139-5p, HS_{—}209.1, hsa-miR-642, hsa-miR-616*, hsa-miR-505, hsa-miR-365, hsa-miR-656, hsa-miR-154, hsa-miR-20b, hsa-miR-363, hsa-miR-340*, hsa-let-7a*, hsa-miR-582-5p, hsa-miR-328, hsa-miR-337-3p, hsa-miR-30a*, hsa-miR-9, hsa-miR-24-1*, hsa-miR-187, hsa-miR-149, hsa-miR-142-5p, hsa-miR-101*, hsa-miR-1, hsa-miR-133b, hsa-miR-490-3p, hsa-let-7f, hsa-miR-15b, hsa-miR-199a*:9.1, and hsa-miR-30d in the biological samples of the subject is indicative of the presence of Lynch syndrome.

In another aspect the downregulation of 10, 20, 30, 40, 50 or more miRNAs selected from the group consisting of hsa-miR-938, hsa-miR-1238, hsa-miR-1183, hsa-miR-892a, hsa-miR-622, solexa-7764-108, hsa-miR-1290, hsa-miR-623, hsa-miR-302d, hsa-miR-18b*, hsa-miR-603, hsa-miR-520e, hsa-miR-1268, HS_{—}217, hsa-miR-202*:9.1, HS_{—}202.1, hsa-miR-512-5p, hsa-miR-612, HS_{—}215, hsa-miR-302b*, HS_{—}111, hsa-miR-1197, HS_{—}149, hsa-miR-346, hsa-miR-1181, HS_{—}33, hsa-miR-647, HS_{—}78, hsa-miR-632, hsa-miR-1304, HS_{—}228.1, HS_{—}116, HS_{—}241.1, HS_{—}72, hsa-miR-196a*, HS_{—}276.1, hsa-miR-1184, hsa-miR-1225-5p, HS_{—}17, hsa-miR-654-3p, hsa-miR-124a:9.1, HS_{—}74, hsa-miR-518b, HS_{—}120, hsa-miR-654-5p, HS_{—}44.1, HS_{—}239 hsa-miR-380*, hsa-miR-1321, solexa-9081-91, hsa-miR-631, hsa-miR-423-5p, hsa-miR-936, hsa-miR-550*, hsa-miR-7-1*, HS_{—}37, HS_{—}79.1, hsa-miR-19a*, HS_{—}86, solexa-578-1915, hsa-miR-450b-3p, HS_{—}9, HS_{—}250, HS_{—}56, HS_{—}208, HS_{—}205.1, HS_{—}128, HS_{—}170, HS_{—}38.1, hsa-miR-576-3p, hsa-miR-583, hsa-miR-923, hsa-miR-940, HS_{—}19, hsa-miR-300, solexa-9655-85, hsa-miR-130a*, HS_{—}106, HS_{—}23, hsa-miR-220b, hsa-miR-187*, hsa-miR-1255b, hsa-miR-515-3p, hsa-miR-1289, solexa-15-44487, hsa-miR-563, hsa-miR-661, HS_{—}264.1, hsa-miR-135a*, hsa-miR-587, hsa miR-548g, HS_{—}51, hsa-miR-512-3p, hsa-miR-1254, HS_{—}71.1, hsa-miR-920, hsa-miR-371-3p, hsa-miR-665, hsa-miR-591, HS_{—}176, HS_{—}188, HS_{—}139, HS_{—}244, HS_{—}12, hsa-miR-1204, solexa-9578-86, hsa-miR-298, hsa-miR-551a, hsa-miR-520d-5p, hsa-miR-508-5p, hsa-miR-1231, hsa-miR-302b, HS_{—}101, HS_{—}48.1, hsa-miR-1228*, hsa-miR-498, hsa-miR-602, HS_{—}150, HS_{—}80, hsa-miR-518d-3p, HS_{—}216, hsa-miR-222*, hsa-miR-890, hsa-miR-1297, HS_{—}52, hsa-miR-554, HS_{—}93, hsa-miR-1243, hsa-miR-1202, HS_{—}97, hsa-miR-518e:9.1, hsa-miR-372, HS_{—}121, hsa-miR-1205, HS_{—}122.1, hsa-miR-525-5p, solexa-555-1991, hsa-miR-302c*, hsa-miR-1262, hsa-miR-518c*, hsa-miR-1233, hsa-miR-888, hsa-miR-33a*, hsa-miR-146a*, hsa-miR-412, hsa-miR-615-5p, hsa-miR-367*, hsa-miR-146b-3p, hsa-miR-1257, hsa-miR-1286, hsa-miR-609, hsa-miR-643, hsa-miR-519b-3p, hsa-miR-657, hsa-miR-384, hsa-miR-887, HS_{—}113, hsa-miR-1284, HS_{—}138, HS_{—}25, hsa-miR-488*, HS_{—}152, hsa-miR-1208, HS_{—}219, hsa-miR-607, hsa-miR-516a-3p, hsa-miR-516b*, hsa-miR-369-5p, hsa-miR-548b-3p, hsa-miR-548a-3p, hsa-miR-567, hsa-miR-1267, hsa-miR-578, HS_{—}184, hsa-miR-1206, hsa-miR-620, hsa-miR-186*, hsa-miR-596, hsa-miR-548c-3p, hsa-miR-1224-3p, hsa-miR-19b-2*, hsa-miR-218-1*, hsa-miR-1323, hsa-miR-876-3p, hsa-miR-1305, hsa-miR-1225-3p, hsa-miR-504, hsa-miR-650, hsa-miR-1179, hsa-miR-190, hsa-miR-376c, HS_{—}168, hsa-miR-144:9.1, hsa-miR-1826, and hsa-miR-544 in the biological samples of the subject is indicative of the presence of Lynch syndrome. In yet another aspect the subject suspected of having Lynch syndrome may or may not demonstrate germline mutations in one or more DNA mismatch repair (MMR) genes. Finally, the biological sample is a tissue sample, a fecal sample or a blood sample.

### BRIEF DESCRIPTION OF THE DRAWINGS

For a more complete understanding of the features and advantages of the present invention, reference is now made to the detailed description of the invention along with the accompanying figures and in which:

FIG. 1 is a schematic representation of the study outline. The study was conducted in three steps: a) miRNA microarray profiling in a training set (n=74) comprised of 4 well-defined groups: N—C tissue, Lynch syndrome tumors, sporadic MSI tumors and MSS tumors; b) technical validation of the most significant results by qRT-PCR in an randomly selected subset of samples from the training set (n=30); and c) development of a predictor to differentiate the type of MSI (Lynch syndrome vs sporadic MSI tumors) using an independent set of samples (n=33).

FIGS. 2A-2C show differential miRNA expression between normal colonic mucosa and tumor tissue: (FIG. 2A) is a heat map showing the expression of the 50 most significant miRNAs identified by LIMMA in the four groups (Lynch syndrome, sporadic MSI, MSS, and N—C mucosa (N—C)). Rows represent miRNAs and columns represent individual samples; the intensity of each color denotes the standardized ratio between each value and the average expression of each miRNA across all samples, where green corresponds to decreased levels, and red indicates abundance, (FIG. 2B) is a Bga plot showing samples clustering based on the expression of the 50 most significant miRNAs, (FIG. 2C) is a Venn diagram showing the significantly dysregulated probes among the 3 tumor subtypes (sporadic MSI, MSS and Lynch syndrome) compared to N—C;

FIGS. 3A-3D show that miRNAs are differentially expressed between sporadic MSI and Lynch syndrome tumors: (FIG. 3A) is a heat map representing the expression profiles of the 31 discriminative miRNAs identified by PAM (overall error rate: 0.057). Rows represent miRNAs and columns represent individual samples; the intensity of each color denotes the standardized ratio between each value and the average expression of each miRNA across all samples, where green corresponds to decreased levels, and red indicates abundance, (FIG. 3B) is a multidimensional scaling plot including Lynch syndrome (blue) and sporadic MSI (red) tumor samples. Distances between samples are proportional to their dissimilarities in miRNA expression included in the PAM classifier, (FIG. 3C) shows unsupervised hierarchical clustering analysis based on the 891 filtered probes comparing tumor tissues from patients with a germline mutation in the DNA mismatch repair (MMR) genes (Lynch-mutated) and MMR deficient tumors from familial cases with a negative genetic tests (Lynch-like), (FIG. 3D) is a multidimensional scaling plot incorporating Lynch-mutated vs Lynch-like subgroups;

FIGS. 4A and 4B show a comparison of miRNA patterns from Lynch MLH1 type and sporadic MSI: (FIG. 4A) is a heat map showing the expression of the 33 miRNAs selected by PAM that can significantly distinguish Lynch MLH1 syndrome CRCs from MSI sporadic tumors. Rows represent miRNAs and columns represent individual samples; the intensity of each color denotes the standardized ratio between each value and the average expression of each miRNA across all samples, where green corresponds to decreased levels, and red indicates abundance, (FIG. 4B) is a multidimensional scaling plot incorporating sporadic MSI and Lynch MLH1 type tumor samples. Distances between samples are proportional to their dissimilarities in the miRNA expression profile included in the PAM classifier;

FIGS. 5A and 5B show a comparison of miRNA patterns from sporadic MSI and MSS: (FIG. 5A) is a heat map showing the expression profiles of the 59 most significant miRNAs capable of predicting the presence of sporadic MSI based on PAM analysis (overall error rate: 0.124), (FIG. 5B) is a multidimensional scaling plot incorporating sporadic MSI and MSS tumors. Distances between samples are proportional to their dissimilarities in the miRNA expression profile included in the PAM classifier;

FIGS. 6A and 6B show in situ hybridization (ISH) analysis of miR-622 in normal colorectal mucosa and CRC. miR-622, positive control (U6) and negative control (no probe) ISH analysis were performed in normal colorectal mucosa (FIG. 6A) and a group of CRCs (FIG. 6B). Staining for miR-622 was observed in the epithelium throughout the colonic crypt, with no staining of the stromal cells. miR-622 was markedly expressed in all of the five tumors evaluated. Hematoxylin-eosin (H&E) staining of the corresponding tissues is shown; and

FIGS. 7A and 7B show the performance of the miRNA-based predictor to distinguish the type of MSI: (FIG. 7A) receiver operating curve of the miRNA-based predictor (miR-622, miR-362-5p, miR-486-5p) to distinguish the presence of Lynch syndrome among MSI tumors. S1, training set (n=14); S2, test set (n=33), (FIG. 7B) discriminant probability plot. The graphical representation shows the LOO—CV probabilities (0.0 to 1.0) of each tumor for being sporadic MSI (red dots and triangles) or Lynch syndrome (blue dots and triangles). Dots indicate samples from the training set (set 1) and triangles from the test set (set 2).

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an,” and “the” are not intended to refer to only a singular entity, but include the general class of which a specific example may be used for illustration. The terminology herein is used to describe specific embodiments of the invention, but their usage does not delimit the invention, except as outlined in the claims.

As used herein, the term “colorectal cancer” includes the well-accepted medical definition that defines colorectal cancer as a medical condition characterized by cancer of cells of the intestinal tract below the small intestine (i.e., the large intestine (colon), including the cecum, ascending colon, transverse colon, descending colon, sigmoid colon, and rectum). Additionally, as used herein, the term “colorectal cancer” also further includes medical conditions, which are characterized by cancer of cells of the duodenum and small intestine (jejunum and ileum).

As used herein, the term “microRNA” (“miRNA”) refers to an RNA (or RNA analog) comprising the product of an endogenous, non-coding gene whose precursor RNA transcripts can form small stem-loops from which mature “miRNAs” are cleaved by Dicer (Lagos-Quintana et al., 2001; Lau et al., 2001; Lee and Ambros, 2001; Lagos-Quintana et al., 2002; Mourelatos et al., 2002; Reinhart et al., 2002; Ambros et al., 2003; Brennecke et al., 2003b; Lagos-Quintana et al., 2003; Lim et al., 2003a; Lim et al., 2003b). “miRNAs” are encoded in genes distinct from the mRNAs whose expression they control.

The term “tissue sample” (the term “tissue” is used interchangeably with the term “tissue sample”) should be understood to include any material composed of one or more cells, either individual or in complex with any matrix or in association with any chemical. The definition shall include any biological or organic material and any cellular subportion, product or by-product thereof. The definition of “tissue sample” should be understood to include without limitation sperm, eggs, embryos and blood components. Also included within the definition of “tissue” for purposes of this invention are certain defined a cellular structures such as dermal layers of skin that have a cellular origin but are no longer characterized as cellular. The term “stool” as used herein is a clinical term that refers to feces excreted by humans.

The term “biomarker” as used herein in various embodiments refers to a specific biochemical in the body that has a particular molecular feature to make it useful for diagnosing and measuring the progress of disease or the effects of treatment. For example, common metabolites or biomarkers found in a person's breath, and the respective diagnostic condition of the person providing such metabolite include, but are not limited to, acetaldehyde (source: ethanol, X-threonine; diagnosis: intoxication), acetone (source: acetoacetate; diagnosis: diet/diabetes), ammonia (source: deamination of amino acids; diagnosis: uremia and liver disease), CO (carbon monoxide) (source: CH₂Cl₂, elevated % COHb; diagnosis: indoor air pollution), chloroform (source: halogenated compounds), dichlorobenzene (source: halogenated compounds), diethylamine (source: choline; diagnosis: intestinal bacterial overgrowth), H (hydrogen) (source: intestines; diagnosis: lactose intolerance), isoprene (source: fatty acid; diagnosis: metabolic stress), methanethiol (source: methionine; diagnosis: intestinal bacterial overgrowth), methylethylketone (source: fatty acid; diagnosis: indoor air pollution/diet), O-toluidine (source: carcinoma metabolite; diagnosis: bronchogenic carcinoma), pentane sulfides and sulfides (source: lipid peroxidation; diagnosis: myocardial infarction), H2S (source: metabolism; diagnosis: periodontal disease/ovulation), MeS (source: metabolism; diagnosis: cirrhosis), and Me2S (source: infection; diagnosis: trench mouth).

As used herein the term “genetic marker” refers to a region of a nucleotide sequence (e.g., in a chromosome) that is subject to variability (i.e., the region can be polymorphic for a variety of alleles). For example, a single nucleotide polymorphism (SNP) in a nucleotide sequence is a genetic marker that is polymorphic for two alleles. Other examples of genetic markers of this invention can include but are not limited to microsatellites, restriction fragment length polymorphisms (RFLPs), repeats (i.e., duplications), insertions, deletions, etc.

The term “polymerase chain reaction” (PCR) as used herein refers to the method of K. B. Mullis, U.S. Pat. Nos. 4,683,195, 4,683,202, and 4,965,188, hereby incorporated by reference, which describes a method for increasing the concentration of a segment of a target sequence in a mixture of genomic DNA without cloning or purification. This process for amplifying the target sequence consists of introducing a large excess of two oligonucleotide primers to the DNA mixture containing the desired target sequence, followed by a precise sequence of thermal cycling in the presence of a DNA polymerase. The two primers are complementary to their respective strands of the double stranded target sequence. To effect amplification, the mixture is denatured and the primers then annealed to their complementary sequences within the target molecule. Following annealing, the primers are extended with a polymerase so as to form a new pair of complementary strands. The steps of denaturation, primer annealing and polymerase extension can be repeated many times (i.e., denaturation, annealing and extension constitute one “cycle”; there can be numerous “cycles”) to obtain a high concentration of an amplified segment of the desired target sequence. The length of the amplified segment of the desired target sequence is determined by the relative positions of the primers with respect to each other, and therefore, this length is a controllable parameter. By virtue of the repeating aspect of the process, the method is referred to as the “polymerase chain reaction” (hereinafter PCR).

Colorectal cancer (CRC) is one of the most common tumors in Western countries and the second leading cause of cancer-related deaths'. From a molecular standpoint, CRC is a complex and heterogeneous disease caused by the accumulation of genetic and epigenetic events²⁻⁴. Based on the evidence that tumors with similar molecular characteristics arise and behave similarly, the molecular classification of CRC has been exponentially developed over the last decade^{5,6}. The main goal of this classification is to empirically predict the pathogenesis and biological behavior of each tumor, which may have diagnostic, prognostic and therapeutic implications.

Based on the presence of microsatellite instability (MSI), the hallmark of DNA mismatch repair (MMR) deficiency, CRC is classified in 3 groups: Lynch syndrome, sporadic MSI and microsatellite stable (MSS) tumors^{7,8}. Lynch syndrome, which accounts for 3% of all CRCs is caused by a germline mutation in one of the MMR genes (MLH1, MSH2, MSH6 and PMS2)⁷. Tumors from Lynch syndrome patients are typically characterized by MSI and/or the absence of the protein corresponding to the mutated gene, and are associated with a better prognosis than MSS tumors⁹. On the other hand, the majority of CRC with MSI arise through biallelic somatic methylation of the MLH1 promoter in older patients with no familiar history of CRC (so called sporadic MSI)^{10,45}. This form of CRC, which accounts for ˜12% of all CRCs, arises through a process that involves the CpG island Methylator Phenotype (CIMP), is usually associated with BRAF mutations (never present in Lynch syndrome) and is associated with a reduced mortality.^{46,47} Finally, MSS tumors account for 85% of all CRCs and are characterized by chromosomal instability, high frequency of aneuploidy and worse prognosis compared to MSI tumors^{11,12}.

MicroRNAs (miRNAs) are small non-coding RNA molecules (˜18-22 nucleotides) that negatively regulate gene expression by inhibiting translation or inducing messenger RNA (mRNA) degradation¹³. Since their discovery, miRNAs have been implicated in various cellular processes including apoptosis, differentiation and cell proliferation and they have shown to play a key role in carcinogenesis¹⁴⁻¹⁷. Altered miRNA expression has been reported in most tumors, including CRC, and specific miRNAs dysregulated in certain types of cancers may act as biomarkers of diagnosis and outcome for that cancer type. Besides their potential as a diagnostic and prognostic tool, one of the most interesting biological features of miRNA, compared to mRNA, is that they are present in different tissues in a very stable form, and they are remarkably protected from endogenous degradation, thus making feasible to analyze their expression in archived materials. Finally, understanding the miRNA expression regulation is critical to gain insight into the different colorectal carcinogenesis pathways and their specific role as potential therapeutic targets.

The miRNA profile of CRC has been analyzed in several studies¹⁸⁻²³, however, only a few have specifically analyzed the different miRNA signatures between the different subtypes of CRC based on the presence of MSI²⁴⁻²⁷. Although the current evidence suggests that the miRNA profile can distinguish between MSI and MSS tumors, most studies have been limited to a modest number of samples. In addition, a majority of studies have used arrays with a limited number of miRNAs, and more importantly, none have validated their results in an independent set of samples. Another issue is that the nature of MSI in the tumor (Lynch syndrome or sporadic MSI) is usually not described, and consequently, the miRNA signature in Lynch syndrome tumors remain unknown. All these aspects are important for understanding the roles of miRNAs in CRC pathogenesis, and for better characterizing the potential diagnostic and prognostic features of miRNAs in the different subtypes of CRC.

The present invention addresses some of the issues raised above by analyzing the global miRNA signatures including a larger panel of miRNAs in various groups of well-characterized CRCs based on the presence of MSI in tissue samples or fecal samples obtained from a human subject and have validated the results in an independent set of samples. The results presented herein provide a large list of miRNAs that are dysregulated in CRC compared to the normal colonic tissue, and, more importantly, the present inventors show for the first time that Lynch syndrome and sporadic MSI tumors exhibit a different miRNA signature that distinguishes them.

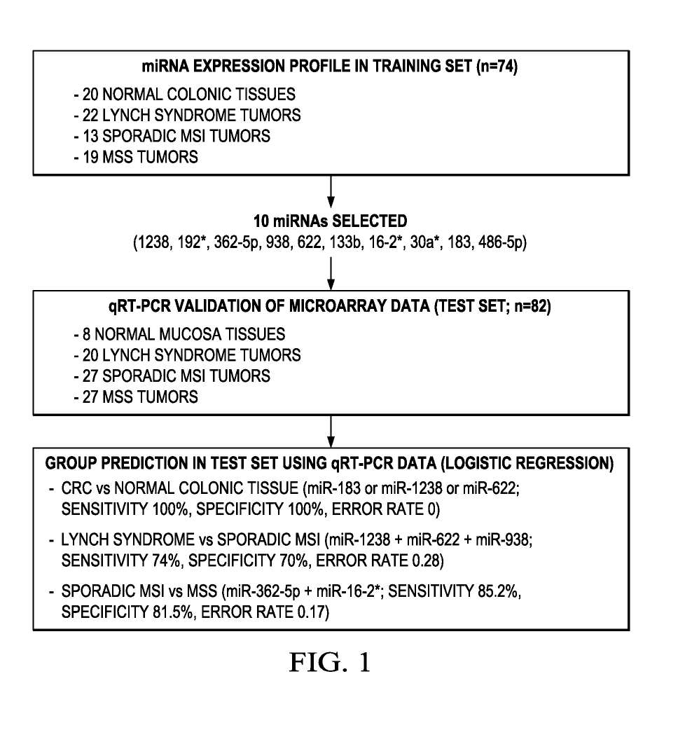

Patient selection: A total of 87 CRCs available as formalin-fixed paraffin-embedded (FFPE) tissues were divided into training and test sets (FIG. 1). The training set was used for miRNA microarray profiling and included 54 CRCs and 20 normal colonic (N—C) tissues. CRC tissues were divided in 3 groups: 1) Lynch syndrome (n=22) group was comprised of tumors with MMR deficiency (loss of MLH1/MSH2/MSH6/PMS2 protein expression and/or MSI). These tumors were collected from either carriers of a germline mutation in one of the MMR genes (n=13; 7 in MLH1, 5 in MSH2 and 1 in MSH6) or from patients fulfilling Amsterdam I/II criteria but without an identified germline mutation (n=9; 6 with loss of MLH1/PMS2 and 3 with loss of MSH2/MSH6); 2) sporadic MSI (n=13), which included tumors with loss of MLH1 protein expression from non-familial CRC cases associated with somatic MLH1 promoter methylation; and 3) MSS (n=19), which included mismatch proficient tumors. N—C tissues were obtained from individuals undergoing colonic surgery for reasons other than cancer (i.e., diverticulosis) showing microscopic normal mucosa.

The test set was used for qRT-PCR analysis and included an independent collection of Lynch syndrome (n=13; 4 with a germline mutation in MLH1, 5 in MSH2, 3 in MSH6 and 1 in EpCamdeletion) and sporadic MSI (n=20). This set of tumors was used to develop a miRNA-based predictor to distinguish both types of MSI based on the microarray results from the training set. These samples were obtained from different institutions (Lynch syndrome tumors from Brigham and Women's Hospital, Boston and Hospital Universitario de Alicante; sporadic MSI from Hospital Universitariode Alicante and Hospital Clinic of Barcelona). The clinico-pathological features of the samples included in the study are detailed in Tables 1 and 2. Informed written consent was obtained from all patients and the project was approved by the institutional review board of all participating institutions.

Mismatch repair deficiency analysis: Tumor MMR deficiency was evaluated in all cases by MSI analysis and/or immunohistochemistry for MLH1/MSH2/MSH6/PMS2 proteins. MSI testing was performed using the five markers of the original Bethesda panel (BAT25, BAT26, D2S123, D5S346 and D17S250).⁴⁸ Since mononucleotide sequences have been shown to have a better performance to identify MSI-high tumors, the inventors confirmed the MSI results using five quasi-monomorphic mononucleotide markers (BAT25, BAT26, NR21, NR24 and NR27) as recently described²⁸. MSI was defined as the presence of ≧2 unstable markers for the Bethesda panel, and ≧3 unstable markers for the mononucleotide pentapanel. Tumors with instability at any locus were labeled as MSS. All MSI tumors included in the study displayed instability at mononucleotide sequences, and none showed instability at a single locus. Immunohistochemistry for the 4 MMR proteins was performed as previously described.⁴⁹

Germline mutational analysis of the MMR genes was performed by Myriad Genetics, Inc. (Salt Lake City, Utah). Tumor MLH1 promoter methylation was analyzed by either methylation-specific PCR or bisulfite pyrosequencing as previously described.⁵⁰

RNA extraction: Total RNA from 10 μm thick macrodissected FFPE tissue cuts was isolated using the RecoverAll™ Total Nucleic Acid Isolation Kit for FFPE tissues (Ambion Inc, Austin, Tex.) according to manufacturer's instructions.

RNA processing: The global miRNA expression profile was analyzed using the MicroRNA Expression Profiling Assay based on the BeadArray™ v.2 (Illumina Inc., San Diego, Calif.), which contains 1,146 probes including 743 validated miRNAs. The miRNA microarray analysis was carried out with the collaboration of the Genomics Platform CICbioGUNE (Center for Cooperative Research in Biosciences, Derio, Spain). The assay was performed following manufacturer's instructions (Illumina, Inc. San Diego, Calif., USA), as previously described^{29,30}.

Microarray data normalization: Data were extracted using BeadStudio data analysis software and transformed to the log base 2 scale. Microarray data from 74 samples (20 N—C, 22 Lynch, 13 sporadic MSI and 19 MSS) were quantile-normalized using Lumi bioconductor package³¹. Next, the inventors employed a conservative probe-filtering step excluding those probes not reaching a detection p value lower of 0.05 in the 90% of samples, which resulted in the selection of a total of 891 probes out of the original 1146 set. Fold changes (FC) in miRNA expression in the microarrayanalyses were calculated based on the difference of the group median values (2 log base 2 difference). All microarray data discussed herein have been deposited in NCBI's Gene Expression Omnibus (GEO; accession number GSE30454).

TABLE 1
Clinico-pathological characteristics of patients included in the study.

| | N-C | | Sporadic | | Lynch | | | | | |
|---|---|---|---|---|---|---|---|---|---|---|
| | patients | | MSI | | syndrome | | p | MSS | | p |
| Characteristic | (n = 20) | | (n = 33) | | (n = 35) | | value^{a} | (n = 19) | | value^{b} |
| Age (±standard | 64.4 | (15.8) | 65.3 | (12.6) | 47.5 | (11.7) | <0.0001 | 67.1 | (12.0) | 0.629 |
| deviation) | | | | | | | | | | |
| Sex, n (%) | | | | | | | | | | |
| Males | 10 | (50) | 16 | (48.5) | 19 | (54.3) | 0.808 | 8 | (42.1) | 0.775 |
| Females | 10 | (50) | 17 | (51.5) | 16 | (45.7) | | 11 | (57.9) | |

| Tumor location*, n (%) | | | | | | | | |
|---|---|---|---|---|---|---|---|---|
| Proximal | 26 | (78.8) | 20 | (57.1) | 0.146 | 5 | (26.3) | <0.0001 |
| Distal | 5 | (15.2) | 11 | (31.4) | | 14 | (73.7) | |
| Unknown | 2 | (6) | 4 | (11.4) | | — | | |
| Tumor stage, n (%) | | | | | | | | |
| I | 2 | (6) | 8 | (22.9) | 0.065 | 3 | (15.8) | 0.334 |
| II | 15 | (45.5) | 11 | (31.4) | | 9 | (47.4) | |
| III | 7 | (21.2) | 9 | (25.7) | | 6 | (31.6) | |
| IV | 7 | (21.2) | 2 | (5.7) | | 1 | (5.2) | |

| Unknown | 2 | (6) | 5 | (14.3) | | — | |
|---|---|---|---|---|---|---|---|
| MMR protein | | | | | | | |
| expression, n (%) | | | | | | | |
| Loss of MLH1 | 31 | (93) | 17 | (48.6) | 0.0001 | — | — |

| | | | | |
|---|---|---|---|---|
| Loss of MSH2 | — | 14 | (40) | — |
| Loss of MSH6 | — | 4 | (11.4) | — |

| | | | | | |
|---|---|---|---|---|---|
| Normal expression | 2 | (7) | — | 19 | (100) |

*Relativeto the splenic flexure.
^{a}p-value for the comparison of sporadic MSI vs Lynch syndrome
^{b}p-value for the comparison of sporadic MSI vs MSS

TABLE 2
Clinico-pathological characteristics of patients included in the study.

| | | | Lynch | | Lynch | | | Sporadic | | Sporadic | | | | | | | |
|---|---|---|---|---|---|---|---|---|---|---|---|---|---|---|---|---|---|
| | Non-tumor | | syndrome | | syndrome | | | MSI | | MSI | | | MSS | | MSS | | |
| Charac- | patients | | Training set | | Test set | | p | Training set | | Test set | | p | Training set | | Test set | | p |
| teristic | (n = 20) | | (n = 22) | | (n = 13) | | value | (n = 13) | | (n = 20) | | value | (n = 19) | | (n = 19) | | value |
| Age | 64.45 | (15.81) | 46.32 | (12.54) | 49.54 | (10.14) | 0.438 | 67.38 | (10.25) | 63.95 | (13.94) | 0.451 | 67.11 | (12.04) | 64.89 | (13.86) | 0.603 |
| (±standard | | | | | | | | | | | | | | | | | |
| deviation) | | | | | | | | | | | | | | | | | |
| Sex, n (%) | | | | | | | | | | | | | | | | | |
| Males | 10 | (50) | 9 | (40.9) | 10 | (76.9) | 0.08 | 4 | (30.8) | 12 | (60) | | 8 | (42.1) | 7 | (36.8) | |
| Females | 10 | (50) | 13 | (59.1) | 3 | (23.1) | | 9 | (69.2) | 8 | (40) | | 11 | (57.9) | 12 | (63.2) | |
| Race, | | | | | | | | | | | | | | | | | |
| n (%) | | | | | | | | | | | | | | | | | |
| Cau- | 20 | (100) | 21 | (95.4) | 13 | (100) | 1 | 13 | (100) | 20 | (100) | 1 | 14 | (73.7) | 12 | (63.2) | 0.630 |
| casians | | | | | | | | | | | | | | | | | |

| African- | — | — | | — | | | — | | — | | | 1 | (5.3) | 2 | (10.5) | |
|---|---|---|---|---|---|---|---|---|---|---|---|---|---|---|---|---|
| americans | | | | | | | | | | | | | | | | |
| Hispanics | — | — | | — | | | — | | — | | | 3 | (15.8) | 4 | (21) | |
| Others | — | 1 | (4.6) | — | | | — | | — | | | 1 | (5.2) | 1 | (5.3) | |
| Tumor | | | | | | | | | | | | | | | | |
| loca- | | | | | | | | | | | | | | | | |
| tion, | | | | | | | | | | | | | | | | |
| n (%) | | | | | | | | | | | | | | | | |
| Proximal | | 16 | (72.3) | 4 | (30.8) | 0.217 | 8 | (61.5) | 18 | (90) | 0.008 | 5 | (26.3) | 5 | (26.3) | 1 |
| Distal | | 6 | (27.7) | 5 | (38.5) | | 5 | (38.5) | — | | | 14 | (73.7) | 12 | (63.2) | |
| Unknown | | — | | 4 | (30.8) | | — | | 2 | (10) | | — | | 2 | (10.5) | |
| Tumor | | | | | | | | | | | | | | | | |
| stage, | | | | | | | | | | | | | | | | |
| n (%) | | | | | | | | | | | | | | | | |
| I | | 4 | (18.2) | 4 | (30.8) | 0.324 | 1 | (7.7) | 1 | (5) | 0.189 | 3 | (15.8) | 1 | (5.3) | 0.261 |
| II | | 8 | (36.4) | 3 | (23) | | 9 | (69.2) | 6 | (30) | | 9 | (47.4) | 11 | (57.9) | |
| III | | 8 | (36.4) | 1 | (0.8) | | 2 | (15.4) | 5 | (25) | | 6 | (31.6) | 3 | (15.8) | |
| IV | | 1 | (4.5) | 1 | (0.8) | | 1 | (7.7) | 6 | (30) | | 1 | (5.2) | 4 | (21) | |

| Unknown | 1 | (4.5) | 4 | (30.8) | | — | | 2 | (10) | | — | — | |
|---|---|---|---|---|---|---|---|---|---|---|---|---|---|
| MMR | | | | | | | | | | | | | |
| protein | | | | | | | | | | | | | |
| expres- | | | | | | | | | | | | | |
| sion, | | | | | | | | | | | | | |
| n (%) | | | | | | | | | | | | | |
| Loss of | 13 | (59) | 4 | (30.8) | 0.135 | 13 | (100) | 18 | (90) | 1 | — | — | — |
| MLH1 | | | | | | | | | | | | | |

| | | | | | | | | |
|---|---|---|---|---|---|---|---|---|
| Loss of | 8 | (36.5) | 6 | (46.2) | — | — | — | — |
| MSH2 | | | | | | | | |
| Loss of | 1 | (45.5) | 3 | (23) | — | — | — | — |
| MSH6 | | | | | | | | |

| Normal | — | — | — | — | | — | — |
|---|---|---|---|---|---|---|---|
| expres- | | | | | | | |
| sion | | | | | | | |
| Undeter- | — | — | — | 2 | (10) | — | — |
| mined | | | | | | | |

The miRNA-based biomarkers described hereinabove can also be detected in human stool specimens. The present inventors utilize two different approaches for miRNA-based biomarker detection a commercially available phenol-chloroform kit based method with some modifications for miRNA extraction from stool specimens and a direct method to amplify miRNA directly from stool specimens without any prior miRNA extraction (direct miRNA analysis—DMA). These two approaches are described below.

miRNA extraction from stool specimens using modified phenol chloroform based methods: Extraction of miRNA from stool specimens was performed with a phenol-chloroform based kit (Qiagen's miRNAeasy Mini kit) with some modifications, which is designed for miRNA extraction from tissue and blood specimens. 20-100 mg of frozen stool was mixed with QIAzol Lysis Reagent in the proportion 1:7-10 (stool:lysis reagent, a solution containing phenol and guanidine thiocyanate) and vortexed thoroughly for 60 sec. The stool specimen was placed in a QIAshredder homogenizing column and centrifuged at a maximum speed of 14,000 rpm for 2 min. at room temperature (RT). Thereafter, the QIAshredder column was discarded and the tube lid was closed and placed at the bench top for 5 min. at RT. Subsequently, chloroform was added to this mix in the proportion 5:1 (lysed stool:chloroform), and the contents were pipetted up and down several times to allow thorough mixing, followed by brief vortexing for 3-5 sec. The tube was then left on the bench top for an additional 2-3 min. at RT. This was followed by centrifugation for 15 min. at 14,000 rpm at 4° C. The upper (aqueous) phase was transferred to a new collection tube and mixed with 1.5 volumes of 100% ethanol and the contents were mixed thoroughly by pipetting up and down several times. Up to 700 μl of the content of the tube was transferred to an RNAeasy Mini spin column supported in a 2 ml collection tube. The tube was centrifuged at 10,000 rpm for 30 s at RT. The flow through was discarded and if necessary, the previous step was repeated with the rest of the mixture one more time. 700 μl of the RWT buffer was added to the RNAeasy Mini spin column, followed by centrifugation for 30 s at 10,000 rpm at RT. The flow through was discarded and 500 μl of Buffer RPE was added to the RNAeasy Mini spin column. Centrifugation was repeated at 10,000 rpm for 30s at RT. The flow through was discarded and another 500 μl of Buffer RPE was added to the RNAeasy Mini spin column. Centrifugation was repeated at 10,000 rpm for 2 min. at RT and the RNAeasy Mini spin column was placed into a fresh 2 ml collection tube and centrifuged at full speed at RT for 1 min. The RNAeasy Mini spin column was transferred to a new 1.5 ml collection tube. Approximately 30-50 μl of RNase-free water was added directly onto the column membrane. The contents were allowed to sit on the bench top for 5 min. and then centrifuged at 10,000 rpm for 1 min. at RT to elute the total miRNA/RNA in the RNase-free water. Following the extraction, the samples were placed on ice for further analysis or stored at −80° C. The phenol-chloroform method is based on the principle of homogenization or lysis with phenol and guanidine isothiocyanate, followed by separation with chloroform the RNA from aqueous phase. This is followed by RNA precipitation with isopropyl alcohol, washing with 75-100% ethanol, air drying, and redissolving the pelleted RNA with RNase free water.

Direct miRNA PCR amplification from stool specimens without extraction (Direct MicroRNA Analysis—DMA): The inventors have developed a new method, which obviates the need for prior miRNA extraction called as Direct miRNA Analysis (DMA). The stool specimens were suspended in RNase free water or 0.89% NaCl by taking 1 volume of stool specimen and mixing it with 10 volumes of NaCl solution (1:10 dilution). Diluted stool specimens were thereafter centrifuged at 4,000×g for 5-10 min. at 4° C. Optionally, the supernatant was further filtered with a 0.2 μm filter and either stored at −80° C. until used, or immediately processed for direct amplification of a target miR.

Differential miRNA expression assessment and prediction: An outline of the study design is depicted in FIG. 1. The inventors first used linear models for Microarray data (LIMMA) to identify miRNAs differentially expressed between the four groups included in the study (N—C, Lynch syndrome, sporadic MSI and MSS) within the filtered 891-probe set³². LIMMA uses linear models and empirical Bayes paired moderated t-statistics and F-statistics. Since the MicroRNA Expression Profiling Assay from Illumina includes 403 non-validated probes, these were not considered for further analyses. False discovery rates (FDR) were determined using Benjamini-Hochberg procedure³². The top most significant 50 miRNAs using F-statistics were used on the 74 sample-set to perform a correspondence analysis as implemented in the bga (between group analysis) function included in the made4 package³³. This method is capable of visualizing high-dimensional data (such as multiple expression measurements) in a 2D graph in which the areas delimited by the ellipses represent 95% of the estimated binormal distribution of the sample scores on the first and second axes³⁴.

Predictability of the most discriminant miRNAs was further explored by using the nearest shrunken centroid classifier implemented in the PAM package to identify the minimal set of miRNAs capable of discriminating between the following groups: tumor tissue (CRC) vs N—C, Lynch vs sporadic MSI, and sporadic MSI vs MSS³⁵. To estimate the classification accuracy of the miRNA signature on the training set (sensitivity, specificity and overall accuracy), a 10-fold cross-validation was conducted by selecting the threshold associated with the lowest error rate and filtering the noisiest genes³⁶. For each of these groups, the PAM classifier was then used to perform a multidimensional scaling analysis on the basis of between-sample Euclidean distances as implemented by the isoMDS function in R. This method is capable of visualizing high-dimensional data (such as multiple expression measurements) in a 3D graph in which the distances between samples are kept as unchanged as possible³⁶.

Validation of microarray data by TaqMan RT-PCR: The expression of a subset of 10 miRNAs was determined in the test set. The selection of miRNAs for validation was rigorously based on the following criteria: log base 2 intensity≧8, FDR <5%, fold change (FC) and selection in either LIMMA or PAM analyses. Expression of miRNAs was analyzed using the TaqMan miRNA Assay (Applied Biosystems Inc., Foster City, Calif.) as previously described. The expression of miR-16 was used as endogenous control³⁷. All studies were performed in triplicate. In order to normalize the miRNA expression levels from different experiments, the miRNAs expression in each sample was calculated by comparing the normalized Ct of the sample with a normalized Ct of a technical replicate common in all experiments (ΔΔCt=ΔCt of sample—ΔCt of technical replicate). Fold change was calculated based on the 2^{-deltadeltaCt}method. Selected target miRNAs for qRT-PCR experiments included 10 miRNAs that were selected among LIMMA or PAM analyses: miR-1238, miR-192*, miR-362-5p, miR-938, miR-622, miR-133b, miR-16-2*, miR-30a*, miR-183 and miR-486-5p. The results from these analyses are shown in Table 6.

To evaluate the performance of each individual miRNA to differentiate between groups based on the ΔΔCt value, the inventors constructed ROC curves and determined the sensitivity and specificity considering the threshold associated with minimum error rate. Logistic regression analysis was used to evaluate the performance of the combination of different miRNAs. The inventors then evaluated the expression of the same 10 target miRNAs in an independent set of MSI tumor samples (n=33), including Lynch syndrome and sporadic-MSI tumors (test set). Based on this analysis the inventors developed a miRNA-based predictor model to differentiate the type of MSI (Lynch syndrome vs sporadic MSI). The method implements a forward stepwise cross-validated procedure to find the optimal prediction model. The inventors specified the Linear Discriminant Analysis method as classification rule, and different candidate models were evaluated with 10-fold cross-validation and 1000 random split using the subset of 13 Lynch samples and 20 sporadic MSI samples. All these algorithms are included in the mipp. seq function from MiPP package.⁴² The performance of the resulting model was evaluated in the set of MSI tumors from the training set used for technical validation (n=14). The inventors then combined the MSI cases from both training and test set cohorts to assess the performance of the predictor model to discriminate the type of MSI based on the ΔΔCt value. The inventors constructed receiving operating curves and determined the AUROC (95% CI).

In situ hybridization: In situ detection of miR-622 on FFPE colonic tissues (5 primary CRC and 5 normal colonic mucosae) was performed as previously described.⁴³ Positive controls (RNU6B, Exiqon) and no probe controls were included for each hybridization procedure. Briefly, sections were deparaffinized and subsequently digested with proteinase K [50 μg/mL in 50 mmol/L Tris-HCl (pH7.5)] for 30 min. at room temperature. After proteinase K digestion, the sections were fixed in 4% paraformaldehyde at 4° C. for 10 min. and prehybridized in hybridization buffer [50% formamide, 50 μg/mL heparin, 5×SSC, 500 μg/mL yeast tRNA, 0.1% Tween 20, 9.2 mM citric acid] for 3 h and 15 min at 42° C. Subsequently, the slides were hybridized with 10 pmol probe (LNA-modified and DIG-labeled oligonucleotide; Exiqon) complementary to miR-622 in hybridization buffer overnight at 50° C. After incubation with anti-DIG-APFab fragments conjugated to alkaline phosphatase diluted 1:250 in blocking solution [2% goat serum, 2 mgr/mL BSA], the hybridized probes were detected by applying nitroblue tetrazolium/5-bromo-4-chloro-3-indolylphosphate color substrate (Roche) to the slides. Slides were mounted in glycerol and analyzed using a Zeiss AxioSkop2 multichannel microscope using AxioVision software (CarlZeiss Inc. Thornwood, N.Y.). Positive controls (RNU6B, Exiqon) and no probe controls were included for each hybridization procedure.

Statistical Analysis: Quantitative variables were analyzed using Student's test. Qualitative variables were analyzed using either the Chi Square Test or the Fisher's test. A two sided p-value of <0.05 was regarded as significant. Clinical data was analyzed using Graph Pad Prism 4.0 (San Diego, Calif.) statistical software.

Outline of the study: In this study the inventors performed global miRNA microarray profiling in a large collection of tumor and N—C tissues categorized by the presence MMR deficiency with the aim of recognizing the most significant differences in miRNA expression. In particular, this is the first study of the miRNA expression profile in Lynch syndrome, the most common form of hereditary CRC, and compares it with the sporadic form of MMR deficiency, caused by somatic inactivation of MLH1 by methylation of its promoter. The study was conducted in three steps: a) miRNA microarray profiling in a training set (n=74) comprised of 4 well-defined groups: N—C tissue, Lynch syndrome tumors, sporadic MSI tumors and MSS tumors; b) technical validation of the most significant results by qRT-PCR in an randomly selected subset of samples from the training set (n=30); and c) development of a predictor to differentiate the type of MSI (Lynch syndrome vs sporadic MSI tumors) using an independent set of samples (n=33)(FIG. 1). Clinico-pathological characteristics of all patients included in this study are summarized in Tables 1 and 2. Overall, there were no clinical differences between the training set and the test set.

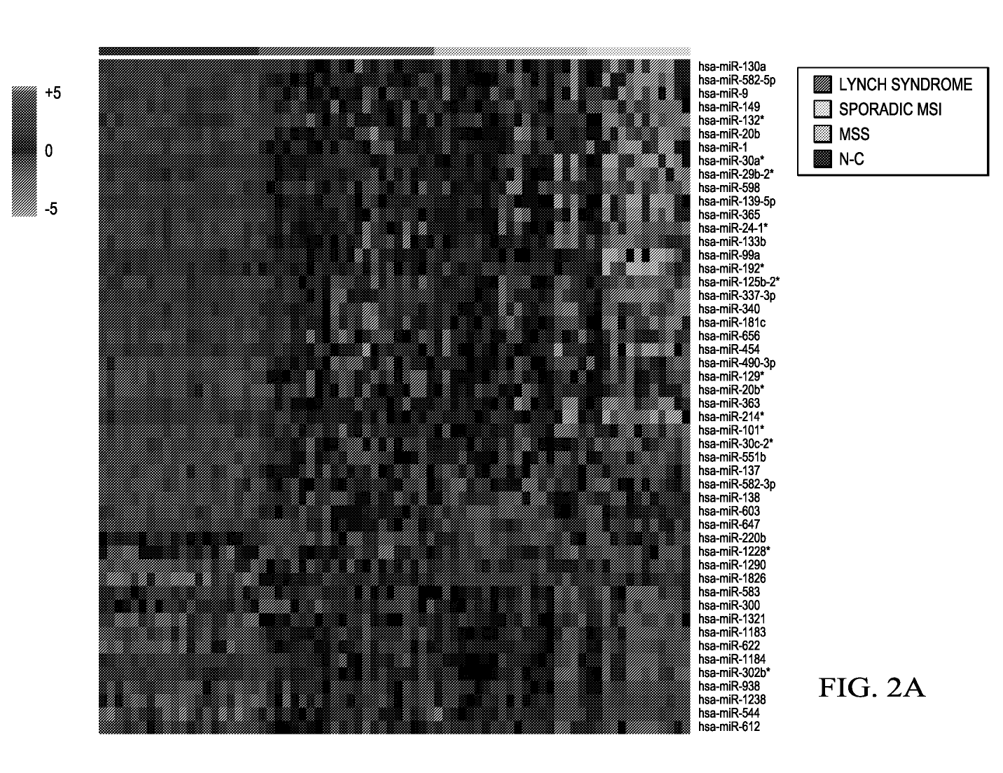

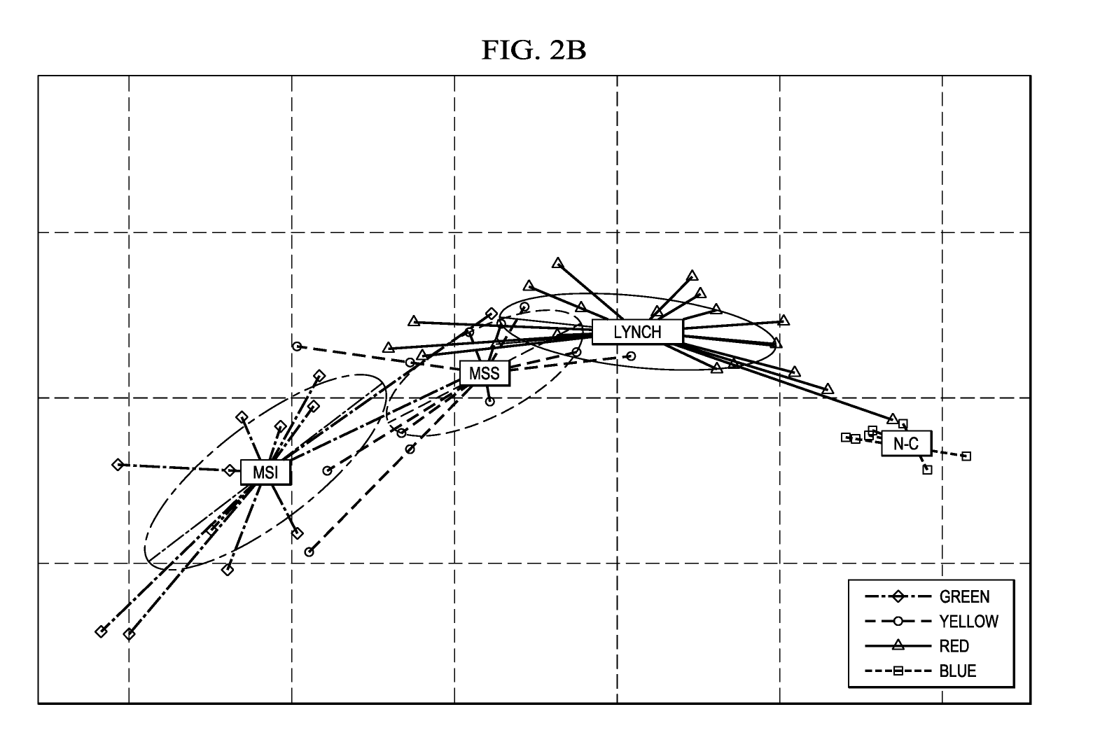

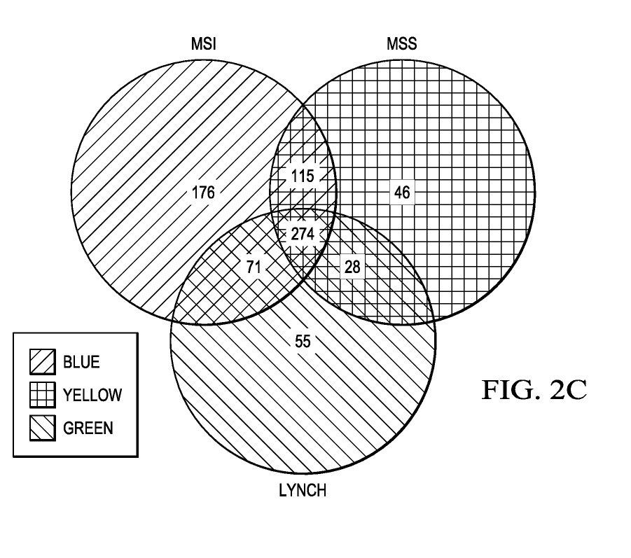

A miRNA expression signature discriminates normal colonic mucosa from tumor tissue: The inventors first used linear effects models (LIMMA) to determine the miRNAs differentially expressed between the four groups included in the study identifying 692 probes with an adjusted F<0.05. Expression profiles of the 50 most significant miRNAs are depicted in FIG. 2A. Between group analysis (bga) plot was then performed to visually represent the distance/separation between the 4 different groups according to the expression of the 50 most significant miRNAs. As depicted in FIG. 2B, N—C tissues and tumor tissues appeared as 2 clearly separated groups and within tumor samples, sporadic MSI, MSS and Lynch syndrome tumors were also visibly different.

The inventors identified 499 probes differentially expressed between normal colonic mucosa and tumor tissue (FDR<0.05). To identify the minimal set of miRNAs capable of predicting tumor tissues, PAM was performed comparing tumor vs N—C tissue resulting in the identification of 9 miRNAs (all of them present in the LIMMA list) with an overall error rate of 0.027 (accuracy, 98.6%; sensitivity, 98.2%; specificity, 100%) (Table 3). In particular, upregulation in tumor tissue of miR-1238, miR-938, miR-622 and downregulation of miR-133b, miR-490-3p, miR-138 and miR-1 were among the most significantly dysregulated miRNAs. Overall, the miRNA microarray data resulted in the identification of a set of miRNAs capable of discriminating tumor vs N—C mucosa with high degree of accuracy.

The inventors then analyzed the specific miRNA profile for each tumor type compared to N—C mucosa, and found that a subset of 176, 46 and 55 probes were exclusively and significantly dysregulated in sporadic MSI, MSS and Lynch syndrome tumors, respectively (FIG. 2C).

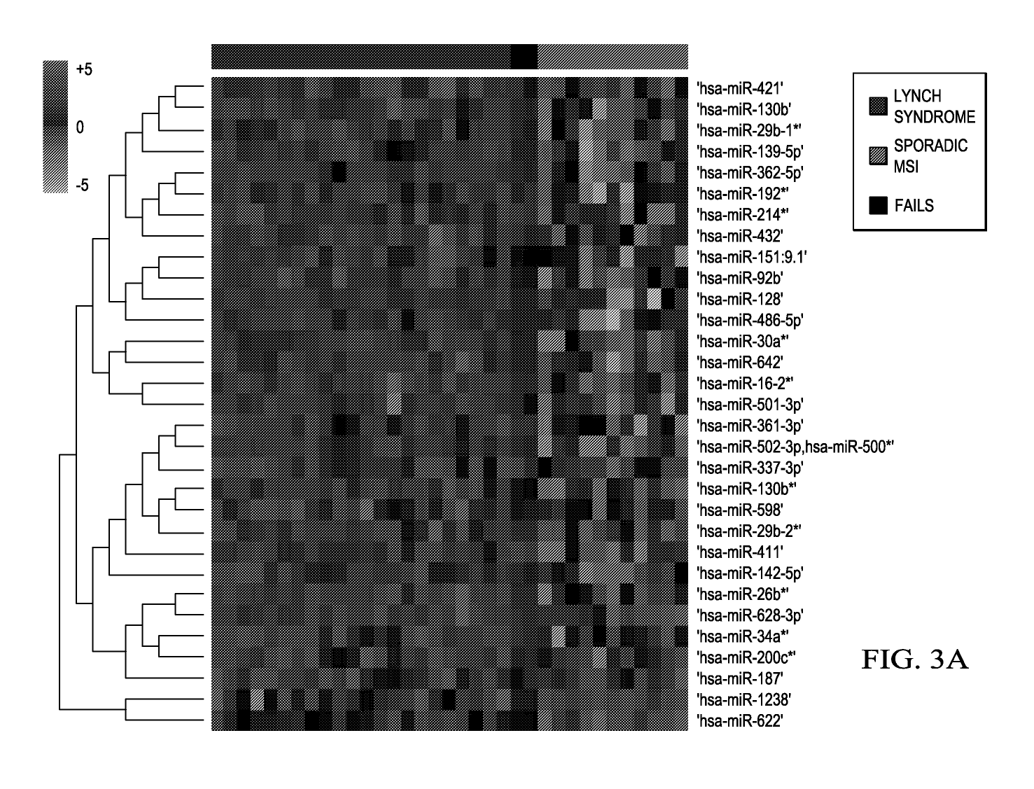

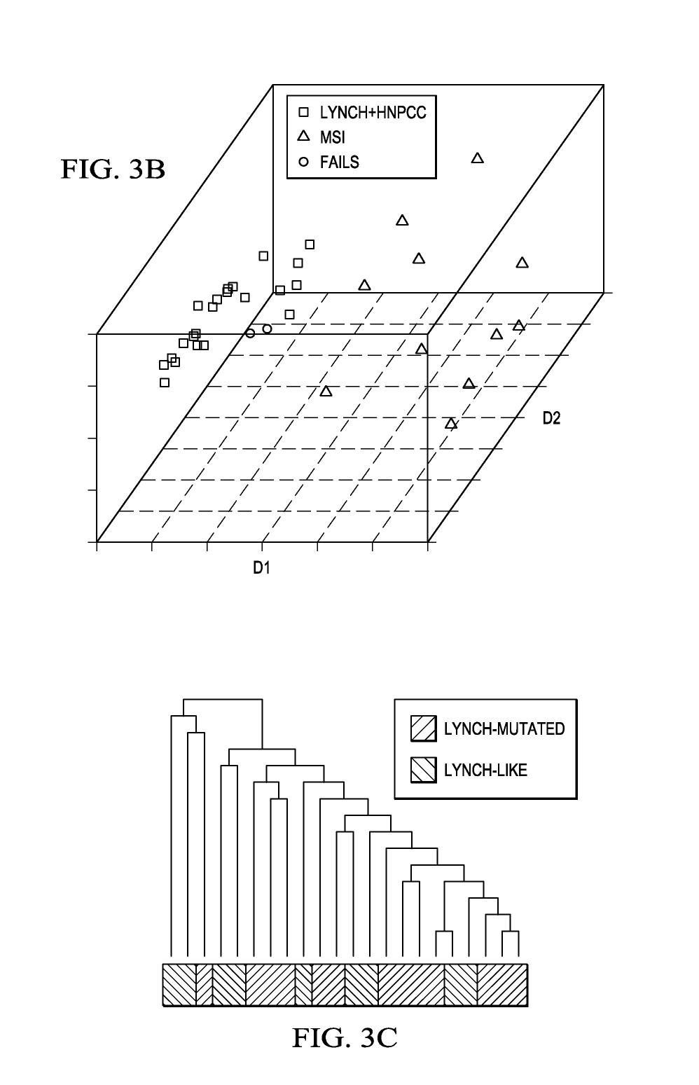

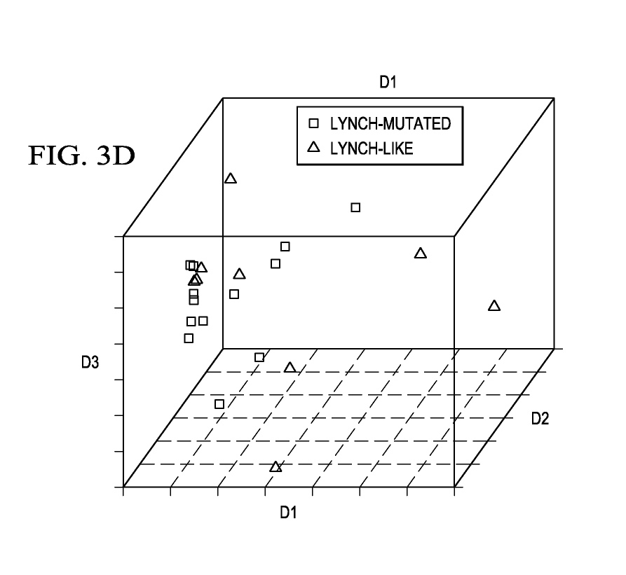

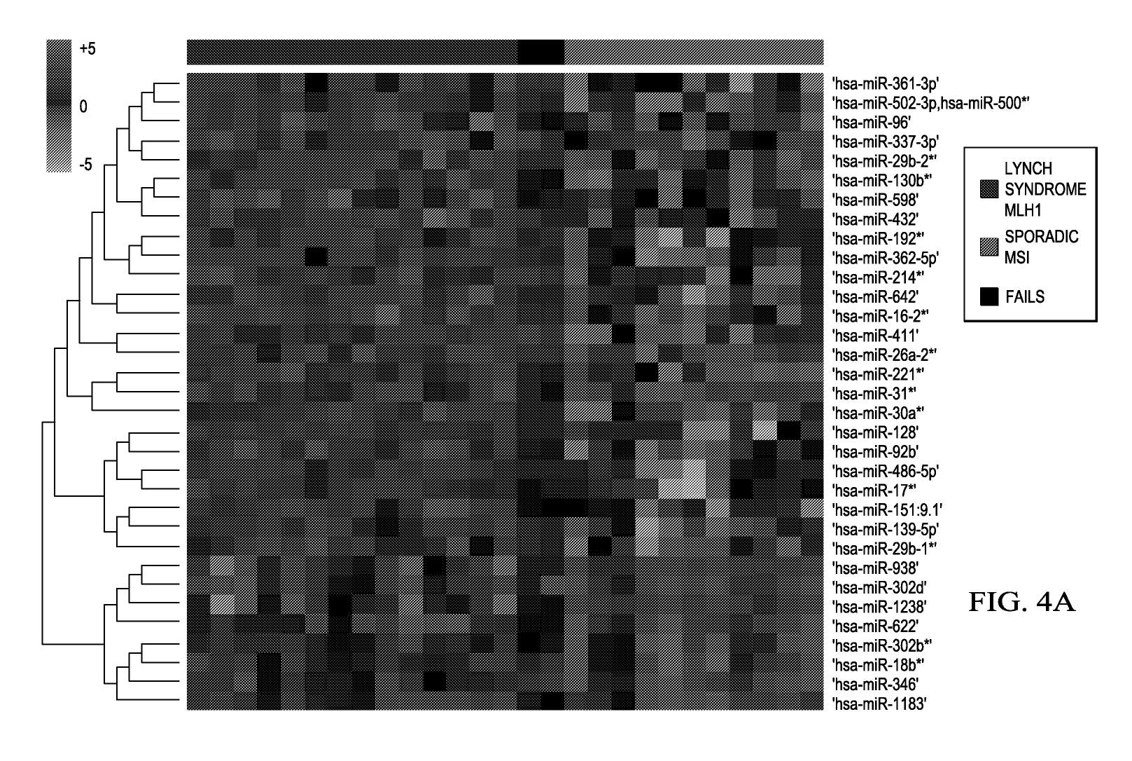

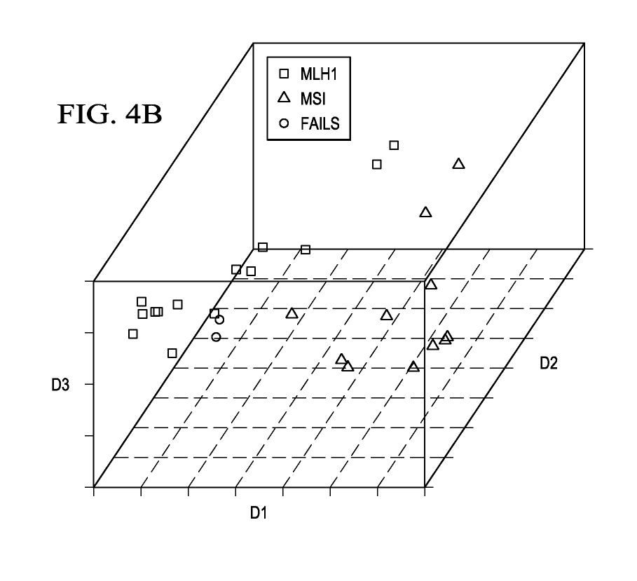

A miRNA expression signature discriminates Lynch syndrome from sporadic MSI tumors: The inventors then evaluated the ability of microarray data to predict the molecular type of CRC based on the type of MMR deficiency. Lynch syndrome accounts for about 3% of all MSI CRC and is caused by germline mutations in DNA MMR genes, whereas the most frequent cause of MSI involves CIMP, associated with somatic methylation of the MLH1 gene. The inventors identified 418 probes differentially (FDR<0.05) expressed between these two groups. To explore the possibility to distinguish both types of MSI based on the miRNA microarray signature, a PAM prediction (FIG. 3A) was employed, identifying a set of 31 miRNAs (29 downregulated and 2 upregulated) able to predict the type of MSI with an overall error rate of 0.057 (accuracy, 94.3%; sensitivity, 84.6%; specificity, 100%) (Table 4). The most up and down-regulated miRNAs in Lynch syndrome tumors compared to sporadic MSI included miR-30a*, miR-16-2*, 362-5p and miR-1238 and miR-622, respectively. Multidimensional scaling was next used to plot Lynch syndrome and sporadic MSI samples based on the PAM-derived signature, and there was a remarkable separation between them (FIG. 3B). When a subanalysis was performed comparing only those Lynch syndrome tumors with MLH1 mutation compared to sporadic MSI, the inventors obtained the same different miRNA patterns than analyzing all Lynch syndromes together demonstrating that miRNA profiles do not exclusively depend on MLH1 mutation (FIGS. 4A and 4B). Overall, these results suggest that Lynch syndrome and sporadic MSI CRCs can be distinguished based on the miRNA expression profile.

The Lynch syndrome group included in the present study involved both tumor tissues from patients with an identified germline mutation in one of the DNA MMR genes (i.e., Lynch-mutated), and tumor tissues with MMR deficiency belonging to patients that fulfilled the Amsterdam criteria but with a negative genetic test (i.e., Lynch-like). From the clinical standpoint both groups are considered the same disease and it is usually assumed that the underlying genetic mutation remains undetected by current analytical methods in the latter. To study the similarities between these two subgroups at miRNA expression level, the inventors performed an unsupervised hierarchical clustering analysis, and the dendogram revealed a lack of clustering between these 2 subgroups (FIG. 3C). Multidimensional scaling plot showed that both subgroups are grouped together, in concordance with the clinical phenotype (FIG. 3D). Overall, these results suggest that Lynch syndrome and sporadic MSI tumor can be distinguished based on the miRNA expression profile, and that Lynch syndrome-like patients with unidentified germline mutation show a similar miRNA profile compared to the mutated ones, suggesting the presence of a common molecular basis.

TABLE 3
Minimal set of miRNA discriminating tumor tissue from
normal colonic mucosa found in PAM analysis.

| miRNA | Fold change | Adjusted F | False discovery rate |
|---|---|---|---|
| hsa-miR-1238 | 20.70 | 2.13E−012 | 6.07E−009 |
| hsa-miR-938 | 27.11 | 1.06E−010 | 2.84E−008 |
| hsa-miR-622 | 11.18 | 1.31E−013 | 4.13E−010 |
| hsa-miR-1290 | 10.42 | 7.25E−012 | 3.75E−010 |
| hsa-miR-490-3p | −17.27 | 1.77E−012 | 1.78E−011 |
| hsa-miR-133b | −12.45 | 1.16E−010 | 5.79E−009 |
| hsa-miR-490-5p | −8.81 | 2.68E−009 | 1.30E−008 |
| hsa-miR-1 | −8.62 | 1.98E−009 | 7.20E−008 |
| hsa-miR-138 | −6.52 | 2.89E−013 | 5.36E−013 |

TABLE 4
Minimal set of miRNA discriminating Lynch syndrome
from sporadic MSI tumors found in PAM analysis.

| miRNA | Fold change | Adjusted F | False Discovery rate |
|---|---|---|---|
| hsa-miR-30a* | 20.73 | 3.92E−009 | 2.36E−005 |
| hsa-miR-16-2* | 14.44 | 5.83E−006 | 0.0005206 |
| hsa-miR-362-5p | 12.84 | 6.85E−008 | 5.27E−006 |
| hsa-miR-486-5p | 12.62 | 2.32E−006 | 0.0001440 |
| hsa-miR-337-3p | 10.60 | 1.42E−010 | 9.18E−005 |
| hsa-miR-642 | 10.59 | 3.95E−008 | 0.0002973 |
| hsa-miR-411 | 9.41 | 3.18E−007 | 0.0006335 |
| hsa-miR-214* | 9.39 | 6.53E−010 | 8.32E−006 |
| hsa-miR-187 | 8.89 | 4.72E−009 | 0.0007601 |
| hsa-miR-628-3p | 8.76 | 9.79E−008 | 0.0003597 |
| hsa-miR-142-5p | 8.70 | 3.48E−008 | 0.0010619 |
| hsa-miR-29b-1* | 8.66 | 0.0001527 | 0.0001576 |
| hsa-miR-361-3p | 8.57 | 4.03E−007 | 0.0001286 |
| hsa-miR-501-3p | 8.03 | 0.0008915 | 0.0010163 |
| hsa-miR-139-5p | 7.72 | 2.60E−009 | 0.0001576 |
| hsa-miR-192* | 7.26 | 1.42E−010 | 0.0001393 |
| hsa-miR-128 | 7.10 | 1.84E−006 | 0.0001286 |
| hsa-miR-29b-2* | 7.09 | 1.06E−011 | 5.27E−006 |
| hsa-miR-26b* | 7.02 | 6.80E−008 | 0.0002973 |
| hsa-miR-432 | 6.86 | 6.99E−006 | 0.0001286 |
| hsa-miR-92b | 6.59 | 4.03E−007 | 0.0002973 |
| hsa-miR-502-3p | 6.55 | 5.05E−007 | 0.0001408 |
| hsa-miR-34a* | 6.45 | 2.27E−007 | 0.0005381 |
| hsa-miR-200c* | 6.01 | 2.19E−006 | 0.0001785 |
| hsa-miR-130b | 5.85 | 1.57E−006 | 0.0002763 |
| hsa-miR-598 | 5.02 | 3.66E−013 | 4.33E−005 |
| hsa-miR-151:9.1 | 4.92 | 5.93E−007 | 8.32E−006 |
| hsa-miR-130b* | 4.83 | 7.23E−009 | 8.40E−005 |
| hsa-miR-421 | 4.81 | 2.92E−006 | 0.0001126 |
| hsa-miR-1238 | −9.60 | 2.13E−012 | 0.0014896 |
| hsa-miR-622 | −7.40 | 1.31E−013 | 0.0001286 |

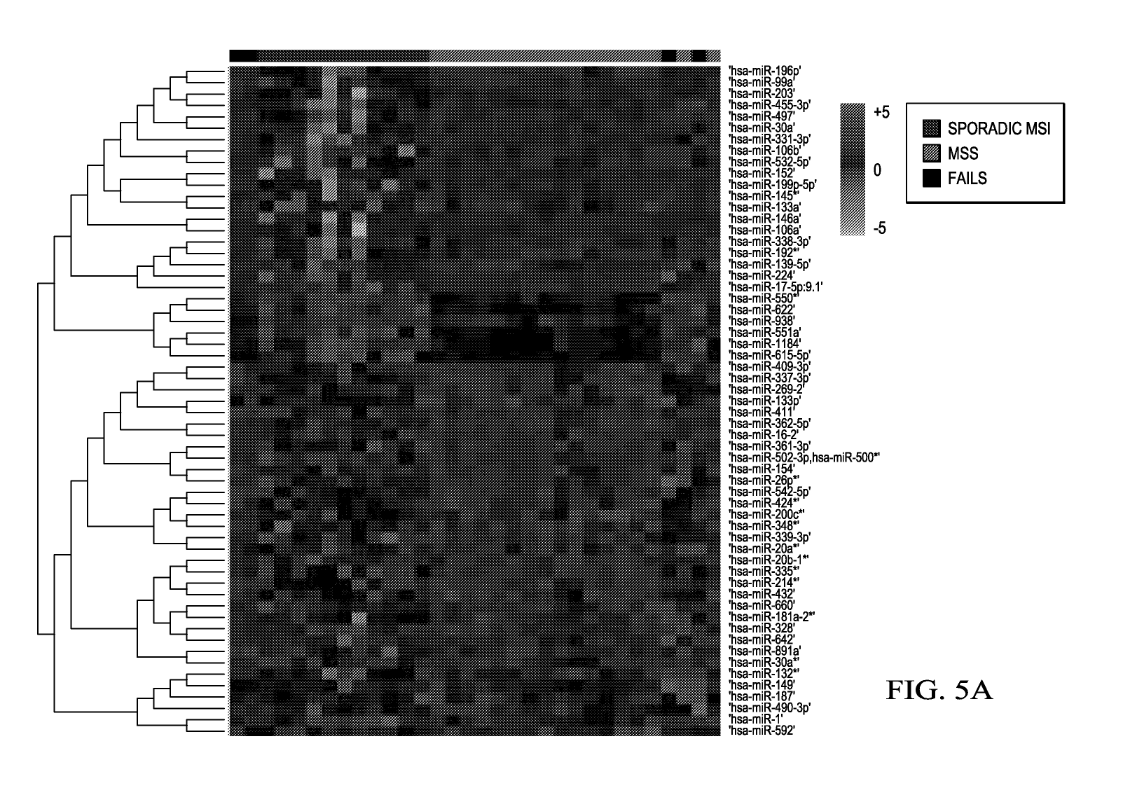

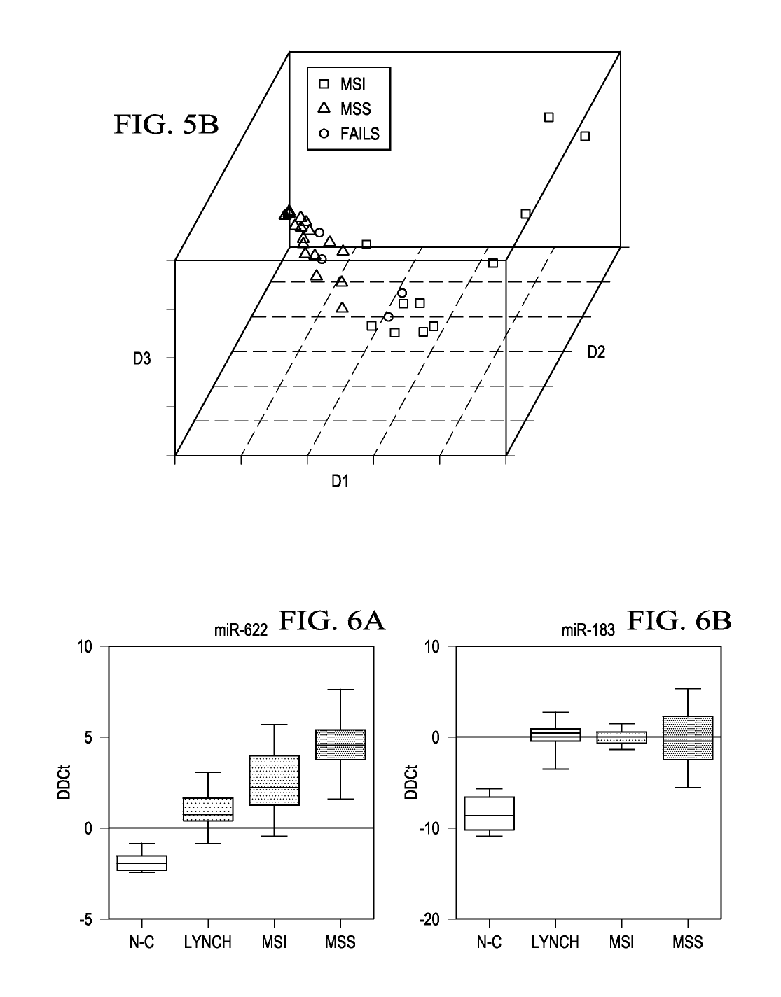

A miRNA expression signature discriminates between sporadic MSI and MSS tumors: The inventors identified 353 probes differentially expressed between sporadic MSI and MSS tumors (FDR<0.05). The analysis of miRNA expression profiles using PAM revealed a signature of 59 miRNAs capable of predicting the presence of MSI with an overall error rate of 0.124 (accuracy, 87.5%; sensitivity, 89.5%; specificity, 84.6%) (Table 5). The most up and down-regulated miRNAs in sporadic MSI compared to MSS tumors, included miR-938, miR-615-5p, miR-1184, miR-551a, miR-622 and miR-17-5p, miR-192* and miR-337-3p, respectively. Using the PAM cross-validation procedure, all but 4 tumors were correctly assigned, and although both groups showed separated in the multidimensional scaling plot (FIGS. 5A and 5B), the spatial differential distribution was not as clean as in the previous comparisons.

Validation of miRNA expression in the test set: The inventors employed TaqMan qRT-PCR to confirm the expression differences of target miRNAs identified by microarray in a different set of colon tissues (test set). Selected target miRNAs for qRT-PCR studies included 10 miRNAs that were selected among LIMMA or PAM analyses (miR-1238, miR-192*, miR-362-5p, miR-938, miR-622, miR-133b, miR-16-2*, miR-30a*, miR-183 and miR-486-5p). The most significant results are shown in Table 6. Overall, the inventors were able to validate the microarray results.

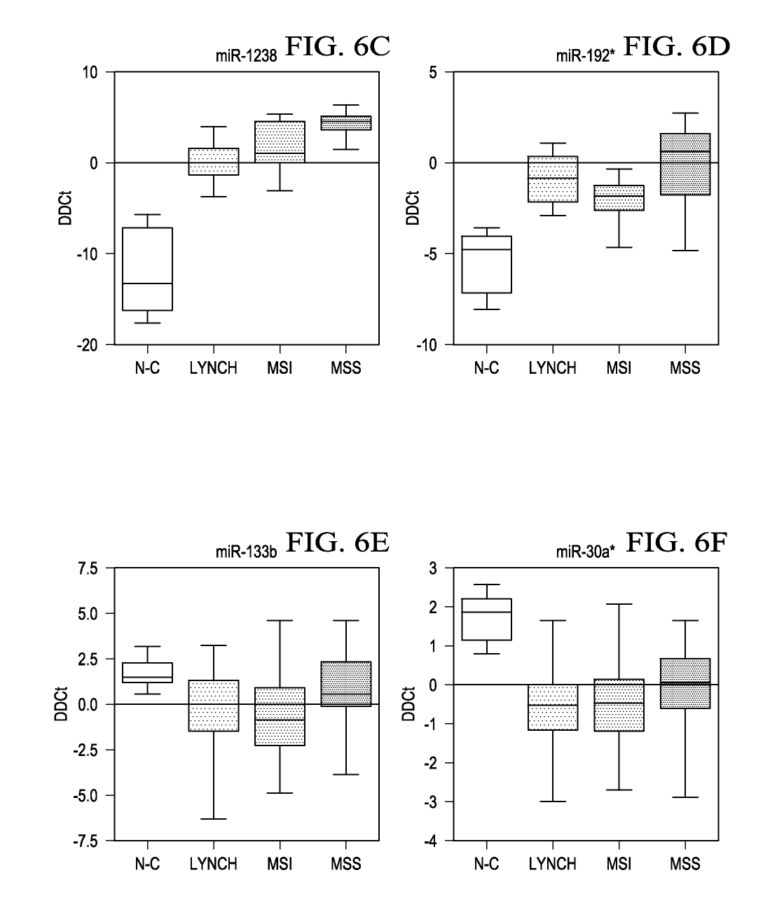

CRC vs normal colonic tissue: In this study the inventors discover and validate several miRNAs that are differentially expressed in CRC tissues compared to normal mucosa, and evaluated their performance using the qRT-PCR results from the test set. The inventors found for the first time that miR-1238 and miR-622 are consistently overexpressed in CRC. In addition, the inventors successfully validated previously known dysregulated miRNAs in CRC (miR-133b and miR-30a*). The inventors performed in situ hybridization using 5′-DIG-labeled LNA probes for miR-622 in several normal colonic mucosa and colorectal cancer tissues to further investigate the pattern of expression of this miRNA. In normal colonic mucosa, miR-622 was expressed only in the colonic epithelial cells throughout the colonic crypts, with a gradient of miRNA expression decreasing from the bottom to the top of the crypts (FIGS. 6A and 6B). CRC samples evaluated showed a marked increase in the expression of this miRNA, consistent with the observation herein that miR-622 is overexpressed in the majority of CRCs.

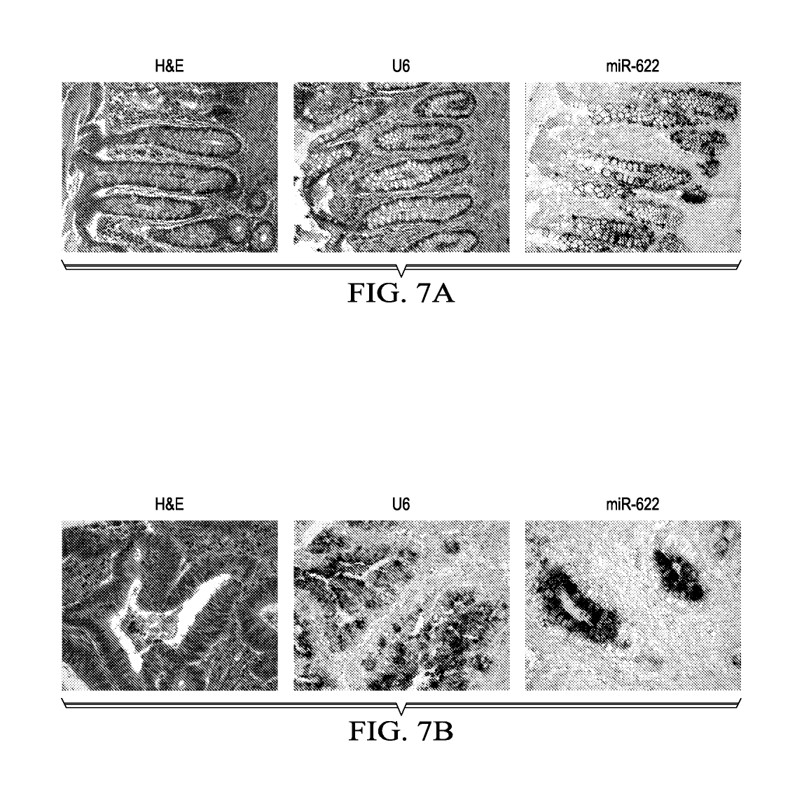

Differentiation of MMR-deficient tumors based on miRNA analysis: The present inventors developed a predictor able to differentiate the type of mismatch repair deficiency based onmiRNA analysis using an independent set of samples with sporadic-MSI (n=20) and Lynch syndrome tumors (n=13). For this purpose we analyzed by TaqMan qRT-PCR the expression of the 10 target miRNAs evaluated in the training set in an independent set of MSI tumors. Statistical analyses showed that the combination of the expression of 3 miRNAs (miR-622, miR-362-5p, miR-486-5p), all of them present in the PAM classifier identified in the microarray analysis, could differentiate the 2 types of MSI with high accuracy (AUROC, 0.77; 95% CI, 0.57-0.98) (FIGS. 7A and 7B). These results are of great significance since we could successfully validate the microarray results in an independent cohort of MSI CRC samples and develop a miRNA-based predictor to differentiate both types of MSI.

Taken together, qRT-PCR expression results confirmed the validity of miRNAs identified by microarrays, and revealed new miRNAs that can be used to distinguish these tumors in difficult cases.

In this study the inventors perform miRNA profiling by microarrays in a large group of CRCs categorized by the presence and type of MSI. The results presented herein show that miRNAs can be used to discriminate between normal vs tumor tissue, and more importantly within tumor subtypes. The inventors described for the first time the miRNA signature in Lynch syndrome tumors and compared it to its sporadic counterpart form of MSI, caused by somatic methylation of MLH1, showing that each type of MMR deficiency is associated with a unique miRNA signature. In addition, the inventors provide insight into the miRNA expression differences between sporadic MSI and MSS tumors. Finally, the inventors validate some of the most significant microarray results by qRT-PCR in a different cohort of tumor tissues, thus reinforcing the value and robustness of the results of the instant invention.

In agreement with previous reports, the findings of the present invention support that numerous miRNAs are aberrantly expressed in CRC relative to healthy tissues. Although several groups have profiled miRNAs in CRC tissues using different platforms^{21,22,25}, in the present study the inventors use the most comprehensive commercial platform so far, including 1,146 probes with 743 validated human miRNAs. Notably, the results herein are highly consistent with a recent publication using the same technology²⁴. Despite methodological differences between the present invention and previous reports, the inventors found concordant expression of previously reported miRNAs altered in tumorous tissues (i.e., downregulation of miR-9, miR-129, miR-137, miR-34b, miR-133b, miR-124 and upregulation of miR-183, miR-31, miR-182), and notably, we have discovered several new miRNAs that are significantly deregulated in tumor tissues (i.e., miR-1238, miR-938, miR-622, miR-1290, miR-490-3p). More importantly, qRT-PCR studies could confirm microarray data and show that the expression of a single miRNA (miR-1238, miR-622 or miR-938) can discriminate between tumor and N—C tissue. These results provide new potential miRNAs involved in the pathogenesis of CRC and new potential diagnostics and prognostic markers.

The inventors show here that miRNA patterns from Lynch syndrome tumors and sporadic MSI tumors are different. Although these two conditions share the same unique molecular mechanism of tumor development (i.e., MSI), the underlying cause is completely different. Lynch syndrome is an autosomal dominant disorder caused by germline mutations in one of the MMR genes (MLH1, MSH2, MSH6, PMS2) and accounts for a minority of MMR deficient tumors (˜20%). Sporadic MSI tumors, which account for the majority of MSI cases (˜80%), are caused by somatic inactivation of the MLH1 gene through biallelic methylation of its promoter in the setting of the so-called CpG island methylator phenotype (CIMP). CIMP tumors show altered patterns of DNA methylation, with concordant hypermethylation of several tumor suppressor genes, although the cause of this alteration remains unknown. In agreement with a distinct genetic and epigenetic background, the inventors found that both types of MSI can be distinguished by the miRNA profile. Microarray data revealed a set of 31 miRNAs that could be used as classifiers with high accuracy (AUROC, 0.94) (FIGS. 3A and 3B). Notably, the inventors successfully validate the upregulation of miR-1238 and miR-622 and downregulation of miR-192* in sporadic MSI compared to Lynch syndrome tumors in a different group of tumors, thus reinforcing the validity of the results. In addition, using an independent set of MSI tumors (including Lynch syndrome and sporadic MSI) the inventors found that the expression of 3 miRNAs identified in the microarray analysis (miR-622, miR-362-5p and miR-486-5p) could accurately classify the type of MSI. Since sporadic MSI tumors are consistently associated with the CIMP phenotype, it is plausible to suggest that this phenotype could explain the observed differences. In addition, Melo et al.⁴⁴ recently showed that somatic frameshift mutations in one of the miRNA processing genes (TARBP2) could explain the miRNA disruption in Lynch syndrome and sporadic MSI tumors. It is worth mentioning that Lynch syndrome tumors from MLH1, MSH2 and MSH6 mutation carriers shared the same miRNA profile, suggesting a common mechanism of miRNA dysregulation. Overall, the results presented herein shed light on the molecular mechanism underlying the sporadic MSI and Lynch tumors, and contribute to the generation of biomarkers to improve diagnosis and prognosis in these two forms of CRC.

Another interesting result from the study described herein is that MMR deficient tumors from patients that fulfill the Amsterdam criteria but with an unidentified germline mutation show a similar miRNA profile compared with those in whom the mutation has been identified. In clinical practice, in these cases it is usually assumed that the underlying genetic mutation has not been detected by current methods, but it remains possible that these tumors have a unique pathogenesis. The results presented herein support the hypothesis that these are all Lynch syndrome tumors, and that the germline mutations have been missed because of technical limitations in the gene analysis, since the global miRNA signatures resembles those in tumors from patients with known germline mutations in the MMR genes. This data suggest that the somatic miRNA profile could be used to predict the presence of a germline mutation in the MMR genes, which could have a significant impact in the genetic counseling of these patients.

Several studies have analyzed and compared the miRNA profile in MSI compared to MSS tumors²⁴⁻²⁷. It is noteworthy, however, that the consistency of the results regarding the miRNAs that distinguish both types of tumors has been poor. These discrepancies can potentially respond to multiple reasons. First, although is very likely that in previous studies most of the considered MSI cases were consequence of somatic methylation of MLH1 promoter, based on these results, the presence of Lynch syndrome tumors in the MSI group would have biased the results, and accordingly, grouping both groups of tumors for miRNA research purposes should be reevaluated. In this sense, a recent publication by Earle et al.²⁷ tried to validate the results of a previously published profile performed by Lanza et al.²⁶ and only 3 out of 8 miRNAs showed similar results using qRT-PCR. Secondary, discrepancies between results obtained with different microarrays are common and mainly determined by the technology used (amplification vs no amplification and probe design). For this reason, a proper validation in an independent cohort of samples is always preferable. Third, biological differences other than the presence of MSI (ex. TNM stage, presence of KRAS/BRAF mutations) could also explain the discrepancy between studies. Finally, although most of the studies about miRNA expression in cancer tissues have been performed on frozen fresh samples, the greater availability of FFPE tissue samples has prompted the use of these types of samples for miRNA profiling. Although this could confer a potential bias, several studies have shown that miRNAs are well preserved in FFPE tissues, and there is a high correlation in miRNA expression between fresh frozen and FFPE tissues³⁸⁻⁴¹. The microarray data present herein can validate a significant numbers of miRNAs shown previously to be differentially expressed between healthy and CRC tissue and between MSI and MSS tumors. The inventors compared the results with previous publications aimed at exploring the miRNA profile in the different subtypes of CRC based on the presence of MSI²⁴⁻²⁷. Consistent miRNA expression profiles for the MSI vs MSS and Lynch vs MSI comparisons between the present study and previous literature is summarized in Table 7. These results are of considerable significance, since they come from different populations, and analyses were performed using different technologies, which indicate the potential biological relevance of these miRNAs in the pathogenesis of colorectal cancer. For example, the results herein are highly coincident with the data obtained by Lanza et al.²⁶, where the miRNA profiling was performed in 23 MSS and 16 MSI fresh frozen tissues using a custom array; and the study from Sarver et al.²⁴, where the miRNA profiling was evaluated in 12 MSI and 68 MSS tumors using Illumina microarray technology. In addition, the present inventors have discovered and validated in a different cohort the differential expression of several miRNAs (miR-622, miR-1238) between sporadic MSI and MSS tumors.

In summary, this study describes the miRNA signature in CRCs from Lynch syndrome patients and demonstrates a unique expression signature compared with sporadic MSI tumors caused by somatic methylation of the MLH1 promoter. In addition, the present inventors have discovered that the tumor miRNA profiles from patients with ‘suspected’ as well as ‘definitive’ Lynch syndrome showed a similar profile, suggesting common molecular pathogenesis for both categories of Lynch syndrome patients. Finally, using a comprehensive platform and a large number of samples, the present inventors have identified several miRNAs dysregulated between tumor and N—C tissue, and within molecular subtypes of CRC based on the presence of MSI. These miRNAs are likely to insight into the pathogenesis of CRC, but in a more immediate fashion, they may be used to classify tumors for diagnostic purposes—particularly in the case of a Lynch syndrome family without an identified germline mutation—and may be useful in the future for the design of individualized treatment strategies.

It is contemplated that any embodiment discussed in this specification can be implemented with respect to any method, kit, reagent, or composition of the invention, and vice versa. Furthermore, compositions of the invention can be used to achieve methods of the invention.

It may be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it may be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

TABLE 5
Minimal set of miRNA discriminating sporadic MSI
from MSS tumors found in PAM analysis.

| | | | False discovery |
|---|---|---|---|
| miRNA | Fold change | Adjusted F | rate |
| hsa-miR-938 | 6.37 | 1.06E−010 | 0.007396 |
| hsa-miR-615-5p | 3.17 | 8.08E−005 | 0.000391 |
| hsa-miR-1184 | 3.11 | 3.29E−009 | 0.001108 |
| hsa-miR-551a | 3.03 | 3.60E−005 | 0.000218 |
| hsa-miR-622 | 2.96 | 1.31E−013 | 0.009895 |
| hsa-miR-17-5p:9.1 | −10.61 | 0.0015050 | 0.000683 |
| hsa-miR-192* | −9.67 | 1.42E−010 | 6.78E−008 |
| hsa-miR-337-3p | −6.91 | 1.42E−010 | 0.000218 |
| hsa-miR-338-3p | −6.71 | 1.27E−007 | 0.000261 |
| hsa-miR-187 | −6.52 | 4.72E−009 | 0.000861 |
| hsa-miR-224 | −6.49 | 0.00074113 | 0.001804 |
| hsa-miR-411 | −6.44 | 3.18E−007 | 0.000883 |
| hsa-miR-362-5p | −6.23 | 6.85E−008 | 0.000745 |
| hsa-miR-891a | −5.70 | 0.022284927 | 0.007263 |
| hsa-miR-16-2* | −5.53 | 5.83E−006 | 0.006089 |
| hsa-miR-214* | −5.45 | 6.53E−010 | 0.000218 |
| hsa-miR-335* | −5.41 | 1.56E−005 | 0.000645 |
| hsa-miR-30a* | −5.33 | 3.92E−009 | 0.00443 |
| hsa-miR-30a | −5.21 | 6.38E−007 | 0.000390 |
| hsa-miR-660 | −5.13 | 6.03E−005 | 0.002831 |
| hsa-miR-26a-2* | −5.09 | 1.09E−006 | 0.000996 |
| hsa-miR-199b-5p | −4.98 | 4.03E−007 | 6.22E−005 |
| hsa-miR-361-3p | −4.81 | 4.03E−007 | 0.002964 |
| hsa-miR-1 | −4.74 | 1.98E−009 | 0.002025 |
| hsa-miR-497 | −4.63 | 2.21E−006 | 0.000218 |
| hsa-miR-99a | −4.56 | 6.02E−008 | 5.45E−005 |
| hsa-miR-542-5p | −4.53 | 0.000238864 | 0.004427 |
| hsa-miR-29b-1* | −4.51 | 0.000152697 | 0.0041 |
| hsa-miR-328 | −4.38 | 4.68E−005 | 0.024533 |
| hsa-miR-152 | −4.26 | 1.07E−005 | 0.000285 |
| hsa-miR-133b | −4.26 | 1.16E−010 | 0.00571 |
| hsa-miR-146a | −4.23 | 0.000370152 | 0.00105 |
| hsa-miR-432 | −4.22 | 6.99E−006 | 0.000987 |
| hsa-miR-490-3p | −4.04 | 1.77E−012 | 0.004614 |
| hsa-miR-20a* | −4.00 | 9.88E−005 | 0.007277 |
| hsa-miR-200c* | −4.00 | 2.19E−006 | 0.000560 |
| hsa-miR-106a | −3.99 | 0.000270549 | 0.000849 |
| hsa-miR-331-3p | −3.98 | 4.79E−005 | 0.001081 |
| hsa-miR-642 | −3.98 | 3.95E−008 | 0.006804 |
| hsa-miR-139-5p | −3.94 | 2.60E−009 | 0.001804 |
| hsa-miR-424* | −3.93 | 0.000762051 | 0.005701 |
| hsa-miR-149 | −3.92 | 1.98E−009 | 0.002815 |
| hsa-miR-592 | −3.87 | 2.36E−005 | 0.000413 |
| hsa-miR-339-3p | −3.82 | 5.85E−005 | 0.015933 |
| hsa-miR-502-3p, | −3.80 | 5.05E−007 | 0.001136 |
| hsa-miR-500* | | | |
| hsa-miR-26b* | −3.79 | 6.80E−008 | 0.004311 |
| hsa-miR-154 | −3.68 | 2.21E−006 | 0.015537 |
| hsa-miR-181a-2* | −3.64 | 6.02E−008 | 0.000813 |
| hsa-miR-34a* | −3.45 | 2.27E−007 | 0.004311 |
| hsa-miR-409-3p | −3.45 | 4.49E−005 | 0.007655 |
| hsa-miR-532-5p | −3.43 | 8.19E−006 | 0.000375 |
| hsa-miR-106b | −3.34 | 1.44E−007 | 6.22E−005 |
| hsa-miR-203 | −3.33 | 0.000846825 | 0.000982 |
| hsa-miR-145* | −3.20 | 6.65E−009 | 0.000219 |
| hsa-miR-455-3p | −3.00 | 3.57E−007 | 0.000997 |
| hsa-miR-132* | −2.81 | 9.60E−010 | 0.000391 |
| hsa-miR-133a | −2.74 | 1.39E−010 | 0.00049 |
| hsa-miR-196b | −2.64 | 0.000203677 | 0.000219 |
| hsa-miR-550 | −1.89 | 0.006314763 | 0.131182 |

TABLE 6
Microarray validation by qRT-PCR.
CRC vs normal colonic mucosa

| | | | Technical | |
|---|---|---|---|---|
| | | | validation | |
| | Microarray | | (qRT-PCR) | |
| | Fold Change | p value | Fold Change | p value |
| miR-1238 | 20.71 | 6.07E−09 | 24154.43 | 2.87E−11 |
| miR-133b | −12.46 | 5.79E−09 | −2.83 | 6.35E−02 |
| miR-16-2* | −2.93 | 2.45E−02 | 1.74 | 2.62E−03 |
| miR-183 | 1.52 | 3.73E−01 | 230.40 | 6.54E−12 |
| miR-192* | −2.78 | 1.87E−03 | 9.43 | 1.36E−07 |
| miR-30a* | −5.90 | 2.05E−04 | −3.64 | 1.29E−04 |
| miR-362-5p | −3.46 | 2.31E−03 | 1.70 | 7.62E−04 |
| miR-486-5p | −2.85 | 1.84E−02 | 3.42 | 6.38E−03 |
| miR-622 | 11.18 | 4.13E−10 | 32.72 | 2.12E−07 |
| miR-938 | 27.12 | 2.84E−08 | 2.66 | 8.90E−02 |

Lynch syndrome vs sporadic MSI

| | | | Technical | | Test | |
|---|---|---|---|---|---|---|
| | | | validation | | set | |
| | Microarray | | (qRT-PCR) | | (qRT-PCR) | |
| | Fold Change | p value | Fold Change | p value | Fold Change | p value |
| miR-1238 | 9.61 | 1.49E−03 | 19.45 | 9.29E−04 | 2.45 | 2.11E−01 |
| miR-133b | −3.21 | 3.48E−02 | −3.87 | 5.26E−01 | −1.41 | 8.32E−01 |
| miR-16-2* | −14.45 | 5.21E−04 | 1.42 | 1.61E−01 | −1.31 | 1.26E−01 |
| miR-183 | −7.13 | 1.15E−03 | −1.20 | 7.54E−01 | −1.58 | 4.18E−01 |
| miR-192* | −7.27 | 1.39E−04 | −1.31 | 2.28E−01 | −2.16 | 1.41E−02 |
| miR-30a* | −20.73 | 2.36E−05 | 1.01 | 7.88E−01 | 1.21 | 3.24E−01 |
| miR-362-5p | −12.85 | 5.27E−06 | −1.03 | 6.99E−01 | −1.61 | 6.33E−02 |
| miR-486-5p | −12.62 | 1.44E−04 | −1.66 | 3.62E−01 | −1.16 | 4.04E−01 |
| miR-622 | 7.41 | 1.29E−04 | 15.38 | 2.11E−05 | 1.66 | 1.45E−01 |
| miR-938 | 11.48 | 2.94E−03 | 5.69 | 1.17E−04 | 1.13 | 9.90E−01 |

TABLE 7
Consistent miRNA expression profiles between the present invention and previous literature.

| | Probes analyzed | | | Lynch syndrome vs | |
|---|---|---|---|---|---|
| Reference | (n) | Technology | Samples analyzed (n) | MSI tumors | MSI vs MSS tumors |
| Lanza et al.²⁶ | 230 | Microarrays | 39 | NA | Down: 215, 192, 191, 203, 17, |
| (2007) | | (custom) | | | 106a, 20 |
| Schepeler | 315 | Microarrays | 59 | NA | Up: 144 |
| et al.²⁵ | | (Exiqon) | | | |
| (2008) | | qRT-PCR | | | |
| Sarver et | 735 probes, 470 | Microarrays | 108 | NA | Up: 625 |
| al.²⁴ | validated miRNAs | (Illumina) | | | Down: 552, 592, 196b, 181c, 1, |
| (2009) | | qRT-PCR | | | 133a, 328, 224 |
| Earle et al.²⁷ | 24 | qRT-PCR | 110 | Up: 223 | Down: 196a |
| (2010) | | | | | |

NA: Not available

### REFERENCES

WIPO Publication No. WO/2008/008430: Micro-RNA-Based Methods and Compositions for the Diagnosis and Treatment of Colon Cancer-Related Diseases.
WIPO Publication No. WO/2008/127587: Isolated Nucleic Acid Molecules Corresponding to Micro RNA (MIRNA-145) and their Use in Treating Colon Cancer.
U.S. Pat. No. 6,844,152: Detection of Microsatellite Instability and its use in Diagnosis of Tumors.
U.S. Pat. No. 7,326,778: Mutator Gene and Hereditary Non-Polyposis Colorectal Cancer.
1. Jemal A, Siegel R, Ward E, Hao Y, Xu J, Thun M J. Cancer Statistics, 2009. CA Cancer J Clin 2009; 59:225-49.
2. Esteller M. Epigenetics in Cancer. N Engl J Med 2008; 358:1148-59.
3. Wong J J, Hawkins N J, Ward R L. Colorectal Cancer: A Model for Epigenetic Tumorigenesis. Gut 2007; 56:140-8.
4. Markowitz S D, Bertagnolli M M. Molecular Origins of Cancer: Molecular Basis of Colorectal Cancer. N Engl J Med 2009; 361:2449-60.
5. Jass J R. Classification of Colorectal Cancer Based on Correlation of Clinical, Morphological and Molecular Features. Histopathology 2007; 50:113-30.
6. Ogino S, Goel A. Molecular Classification and Correlates in Colorectal Cancer. J Mol Diagn 2008; 10:13-27.
7. Yuen S T, Chan T L, Ho J W, Chan A S, Chung L P, Lam P W, Tse C W, Wyllie A H, Leung S Y. Germline, Somatic and Epigenetic Events Underlying Mismatch Repair Deficiency in Colorectal and HNPCC-Related Cancers. Oncogene 2002; 21:7585-92.
8. Poulogiannis G, Frayling I M, Arends M J. DNA Mismatch Repair Deficiency in Sporadic Colorectal Cancer and Lynch Syndrome. Histopathology; 56:167-79.
9. Lynch H T, Boland C R, Gong G, Shaw T G, Lynch P M, Fodde R, Lynch J F, de la Chapelle A. Phenotypic and Genotypic Heterogeneity in the Lynch Syndrome: Diagnostic, Surveillance and Management Implications. Eur J Hum Genet. 2006; 14:390-402.
10. Cunningham J M, Christensen E R, Tester D J, Kim C Y, Roche P C, Burgart L J, Thibodeau S N. Hypermethylation of the hMLH1 Promoter in Colon Cancer with Microsatellite Instability. Cancer Res 1998; 58:3455-60.
11. de la Chapelle A, Hampel H. Clinical Relevance of Microsatellite Instability in Colorectal Cancer. J Clin Oncol; 28:3380-7.
12. Vilar E, Gruber S B. Microsatellite Instability in Colorectal Cancer—The Stable Evidence. Nat. Rev Clin Oncol; 7:153-62.
13. Ambros V. The Functions of Animal microRNAs. Nature 2004; 431:350-5.
14. Calin G A, Croce C M. MicroRNA Signatures in Human Cancers. Nat. Rev Cancer 2006; 6:857-66.
15. Esquela-Kerscher A, Slack F J. Oncomirs—microRNAs with A Role in Cancer. Nat. Rev Cancer 2006; 6:259-69.
16. Lynam-Lennon N, Maher S G, Reynolds J V. The Roles of microRNA in Cancer and Apoptosis. Biol Rev Camb Philos Soc 2009; 84:55-71.
17. Lu J, Getz G, Miska E A, Alvarez-Saavedra E, Lamb J, Peck D, Sweet-Cordero A, Ebert B L, Mak R H, Ferrando A A, Downing J R, Jacks T, Horvitz H R, Golub T R. microRNA Expression Profiles Classify Human Cancers. Nature 2005; 435:834-8.
18. Cummins J M, He Y, Leary R J, Pagliarini R, Diaz L A, Jr., Sjoblom T, Barad O, Bentwich Z, Szafranska A E, Labourier E, Raymond C K, Roberts B S, Juhl H, Kinzler K W, Vogelstein B, Velculescu V E. The Colorectal microRNAome. Proc Natl Acad Sci USA 2006; 103:3687-92.
19. Michael M Z, SM O C, van Holst Pellekaan N G, Young G P, James R J. Reduced Accumulation of Specific microRNAs in Colorectal Neoplasia. Mol Cancer Res 2003; 1:882-91.
20. Motoyama K, Inoue H, Takatsuno Y, Tanaka F, Mimori K, Uetake H, Sugihara K, Mori M. Over- and Under-Expressed microRNAs in Human Colorectal Cancer. Int J Oncol 2009; 34:1069-75.
21. Bandres E, Cubedo E, Agirre X, Malumbres R, Zarate R, Ramirez N, Abajo A, Navarro A, Moreno I, Monzo M, Garcia-Foncillas J. Identification by Real-Time PCR of 13 Mature microRNAs Differentially Expressed in Colorectal Cancer and Non-Tumoral Tissues. Mol Cancer 2006; 5:29.
22. Schetter A J, Leung S Y, Sohn J J, Zanetti K A, Bowman E D, Yanaihara N, Yuen S T, Chan T L, Kwong D L, Au G K, Liu C G, Calin G A, Croce C M, Harris C C. microRNA Expression Profiles Associated with Prognosis and Therapeutic Outcome in Colon Adenocarcinoma. JAMA 2008; 299:425-36.
23. Aslam M I, Taylor K, Pringle J H, Jameson J S. MicroRNAs are Novel Biomarkers of Colorectal Cancer. Br J Surg 2009; 96:702-10.
24. Sarver A L, French A J, Borralho P M, Thayanithy V, Oberg A L, Silverstein K A, Morlan B W, Riska S M, Boardman L A, Cunningham J M, Subramanian S, Wang L, Smyrk T C, Rodrigues C M, Thibodeau S N, Steer C J. Human Colon Cancer Profiles Show Differential microRNA Expression Depending on Mismatch Repair Status and are Characteristic of Undifferentiated Proliferative States. BMC Cancer 2009; 9:401.
25. Schepeler T, Reinert J T, Ostenfeld M S, Christensen L L, Silahtaroglu A N, Dyrskjot L, Wiuf C, Sorensen F J, Kruhoffer M, Laurberg S, Kauppinen S, Orntoft T F, Andersen C L. Diagnostic and Prognostic microRNAs in Stage 11 Colon Cancer. Cancer Res 2008; 68:6416-24.
26. Lanza G, Ferracin M, Gafa R, Veronese A, Spizzo R, Pichiorri F, Liu C G, Calin G A, Croce C M, Negrini M. mRNA/microRNA Gene Expression Profile in Microsatellite Unstable Colorectal Cancer. Mol Cancer 2007; 6:54.
27. Earle J S, Luthra R, Romans A, Abraham R, Ensor J, Yao H, Hamilton S R. Association of microRNA Expression with Microsatellite Instability Status in Colorectal Adenocarcinoma. J Mol Diagn 2010; 12:433-40.
28. Goel A, Nagasaka T, Hamelin R, Boland C R. An Optimized Pentaplex PCR for Detecting DNA Mismatch Repair-Deficient Colorectal Cancers. PLoS One; 5:e9393.
29. Chen J, Lozach J, Garcia E W, Barnes B, Luo S, Mikoulitch I, Zhou L, Schroth G, Fan J B. Highly Sensitive and Specific microRNA Expression Profiling using Beadarray Technology. Nucleic Acids Res 2008; 36:e87.
30. Cunningham J M, Oberg A L, Borralho P M, Kren B T, French A J, Wang L, Bot B M, Morlan B W, Silverstein K A, Staggs R, Zeng Y, Lamblin A F, Hilker C A, Fan J B, Steer C J, Thibodeau S N. Evaluation of A New High-Dimensional miRNA Profiling Platform. BMC Med Genomics 2009; 2:57.
31. Du P, Kibbe W A, Lin S M. LUMI: A Pipeline for Processing Illumina Microarray. Bioinformatics 2008; 24:1547-8.
32. Wettenhall J M, Smyth G K. LimmaGUI: A Graphical User Interface for Linear Modeling of Microarray Data. Bioinformatics 2004; 20:3705-6.
33. Culhane A C, Thioulouse J, Perriere G, Higgins D G. MADE4: An R package for Multivariate Analysis of Gene Expression Data. Bioinformatics 2005; 21:2789-90.
34. Sabates-Bellver J, Van der Flier L G, de Palo M, Cattaneo E, Maake C, Rehrauer H, Laczko E, Kurowski M A, Bujnicki J M, Menigatti M, Luz J, Ranalli T V, Gomes V, Pastorelli A, Faggiani R, Anti M, Jiricny J, Clevers H, Marra G. Transcriptome Profile Of Human Colorectal Adenomas. Mol Cancer Res 2007; 5:1263-75.
35. Tibshirani R, Hastie T, Narasimhan B, Chu G. Diagnosis of Multiple Cancer Types by Shrunken Centroids of Gene Expression. Proc Natl Acad Sci USA 2002; 99:6567-72.
36. Martinez-Llordella M, Lozano J J, Puig-Pey I, Orlando G, Tisone G, Lerut J, Benitez C, Pons J A, Parrilla P, Ramirez P, Bruguera M, Rimola A, Sanchez-Fueyo A. Using Transcriptional Profiling to Develop A Diagnostic Test of Operational Tolerance in Liver Transplant Recipients. J Clin Invest 2008; 118:2845-57.
37. Chang K H, Mestdagh P, Vandesompele J, Kerin M J, Miller N. microRNA expression Profiling to Identify and Validate Reference Genes for Relative Quantification in Colorectal Cancer. BMC Cancer; 10:173.
38. Zhang X, Chen J, Radcliffe T, Lebrun D P, Tron V A, Feilotter H. An Array-Based Analysis of microRNA Expression Comparing Matched Frozen and Formalin-Fixed Paraffin-Embedded Human Tissue Samples. J Mol Diagn 2008; 10:513-9.
39. Xi Y, Nakajima G, Gavin E, Morris C G, Kudo K, Hayashi K, Ju J. Systematic Analysis of microRNA Expression of RNA Extracted from Fresh Frozen and Formalin-Fixed Paraffin-Embedded Samples. RNA 2007; 13:1668-74.
40. Li J, Smyth P, Flavin R, Cahill S, Denning K, Aherne S, Guenther S M, O'Leary J J, Sheils O. Comparison of miRNA Expression Patterns using Total RNA Extracted from Matched Samples of Formalin-Fixed Paraffin-Embedded (FFPE) Cells and Snap Frozen Cells. BMC Biotechnol 2007; 7:36.
41. Glud M, Klausen M, Gniadecki R, Rossing M, Hastrup N, Nielsen F C, Drzewiecki K T. microRNA Expression in Melanocytic Nevi: The Usefulness of Formalin-Fixed, Paraffin-Embedded Material for miRNA Microarray Profiling. J Invest Dermatol 2009; 129:1219-24.
42. Soukup M, Cho H, Lee J K. Robust classification modeling on microarray data using misclassification penalized posterior. Bioinformatics. 2005; 21 Suppl 1:1423-30.
43. Balaguer F, Link A, Lozano J J, Cuatrecasas M, Nagasaka T, Boland C R, et al. Epigenetic silencing of miR-137 is an early event in colorectal carcinogenesis. Cancer Res. 2010; 70:6609-18.
44. Melo S A, Ropero S, Moutinho C, Aaltonen L A, Yamamoto H, Calin G A, et al. A TARBP2 mutation in human cancer impairs microRNA processing and DICER1 function. Nat. Genet. 2009; 41:365-70.
45. Kane M F, Loda M, Gaida G M, Lipman J, Mishra R, Goldman H, et al. Methylation of the hMLH1 promoter correlates with lack of expression of hMLH1 in sporadic colon tumors and mismatch repair-defective human tumor cell lines. Cancer Res. 1997; 57:808-11.
46. Ogino S, Nosho K, Kirkner G J, Kawasaki T, Meyerhardt J A, Loda M, et al. CpG island methylator phenotype, microsatellite instability, BRAF mutation and clinical outcome in colon cancer. Gut. 2009; 58:90-6.
47. Toyota M, Ahuja N, Ohe-Toyota M, Herman J G, Baylin S B, Issa J P. CpG island methylator phenotype in colorectal cancer. Proc Natl Acad Sci USA. 1999; 96:8681-6.
48. Boland C R, Thibodeau S N, Hamilton S R, Sidransky D, Eshleman J R, Burt R W, et al. A National Cancer Institute Workshop on Microsatellite Instability for cancer detection and familial predisposition: development of international criteria for the determination of microsatellite instability in colorectal cancer. Cancer Res. 1998; 58:5248-57.
49. Giraldez M D, Balaguer F, Bujanda L, Cuatrecasas M, Munoz J, Alonso-Espinaco V, et al. MSH6 and MUTYH deficiency is a frequent event in early-onset colorectal cancer. Clin Cancer Res. 2010; 16:5402-13.
50. Goel A, Xicola R M, Nguyen T P, Doyle B J, Sohn V R, Bandipalliam P, et al. Aberrant DNA methylation in hereditary nonpolyposis colorectal cancer without mismatch repair deficiency. Gastroenterology. 2010; 138:1854-62.

What is claimed is:

1. A method for diagnosing a colorectal cancer (CRC) in a human subject comprising the steps of:
identifying the subject suspected of having CRC;
obtaining one or more biological samples from the subject, wherein the biological samples are selected from the group consisting of a tissue sample, a fecal sample, a cell homogenate, and one or more biological fluids comprising blood, plasma, lymph, urine, cerebrospinal fluid, amniotic fluid, pus or tears;
obtaining expression patterns of one or more MicroRNAs (miRNAs) in the biological samples using a microarray, wherein the one or more miRNAs are either upregulated or downregulated in the tissue sample of the subject suspected of having the CRC; and
comparing the expression pattern of the miRNAs from the biological sample of the subject suspected of having the CRC, with a miRNA expression pattern in a tissue of a normal subject, wherein the normal subject is a healthy subject not suffering from CRC.

2. The method of claim 1, wherein an upregulation of one or more miRNAs selected from the group consisting of miR-1238, miR-938, miR-1290, and miR-622 in the biological samples of the subject is indicative of the presence of the CRC.

3. The method of claim 1, wherein the upregulation of 10, 20, 30, 40, 50 or more miRNAs selected from the group consisting of HS_{—}78, hsa-miR-1826, hsa-miR-647, hsa-miR-603, hsa-miR-622, HS_{—}33, HS_{—}19, hsa-miR-300, HS_{—}111, hsa-miR-1238, hsa-miR-1290, HS_{—}276.1, hsa-miR-544, HS_{—}79.1, solexa-4793-177, hsa-miR-196a*, solexa-8048-104, HS_{—}149, hsa-miR-938, HS_{—}239, hsa-miR-1321, hsa-miR-1183, hsa-miR-583, hsa-miR-302b*, solexa-9578-86, HS_{—}128, hsa-miR-220b, HS_{—}22.1, hsa-miR-1184, solexa-7764-108, hsa-miR-940, hsa-miR-923, hsa-miR-1228*, HS_{—}120, hsa-miR-18b*, solexa-9655-85, hsa-miR-801:9.1, hsa-miR-302d, HS_{—}72, HS_{—}38.1, hsa-miR-512-5pm, HS_{—}215, hsa-miR-31, hsa-miR-423-5p, hsa-miR-576-3p, hsa-miR-612, HS_{—}43.1, hsa-miR-7-1*, hsa-miR-346, hsa-miR-1268, hsa-miR-892a, HS_{—}208, hsa-miR-623, HS_{—}86, HS_{—}170, hsa-miR-563, hsa-miR-1181, hsa-miR-1289, HS_{—}241.1, hsa-miR-183*, hsa-miR-1269, HS_{—}9, hsa-miR-512-3p, hsa-miR-587, HS_{—}202.1, HS_{—}37, hsa-miR-936, hsa-miR-1231, HS_{—}250, hsa-miR-202*:9.1, HS_{—}254, hsa-miR-518b, hsa-miR-19a*, HS_{—}116, hsa-miR-450b-3p, HS_{—}48.1, hsa-miR-591, hsa-miR-25*, hsa-miR-665, hsa-miR-654-3p, HS_{—}74, HS_{—}217, HS_{—}71.1, hsa-miR-550*, hsa-miR-1291, hsa-miR-371-3p, hsa-miR-1245, hsa-miR-520e, hsa-miR-135a*, HS_{—}51, hsa-miR-298, HS_{—}228.1, solexa-15-44487, HS_{—}110, hsa-miR-1255b, hsa-miR-1285, HS_{—}44.1, HS_{—}29, hsa-miR-198, hsa-miR-551a, solexa-9081-91, HS_{—}35, HS_{—}167.1, hsa-miR-1225-5p, HS_{—}56, hsa-miR-654-5p, hsa-miR-1207-3p, hsa-miR-631, hsa-miR-920, hsa-miR-515-3p, hsa-miR-661, hsa-miR-508-5p, hsa-miR-566, solexa-8926-93, HS_{—}65, hsa-miR-218-2*, HS_{—}2, hsa-miR-509-5p, hsa-miR-1254, HS_{—}163, hsa-miR-135b*, HS_{—}205.1, hsa-miR-31*, hsa-miR-1273, HS_{—}106, HS_{—}4.1, HS_{—}23, hsa-miR-1304, HS_{—}139, HS_{—}287, HS_{—}46, HS_{—}155, hsa-miR-187*, hsa-miR-193b*, HS_{—}147, HS_{—}187, HS_{—}17, HS_{—}87, hsa-miR-935, HS_{—}244, hsa-miR-1197, HS_{—}216, solexa-9124-90, hsa-miR-1324, hsa-miR-548g, hsa-miR-619, hsa-miR-302b, hsa-miR-632, hsa-miR-380*, hsa-miR-572, hsa-miR-668, hsa-miR-767-3p, hsa-miR-520d-5p, hsa-miR-1248, hsa-miR-380, HS_{—}101, HS_{—}150, solexa-578-1915, hsa-miR-549, HS_{—}189.1, HS_{—}80, HS_{—}264.1, hsa-miR-614, HS_{—}76, HS_{—}21, hsa-miR-182*, hsa-miR-1182, HS_{—}126, hsa-miR-1244, hsa-miR-1250, hsa-miR-602, hsa-miR-518a-5p, hsa-miR-527, hsa-miR-518f, hsa-miR-124a:9.1, hsa-miR-944, hsa-miR-517*, HS_{—}109, hsa-miR-1303, HS_{—}94, hsa-miR-1247, hsa-miR-588, hsa-miR-675, hsa-miR-645, hsa-miR-1300, hsa-miR-767-5p, hsa-miR-1180, HS_{—}68, hsa-miR-1204, hsa-miR-560:9.1, solexa-3044-295, hsa-miR-1295, hsa-miR-616, HS_{—}206, HS_{—}58, hsa-miR-671:9.1, solexa-5620-151, hsa-miR-519d, solexa-826-1288, hsa-miR-608, hsa-miR-509-3p, HS_{—}45.1, HS_{—}32, HS_{—}174.1, HS_{—}200, HS_{—}243.1, HS_{—}284.1, HS_{—}89, HS_{—}77, hsa-miR-1234, HS_{—}242, hsa-miR-663b, solexa-2952-306, hsa-miR-1274a, hsa-miR-890, hsa-miR-1243, hsa-miR-95, solexa-555-1991, hsa-miR-222*, HS_{—}121, hsa-miR-554, hsa-miR-1246, hsa-miR-1207-5p, solexa-3927-221, HS_{—}100, hsa-miR-574-5p, hsa-miR-1202, HS_{—}199, hsa-miR-1260, hsa-miR-943, and HS_{—}262.1 in the biological samples of the subject is indicative of the presence of the CRC.

4. The method of claim 1, wherein a downregulation of one or more miRNAs selected from the group consisting of miR-133b, miR-490-3p, miR-490-5p, miR-138, and miR-1 in the biological samples of the subject is indicative of the presence of the CRC.

5. The method of claim 1, wherein the downregulation of 10, 20, 30, 40, 50 or more miRNAs selected from the group consisting of solexa-5169-164, hsa-miR-129*, hsa-miR-101*, hsa-miR-138, hsa-miR-598, hsa-miR-490-3p, hsa-miR-29b-2*, hsa-miR-365, hsa-miR-30c-2*, hsa-miR-133b, hsa-miR-133a, hsa-miR-551b, hsa-miR-192*, hsa-miR-337-3p, hsa-miR-125b-2*, hsa-miR-20b*, hsa-miR-137, hsa-miR-214*, hsa-miR-582-3p, hsa-miR-132*, hsa-miR-582-5p, hsa-miR-24-1*, hsa-miR-130a, hsa-miR-149, hsa-miR-1, hsa-miR-656, hsa-miR-139-5p, hsa-miR-490-5p, hsa-miR-181c, hsa-miR-30a*, hsa-miR-187, hsa-miR-33b, hsa-miR-145*, hsa-miR-20b, hsa-miR-340, HS_{—}209.1, hsa-miR-363, hsa-miR-570, hsa-miR-9, hsa-miR-340*, hsa-miR-497, hsa-miR-579, hsa-miR-545, hsa-miR-744*, hsa-miR-30e, hsa-miR-142-5p, hsa-let-7i*, hsa-miR-323-3p, hsa-miR-642, hsa-miR-99a, hsa-miR-195*, hsa-miR-181a-2*, hsa-miR-26b*, hsa-miR-362-5p, hsa-miR-885-5p, hsa-miR-26a-1*, hsa-miR-628-3p, hsa-miR-136, hsa-miR-148b, hsa-let-7g*, hsa-miR-135a, hsa-miR-338-3p, hsa-miR-376a*, hsa-miR-454, hsa-miR-106b, hsa-miR-154*, hsa-let-7f-1*, hsa-miR-148a*, hsa-miR-27b*, hsa-miR-381, hsa-miR-212, hsa-miR-153, hsa-miR-34a*, hsa-miR-577, hsa-miR-144*, hsa-miR-127-5p, hsa-miR-411, hsa-miR-590-3p, hsa-miR-519a, hsa-miR-487b, hsa-miR-455-3p, hsa-miR-345, hsa-miR-199b-5p, hsa-miR-92b, hsa-let-7e*, hsa-miR-361-3p, hsa-miR-548p hsa-miR-502-3p, hsa-miR-500*, hsa-miR-186, hsa-miR-151:9.1, hsa-miR-30a, hsa-miR-221*, hsa-miR-9*, hsa-miR-136*, hsa-miR-26a-2*, hsa-miR-143*, hsa-miR-140-5p, hsa-miR-189:9.1, hsa-miR-130b, hsa-miR-374a, hsa-miR-128, hsa-miR-616*, solexa-3126-285, hsa-miR-766, hsa-miR-548e, hsa-miR-154, hsa-miR-486-5p, hsa-miR-597, HS_{—}194, hsa-miR-361-5p, hsa-miR-421, hsa-miR-127-3p, hsa-miR-195, hsa-miR-99a*, hsa-miR-337-5p, hsa-let-7a*, solexa-2580-353, hsa-miR-409-5p, hsa-miR-34b*, hsa-miR-16-2*, hsa-miR-30d*, hsa-miR-10b, hsa-miR-499-5p, hsa-miR-548c-5p, hsa-miR-148b*, hsa-miR-193a-3p, hsa-miR-342-3p, hsa-miR-410, hsa-miR-425*, hsa-miR-29c*, hsa-miR-495, hsa-miR-330-3p, hsa-miR-219-5p, hsa-miR-185, hsa-miR-329, hsa-miR-592, hsa-miR-433, hsa-miR-181c*, hsa-miR-193a-5p, hsa-miR-34c-5p, hsa-miR-124, HS_{—}49, HS_{—}282, hsa-miR-100, hsa-miR-299-5p, hsa-miR-128a:9.1, hsa-miR-455-5p, hsa-miR-101, hsa-miR-409-3p, hsa-miR-326, hsa-miR-379*, hsa-miR-328, hsa-miR-539, hsa-miR-331-3p, hsa-miR-1272, HS_{—}168, hsa-miR-374b*, hsa-miR-548m, hsa-miR-378*, hsa-miR-202*, hsa-miR-339-3p, hsa-miR-660, hsa-miR-576-5p, hsa-miR-296-5p, hsa-miR-451, hsa-miR-17*, hsa-miR-141*, hsa-miR-190b, hsa-miR-511, hsa-miR-20a*, hsa-miR-204, hsa-miR-1185, hsa-miR-624*, hsa-miR-655, hsa-miR-34b, hsa-miR-411*, hsa-miR-505, hsa-miR-15a, hsa-miR-454*, hsa-miR-22*, hsa-miR-18b, hsa-miR-144:9.1, hsa-miR-99b, hsa-miR-100*, hsa-miR-873, hsa-miR-10a*, hsa-miR-1537, hsa-miR-19b-1*, hsa-miR-505*, hsa-miR-29a*, hsa-miR-147, hsa-miR-485-3p, solexa-539-2056, hsa-miR-193b, HS_{—}42, hsa-miR-218, hsa-miR-19b, hsa-miR-106a:9.1, hsa-miR-378, hsa-miR-376c, hsa-miR-24-2*, hsa-miR-32, hsa-miR-197, hsa-miR-744, hsa-miR-7-2*, hsa-miR-335, hsa-miR-627, hsa-miR-139-3p, hsa-miR-629, hsa-miR-15b*, hsa-miR-107, hsa-miR-383, hsa-miR-147b, hsa-miR-19a, HS_{—}108.1, hsa-miR-301a, hsa-let-7b*, hsa-miR-345:9.1, hsa-miR-331-5p, hsa-miR-552, hsa-miR-1271, hsa-miR-550, hsa-miR-1296, HS_{—}20, hsa-miR-487a, hsa-miR-491-5p, solexa-3695-237, hsa-miR-374a*, solexa-7534-111, hsa-miR-128b:9.1, hsa-miR-188-3p, hsa-miR-33a, hsa-miR-129-3p, hsa-miR-23b*, hsa-miR-362-3p, hsa-miR-496, HS_{—}40, HS_{—}64, HS_{—}201, hsa-miR-1227, hsa-miR-125a-3p, hsa-miR-99b*, hsa-miR-542-3p, hsa-miR-142-3p, hsa-miR-571, hsa-miR-376a*:9.1, hsa-miR-493, solexa-2526-361, hsa-miR-585, hsa-miR-93*, hsa-miR-502-5p, hsa-miR-30e*, hsa-miR-145, hsa-miR-126, hsa-miR-222, hsa-let-7e, hsa-miR-30d, hsa-miR-28-5p, hsa-miR-30c, hsa-miR-199a*:9.1, hsa-miR-29c, HS_{—}275, hsa-miR-143, hsa-miR-125b, hsa-miR-26a, hsa-miR-141, hsa-miR-140-3p, hsa-miR-30b, and hsa-miR-338-5p
in the biological samples of the subject is indicative of the presence of the CRC.

6. The method of claim 1, wherein the CRC comprises Lynch syndrome, sporadic microsatellite instability (MSI) tumors or microsatellite stable (MSS) tumors.

7. The method of claim 1, wherein the biological sample is a tissue sample, a fecal sample or a blood sample.

8. A method for diagnosing a colorectal cancer (CRC) in a human subject comprising the steps of:
identifying the subject suspected of having CRC;
obtaining one or more biological samples from the subject, wherein the biological samples are selected from the group consisting of a tissue sample, a fecal sample, a cell homogenate, and one or more biological fluids comprising blood, plasma, lymph, urine, cerebrospinal fluid, amniotic fluid, pus or tears; and
diagnosing the CRC by determining an expression of one or more MicroRNAs (miRNAs) in the biological sample of the subject suspected of having the CRC using a microarray, wherein the miRNAs are selected from the group consisting of hsa-miR-1238, hsa-miR-938, hsa-miR-622, hsa-miR-1290, hsa-miR-490-3p, hsa-miR-133b, hsa-miR-139-5p, hsa-miR-1, hsa-miR-138, hsa-miR-130a, hsa-miR-582-5p, hsa-miR-9, hsa-miR-149, hsa-miR-132*, hsa-miR-20b, hsa-miR-29-b2*hsa-miR-30a*, hsa-miR-598, hsa-miR-365, hsa-miR-24-1*, hsa-miR-99a, hsa-miR-192, hsa-miR-125b-2*, hsa-miR-337-3p, hsa-miR-340, hsa-miR-181c, hsa-miR-656, hsa-miR-454, hsa-miR-129*, hsa-miR-20b*, hsa-miR-363, hsa-miR-30c-2*, hsa-miR-137, hsa-miR-582-3p, hsa-miR-603, hsa-miR-647, hsa-miR-220b, hsa-miR-1228*, hsa-miR-1826, hsa-miR-583, hsa-miR-300, hsa-miR-214*, hsa-miR-101*, hsa-miR-1321, hsa-miR-1183, hsa-miR-1184, hsa-miR-302b*, hsa-miR-544, and hsa-miR-612, wherein the one or more miRNAs are absent in a biological sample of a normal or healthy subject not suffering from the CRC.

9. The method of claim 8, wherein the CRC comprises Lynch syndrome, sporadic microsatellite instability (MSI) tumors or microsatellite stable (MSS) tumors.

10. The method of claim 8, wherein the biological sample is a tissue sample, a fecal sample or a blood sample.

11. A method for distinguishing between one or more types of colorectal cancers (CRC) characterized by microsatellite instability (MSI) in a human subject comprising the steps of:
identifying the human subject having the CRC characterized by MSI;
obtaining one or more biological samples from the subject, wherein the biological samples are selected from the group consisting of a tissue sample, a fecal sample, a cell homogenate, and one or more biological fluids comprising blood, plasma, lymph, urine, cerebrospinal fluid, amniotic fluid, pus or tears; and
determining a differential expression signature for one or more MicroRNAs (miRNAs) in the biological samples using a microarray, wherein the one or more miRNAs are selected from the group consisting of hsa-miR-30a*, hsa-miR-16-2*, hsa-miR-362-5p, hsa-miR-486-5p, hsa-miR-337-3p, hsa-miR-642, hsa-miR-411, hsa-miR-214*, hsa-miR-187, hsa-miR-628-3p, hsa-miR-142-5p, hsa-miR-29b-1*, hsa-miR-361-3p, hsa-miR-501-3p, hsa-miR-139-5p, hsa-miR-192*, hsa-miR-128, hsa-miR-29b-2*, hsa-miR-26b*, hsa-miR-432, hsa-miR-92b, hsa-miR-502-3p, hsa-miR-34a*, hsa-miR-200c*, hsa-miR-130b, hsa-miR-598, hsa-miR-151:9.1, hsa-miR-130b*, hsa-miR-421, hsa-miR-1238, and hsa-miR-622, wherein an upregulation, a downregulation or both of the one or more miRNAs is indicative of the presence of Lynch syndrome or a sporadic microsatellite instability (MSI) tumor.

12. The method of claim 11, wherein the upregulation of 10, 20, 30, 40, 50 or more miRNAs selected from the group consisting of hsa-miR-198, hsa-miR-31*, hsa-miR-183*, hsa-miR-935, hsa-miR-183, hsa-miR-891a, hsa-miR-182, hsa-miR-1275, hsa-miR-886-3p, hsa-miR-155*, hsa-miR-503, hsa-miR-664, hsa-miR-424*, HS_{—}303 b, hsa-miR-18a*, hsa-miR-594:9.1, hsa-miR-452*:9.1, hsa-miR-223, hsa-miR-625*, hsa-miR-29b-1*, hsa-miR-17-5p:9.1, hsa-miR-196b, hsa-miR-151-3p, solexa-51-13984, hsa-miR-200b*, hsa-miR-342-5p, hsa-miR-425, hsa-miR-203, hsa-miR-768-5p:11.0, hsa-miR-200a*, hsa-miR-30e*, hsa-miR-942, hsa miR-28-5p, hsa-miR-429, hsa-miR-30c, hsa-miR-126, hsa-miR-486-3p, hsa-let-7d, hsa-miR-382, hsa-miR-92a-1*, hsa-miR-224, hsa-miR-222, hsa-let-7e, hsa-miR-181a, hsa-miR-146b-5p, hsa-let-7c, hsa-miR-450b-5p, hsa-miR-370, hsa-miR-450a, hsa-miR-146a, hsa-miR-223*, hsa-miR-501-5p, hsa-miR-106b*, hsa-miR-181b, hsa-miR-134, hsa-miR-98, hsa-miR-106a, hsa-miR-889, hsa-miR-96, hsa-miR-132, hsa-miR-195, hsa-miR-1237, hsa-miR-451, hsa-miR-628-5p, hsa-miR-532-5p, hsa-miR-342-3p, hsa-miR-558, hsa-miR-10a, hsa-miR-215, hsa-miR-210, hsa-miR-10a*, hsa-miR-424, hsa-miR-432, hsa-miR-125a-5p, hsa-miR-500, hsa-miR-200c*, hsa-miR-130b*, hsa-miR-361-5p, hsa-miR-874, hsa-miR-374a, hsa-miR-32*, hsa-miR-335*, hsa-miR-100, hsa-miR-152, hsa-miR-652, hsa-miR-193a-5p, hsa-miR-34a, hsa-miR-10b, hsa-miR-15a, hsa-miR-106b, hsa-miR-574-3p, hsa-miR-455-3p, hsa-miR-499-5p, hsa-miR-335, hsa-miR-151:9.1, hsa-miR-23b*, hsa-miR-185, hsa-miR-941, hsa-miR-331-3p, hsa-miR-550, hsa miR-330-3p, hsa-miR-421, hsa-miR-744, hsa-let-7f-1*, hsa-miR-629, hsa-miR-433, hsa-miR-505*, hsa-miR-22*, hsa-miR-130b, hsa-miR-345, hsa-miR-532-3p, hsa-miR-542-5p, hsa-miR-339-5p, hsa-miR-193b, hsa-let-7d*, hsa-miR-199b-5p, hsa-miR-409-3p, hsa miR-148b, hsa-miR-190b, hsa-miR-18a, hsa-miR-29a*, hsa-miR-409-5p, hsa-miR-197, hsa-miR-708, hsa-miR-99a, hsa-miR-576-5p, hsa-miR-629*, hsa-miR-502-3p, hsa-miR-500*, hsa-miR-501-3p, hsa-miR-128, hsa-miR-19b-1*, hsa-miR-27b*, HS_{—}194, hsa-miR-92b, hsa-miR-130a, hsa-miR-577, HS_{—}108.1, hsa-miR-30e, hsa-miR-26a-1*, hsa-miR-32, hsa-miR-132*, hsa-miR-511, hsa-miR-145*, hsa-miR-221*, hsa-miR-454, hsa-miR-212, hsa-miR-34c-5p, hsa-miR-99b, hsa-miR-192*, hsa-miR-486-5p, hsa-miR-148a*, hsa-miR-30a, hsa-miR-16-2*, hsa-miR-107, hsa-miR-17*, hsa-miR-127-3p, hsa-let-7g*, hsa-miR-135a, hsa-miR-133a, hsa-miR-181a-2*, hsa-miR-101, hsa-miR-378*, hsa-miR-34a*, solexa-2580-353, hsa-miR-660, hsa-miR-154*, hsa-miR-497, hsa-miR-655, hsa-miR-144*, hsa-miR-362-5p, hsa-miR-339-3p, solexa-3126-285, hsa-miR-29c*, hsa-miR-30c-2*, hsa-miR-766, hsa-miR-26a-2*, hsa-miR-425*, hsa-miR-329, hsa-miR-323-3p, hsa-miR-338-3p, hsa-miR-186, hsa-miR-33b, hsa-miR-214*, hsa-miR-340, hsa-let-7i*, hsa-miR-598, hsa-miR-26b*, hsa-miR-125b-2*, hsa-miR-29b-2*, hsa-miR-411, hsa-miR-487b, hsa-miR-361-3p, hsa-miR-181c, hsa-miR-628-3p, hsa-miR-326, hsa-miR-139-5p, HS_{—}209.1, hsa-miR-642, hsa-miR-616*, hsa-miR-505, hsa-miR-365, hsa-miR-656, hsa-miR-154, hsa-miR-20b, hsa-miR-363, hsa-miR-340*, hsa-let-7a*, hsa-miR-582-5p, hsa-miR-328, hsa-miR-337-3p, hsa-miR-30a*, hsa-miR-9, hsa-miR-24-1*, hsa-miR-187, hsa-miR-149, hsa-miR-142-5p, hsa-miR-101*, hsa-miR-1, hsa-miR-133b, hsa-miR-490-3p, hsa-let-7f, hsa-miR-15b, hsa-miR-199a*:9.1, and hsa-miR-30din the biological samples of the subject is indicative of the presence of Lynch syndrome.

13. The method of claim 11, wherein the downregulation of 10, 20, 30, 40, 50 or more miRNAs selected from the group consisting of hsa-miR-938, hsa-miR-1238, hsa-miR-1183, hsa-miR-892a, hsa-miR-622, solexa-7764-108, hsa-miR-1290, hsa-miR-623, hsa-miR-302d, hsa-miR-18b*, hsa-miR-603, hsa-miR-520e, hsa-miR-1268, HS_{—}217, hsa-miR-202*:9.1, HS_{—}202.1, hsa-miR-512-5p, hsa-miR-612, HS_{—}215, hsa-miR-302b*, HS_{—}111, hsa-miR-1197, HS_{—}149, hsa-miR-346, hsa-miR-1181, HS_{—}33, hsa-miR-647, HS_{—}78, hsa-miR-632, hsa-miR-1304, HS_{—}228.1, HS_{—}116, HS_{—}241.1, HS_{—}72, hsa-miR-196a*, HS_{—}276.1, hsa-miR-1184, hsa-miR-1225-5p, HS_{—}17, hsa-miR-654-3p, hsa-miR-124a:9.1, HS_{—}74, hsa-miR-518b, HS_{—}120, hsa-miR-654-5p, HS_{—}44.1, HS_{—}239 hsa-miR-380*, hsa-miR-1321, solexa-9081-91, hsa-miR-631, hsa-miR-423-5p, hsa-miR-936, hsa-miR-550*, hsa-miR-7-1*, HS_{—}37, HS_{—}79.1, hsa-miR-19a*, HS_{—}86, solexa-578-1915, hsa-miR-450b-3p, HS_{—}9, HS_{—}250, HS_{—}56, HS_{—}208, HS_{—}205.1, HS_{—}128, HS_{—}170, HS_{—}38.1, hsa-miR-576-3p, hsa-miR-583, hsa-miR-923, hsa-miR-940, HS_{—}19, hsa-miR-300, solexa-9655-85, hsa-miR-130a*, HS_{—}106, HS_{—}23, hsa-miR-220b, hsa-miR-187*, hsa-miR-1255b, hsa-miR-515-3p, hsa-miR-1289, solexa-15-44487, hsa-miR-563, hsa-miR-661, HS_{—}264.1, hsa-miR-135a*, hsa-miR-587, hsa miR-548g, HS_{—}51, hsa-miR-512-3p, hsa-miR-1254, HS_{—}71.1, hsa-miR-920, hsa-miR-371-3p, hsa-miR-665, hsa-miR-591, HS_{—}176, HS_{—}188, HS_{—}139, HS_{—}244, HS_{—}12, hsa-miR-1204, solexa-9578-86, hsa-miR-298, hsa-miR-551a, hsa-miR-520d-5p, hsa-miR-508-5p, hsa-miR-1231, hsa-miR-302b, HS_{—}101, HS_{—}48.1, hsa-miR-1228*, hsa-miR-498, hsa-miR-602, HS_{—}150, HS_{—}80, hsa-miR-518d-3p, HS_{—}216, hsa-miR-222*, hsa-miR-890, hsa-miR-1297, HS_{—}52, hsa-miR-554, HS_{—}93, hsa-miR-1243, hsa-miR-1202, HS_{—}97, hsa-miR-518e:9.1, hsa-miR-372, HS_{—}121, hsa-miR-1205, HS_{—}122.1, hsa-miR-525-5p, solexa-555-1991, hsa-miR-302c*, hsa-miR-1262, hsa-miR-518c*, hsa-miR-1233, hsa-miR-888, hsa-miR-33a*, hsa-miR-146a*, hsa-miR-412, hsa-miR-615-5p, hsa-miR-367*, hsa-miR-146b-3p, hsa-miR-1257, hsa-miR-1286, hsa-miR-609, hsa-miR-643, hsa-miR-519b-3p, hsa-miR-657, hsa-miR-384, hsa-miR-887, HS_{—}113, hsa-miR-1284, HS_{—}138, HS_{—}25, hsa-miR-488*, HS_{—}152, hsa-miR-1208, HS_{—}219, hsa-miR-607, hsa-miR-516a-3p, hsa-miR-516b*, hsa-miR-369-5p, hsa-miR-548b-3p, hsa-miR-548a-3p, hsa-miR-567, hsa-miR-1267, hsa-miR-578, HS_{—}184, hsa-miR-1206, hsa-miR-620, hsa-miR-186*, hsa-miR-596, hsa-miR-548c-3p, hsa-miR-1224-3p, hsa-miR-19b-2*, hsa-miR-218-1*, hsa-miR-1323, hsa-miR-876-3p, hsa-miR-1305, hsa-miR-1225-3p, hsa-miR-504, hsa-miR-650, hsa-miR-1179, hsa-miR-190, hsa-miR-376c, HS_{—}168, hsa-miR-144:9.1, hsa-miR-1826, and hsa-miR-544 in the biological samples of the subject is indicative of the presence of Lynch syndrome.

14. The method of claim 11, wherein the upregulation of 10, 20, 30, 40, 50 or more miRNAs selected from the group consisting of hsa-miR-938, hsa-miR-1238, hsa-miR-1183, hsa-miR-892a, hsa-miR-622, solexa-7764-108, hsa-miR-1290, hsa-miR-623, hsa-miR-302d, hsa-miR-18b*, hsa-miR-603, hsa-miR-520e, hsa-miR-1268, HS_{—}217, hsa-miR-202*:9.1, HS_{—}202.1, hsa-miR-512-5p, hsa-miR-612, HS_{—}215, hsa-miR-302b*, HS_{—}111, hsa-miR-1197, HS_{—}149, hsa-miR-346, hsa-miR-1181, HS_{—}33, hsa-miR-647, HS_{—}78, hsa-miR-632, hsa-miR-1304, HS_{—}228.1, HS_{—}116, HS_{—}241.1, HS_{—}72, hsa-miR-196a*, HS_{—}276.1, hsa-miR-1184, hsa-miR-1225-5p, HS_{—}17, hsa-miR-654-3p, hsa-miR-124a:9.1, HS_{—}74, hsa-miR-518b, HS_{—}120, hsa-miR-654-5p, HS_{—}44.1, HS_{—}239 hsa-miR-380*, hsa-miR-1321, solexa-9081-91, hsa-miR-631, hsa-miR-423-5p, hsa-miR-936, hsa-miR-550*, hsa-miR-7-1*, HS_{—}37, HS_{—}79.1, hsa-miR-19a*, HS_{—}86, solexa-578-1915, hsa-miR-450b-3p, HS_{—}9, HS_{—}250, HS_{—}56, HS_{—}208, HS_{—}205.1, HS_{—}128, HS_{—}170, HS_{—}38.1, hsa-miR-576-3p, hsa-miR-583, hsa-miR-923, hsa-miR-940, HS_{—}19, hsa-miR-300, solexa-9655-85, hsa-miR-130a*, HS_{—}106, HS_{—}23, hsa-miR-220b, hsa-miR-187*, hsa-miR-1255b, hsa-miR-515-3p, hsa-miR-1289, solexa-15-44487, hsa-miR-563, hsa-miR-661, HS_{—}264.1, hsa-miR-135a*, hsa-miR-587, hsa miR-548g, HS_{—}51, hsa-miR-512-3p, hsa-miR-1254, HS_{—}71.1, hsa-miR-920, hsa-miR-371-3p, hsa-miR-665, hsa-miR-591, HS_{—}176, HS_{—}188, HS_{—}139, HS_{—}244, HS_{—}12, hsa-miR-1204, solexa-9578-86, hsa-miR-298, hsa-miR-551a, hsa-miR-520d-5p, hsa-miR-508-5p, hsa-miR-1231, hsa-miR-302b, HS_{—}101, HS_{—}48.1, hsa-miR-1228*, hsa-miR-498, hsa-miR-602, HS_{—}150, HS_{—}80, hsa-miR-518d-3p, HS_{—}216, hsa-miR-222*, hsa-miR-890, hsa-miR-1297, HS_{—}52, hsa-miR-554, HS_{—}93, hsa-miR-1243, hsa-miR-1202, HS_{—}97, hsa-miR-518e:9.1, hsa-miR-372, HS_{—}121, hsa-miR-1205, HS_{—}122.1, hsa-miR-525-5p, solexa-555-1991, hsa-miR-302c*, hsa-miR-1262, hsa-miR-518c*, hsa-miR-1233, hsa-miR-888, hsa-miR-33a*, hsa-miR-146a*, hsa-miR-412, hsa-miR-615-5p, hsa-miR-367*, hsa-miR-146b-3p, hsa-miR-1257, hsa-miR-1286, hsa-miR-609, hsa-miR-643, hsa-miR-519b-3p, hsa-miR-657, hsa-miR-384, hsa-miR-887, HS_{—}113, hsa-miR-1284, HS_{—}138, HS_{—}25, hsa-miR-488*, HS_{—}152, hsa-miR-1208, HS_{—}219, hsa-miR-607, hsa-miR-516a-3p, hsa-miR-516b*, hsa-miR-369-5p, hsa-miR-548b-3p, hsa-miR-548a-3p, hsa-miR-567, hsa-miR-1267, hsa-miR-578, HS_{—}184, hsa-miR-1206, hsa-miR-620, hsa-miR-186*, hsa-miR-596, hsa-miR-548c-3p, hsa-miR-1224-3p, hsa-miR-19b-2*, hsa-miR-218-1*, hsa-miR-1323, hsa-miR-876-3p, hsa-miR-1305, hsa-miR-1225-3p, hsa-miR-504, hsa-miR-650, hsa-miR-1179, hsa-miR-190, hsa-miR-376c, HS_{—}168, hsa-miR-144:9.1, hsa-miR-1826, and hsa-miR-544 in the biological samples of the subject is indicative of the presence of sporadic MSI tumor.

15. The method of claim 11, wherein the downregulation of 10, 20, 30, 40, 50 or more miRNAs selected from the group consisting of hsa-miR-198, hsa-miR-31*, hsa-miR-183*, hsa-miR-935, hsa-miR-183, hsa-miR-891a, hsa-miR-182, hsa-miR-1275, hsa-miR-886-3p, hsa-miR-155*, hsa-miR-503, hsa-miR-664, hsa-miR-424*, HS_{—}303b, hsa-miR-18a*, hsa-miR-594:9.1, hsa-miR-452*:9.1, hsa-miR-223, hsa-miR-625*, hsa-miR-29b-1*, hsa-miR-17-5p:9.1, hsa-miR-196b, hsa-miR-151-3p, solexa-51-13984, hsa-miR-200b*, hsa-miR-342-5p, hsa-miR-425, hsa-miR-203, hsa-miR-768-5p:11.0, hsa-miR-200a*, hsa-miR-30e*, hsa-miR-942, hsa miR-28-5p, hsa-miR-429, hsa-miR-30c, hsa-miR-126, hsa-miR-486-3p, hsa-let-7d, hsa-miR-382, hsa-miR-92a-1*, hsa-miR-224, hsa-miR-222, hsa-let-7e, hsa-miR-181a, hsa-miR-146b-5p, hsa-let-7c, hsa-miR-450b-5p, hsa-miR-370, hsa-miR-450a, hsa-miR-146a, hsa-miR-223*, hsa-miR-501-5p, hsa-miR-106b*, hsa-miR-181b, hsa-miR-134, hsa-miR-98, hsa-miR-106a, hsa-miR-889, hsa-miR-96, hsa-miR-132, hsa-miR-195, hsa-miR-1237, hsa-miR-451, hsa-miR-628-5p, hsa-miR-532-5p, hsa-miR-342-3p, hsa-miR-558, hsa-miR-10a, hsa-miR-215, hsa-miR-210, hsa-miR-10a*, hsa-miR-424, hsa-miR-432, hsa-miR-125a-5p, hsa-miR-500, hsa-miR-200c*, hsa-miR-130b*, hsa-miR-361-5p, hsa-miR-874, hsa-miR-374a, hsa-miR-32*, hsa-miR-335*, hsa-miR-100, hsa-miR-152, hsa-miR-652, hsa-miR-193a-5p, hsa-miR-34a, hsa-miR-10b, hsa-miR-15a, hsa-miR-106b, hsa-miR-574-3p, hsa-miR-455-3p, hsa-miR-499-5p, hsa-miR-335, hsa-miR-151:9.1, hsa-miR-23b*, hsa-miR-185, hsa-miR-941, hsa-miR-331-3p, hsa-miR-550, hsa miR-330-3p, hsa-miR-421, hsa-miR-744, hsa-let-7f-1*, hsa-miR-629, hsa-miR-433, hsa-miR-505*, hsa-miR-22*, hsa-miR-130b, hsa-miR-345, hsa-miR-532-3p, hsa-miR-542-5p, hsa-miR-339-5p, hsa-miR-193b, hsa-let-7d*, hsa-miR-199b-5p, hsa-miR-409-3p, hsa miR-148b, hsa-miR-190b, hsa-miR-18a, hsa-miR-29a*, hsa-miR-409-5p, hsa-miR-197, hsa-miR-708, hsa-miR-99a, hsa-miR-576-5p, hsa-miR-629*, hsa-miR-502-3p, hsa-miR-500*, hsa-miR-501-3p, hsa-miR-128, hsa-miR-19b-1*, hsa-miR-27b*, HS_{—}194, hsa-miR-92b, hsa-miR-130a, hsa-miR-577, HS_{—}108.1, hsa-miR-30e, hsa-miR-26a-1*, hsa-miR-32, hsa-miR-132*, hsa-miR-511, hsa-miR-145*, hsa-miR-221*, hsa-miR-454, hsa-miR-212, hsa-miR-34c-5p, hsa-miR-99b, hsa-miR-192*, hsa-miR-486-5p, hsa-miR-148a*, hsa-miR-30a, hsa-miR-16-2*, hsa-miR-107, hsa-miR-17*, hsa-miR-127-3p, hsa-let-7g*, hsa-miR-135a, hsa-miR-133a, hsa-miR-181a-2*, hsa-miR-101, hsa-miR-378*, hsa-miR-34a*, solexa-2580-353, hsa-miR-660, hsa-miR-154*, hsa-miR-497, hsa-miR-655, hsa-miR-144*, hsa-miR-362-5p, hsa-miR-339-3p, solexa-3126-285, hsa-miR-29c*, hsa-miR-30c-2*, hsa-miR-766, hsa-miR-26a-2*, hsa-miR-425*, hsa-miR-329, hsa-miR-323-3p, hsa-miR-338-3p, hsa-miR-186, hsa-miR-33b, hsa-miR-214*, hsa-miR-340, hsa-let-7i*, hsa-miR-598, hsa-miR-26b*, hsa-miR-125b-2*, hsa-miR-29b-2*, hsa-miR-411, hsa-miR-487b, hsa-miR-361-3p, hsa-miR-181c, hsa-miR-628-3p, hsa-miR-326, hsa-miR-139-5p, HS_{—}209.1, hsa-miR-642, hsa-miR-616*, hsa-miR-505, hsa-miR-365, hsa-miR-656, hsa-miR-154, hsa-miR-20b, hsa-miR-363, hsa-miR-340*, hsa-let-7a*, hsa-miR-582-5p, hsa-miR-328, hsa-miR-337-3p, hsa-miR-30a*, hsa-miR-9, hsa-miR-24-1*, hsa-miR-187, hsa-miR-149, hsa-miR-142-5p, hsa-miR-101*, hsa-miR-1, hsa-miR-133b, hsa-miR-490-3p, hsa-let-7f, hsa-miR-15b, hsa-miR-199a*:9.1, and hsa-miR-30din the biological samples of the subject is indicative of the presence of sporadic MSI tumor.

16. The method of claim 11, wherein the biological sample is a tissue sample, a fecal sample or a blood sample.

17. A method for confirming a diagnosis of one or more tumors characterized by DNA mismatch repair (MMR) deficiency in a human subject comprising the steps of:
identifying the human subject diagnosed of having the tumor characterized by the MMR deficiency; and
confirming the diagnosis of the tumor by a method comprising the steps of:
obtaining one or more biological samples from the subject, wherein the biological samples are selected from the group consisting of a tissue sample, a fecal sample, a cell homogenate, and one or more biological fluids comprising blood, plasma, lymph, urine, cerebrospinal fluid, amniotic fluid, pus or tears;
analyzing for a presence, a level or both of one or more genes associated with the MMR deficiency in the biological samples of the subject, wherein the genes are selected from the group consisting of MLH1, MSH2, MSH6, and PMS2;
comparing the results of the analysis with a first panel of markers, wherein the first set comprises BAT25, BAT26, D2S123, D5S346, and D17S250;
comparing the results of the analysis with a second panel of markers, wherein the second set comprises BAT25, BAT26, NR21, NR24, and NR27; and
determining the presence of the MMR deficiency by comparison of the results of the biological sample analysis with the first and second panel of markers, wherein a presence of ≧2 markers in the first panel and ≧3 markers in the second panel confirms the presence of the tumor characterized by MMR deficiency.

18. The method of claim 16, wherein the tumors characterized by the MMR deficiency comprise Lynch syndrome or sporadic microsatellite instability (MSI) tumor.

19. The method of claim 16, wherein an absence of one or more genes associated with the MMR deficiency in the tissue samples confirms the presence of a microsatellite stable (MSS) tumor.

20. The method of claim 16, wherein the biological sample is a tissue sample, a fecal sample or a blood sample.

21. A method for distinguishing between one or more types of colorectal cancers (CRC), wherein the CRCs comprise microsatellite instability (MSI) tumor and microsatellite stable (MSS) tumors in a human subject comprising the steps of:
identifying the human subject having the MSI or the MSS tumor;
obtaining one or more biological samples from the subject, wherein the biological samples are selected from the group consisting of a tissue sample, a fecal sample, a cell homogenate, and one or more biological fluids comprising blood, plasma, lymph, urine, cerebrospinal fluid, amniotic fluid, pus or tears; and
determining a differential expression signature for one or more MicroRNAs (miRNAs) in the biological sample using a microarray, wherein the one or more miRNAs are selected from the group consisting of, hsa-miR-938, hsa-miR-615-5p, hsa-miR-1184, hsa-miR-551a, hsa-miR-622, hsa-miR-17-5p:9.1, hsa-miR-192*, hsa-miR-337-3p, hsa-miR-338-3p, hsa-miR-187, hsa-miR-224, hsa-miR-411, hsa-miR-362-5p, hsa-miR-891a, hsa-miR-16-2*, hsa-miR-214*, hsa-miR-335*, hsa-miR-30a*, hsa-miR-30a, hsa-miR-660, hsa-miR-26a-2*, hsa-miR-199b-5p, hsa-miR-361-3p, hsa-miR-1, hsa-miR-497, hsa-miR-99a, hsa-miR-542-5p, hsa-miR-29b-1*, hsa-miR-328, hsa-miR-152, hsa-miR-133b, hsa-miR-146a, hsa-miR-432, hsa-miR-490-3p, hsa-miR-20a*, hsa-miR-200c*, hsa-miR-106a, hsa-miR-331-3p, hsa-miR-642, hsa-miR-139-5p, hsa-miR-424*, hsa-miR-149, hsa-miR-592, hsa-miR-339-3p, hsa-miR-502-3p, hsa-miR-500*, hsa-miR-26b*, hsa-miR-154, hsa-miR-181a-2*, hsa-miR-34a*, hsa-miR-409-3p, hsa-miR-532-5p, hsa-miR-106b, hsa-miR-203, hsa-miR-145*, hsa-miR-455-3p, hsa-miR-132*, hsa-miR-133a, hsa-miR-196b, and hsa-miR-550, wherein an upregulation, a downregulation or both of the one or more miRNAs in the biological samples of the subject is indicative of the presence of a MSI or a MSS tumor.

22. The method of claim 21, wherein the upregulation of 10, 20, 30, 40, 50 or more miRNAs selected from the group consisting of solexa-9578-86, solexa-7764-108, solexa-5874-144, hsa-miR-940, hsa-miR-938, hsa-miR-936, hsa-miR-920, hsa-miR-890, hsa-miR-888, hsa-miR-887, hsa-miR-876-5p, hsa-miR-876-3p, hsa-miR-875-5p, hsa-miR-873, hsa-miR-769-5p, hsa-miR-7-2*, hsa-miR-7-1*, hsa-miR-657, hsa-miR-654-3p, hsa-miR-653:9.1, hsa-miR-653, hsa-miR-646, hsa-miR-641, hsa-miR-632, hsa-miR-625*, hsa-miR-625, hsa-miR-623, hsa-miR-622, hsa-miR-620, hsa-miR-618, hsa-miR-617, hsa-miR-615-5p, hsa-miR-609, hsa-miR-607, hsa-miR-602, hsa-miR-596, hsa-miR-590-3p, hsa-miR-583, hsa-miR-578, hsa-miR-573, hsa-miR-567, hsa-miR-563, hsa-miR-551a, hsa-miR-550*, hsa-miR-548j, hsa-miR-548g, hsa-miR-548c-3p, hsa-miR-548b-3p, hsa-miR-548a-3p, hsa-miR-525-5p, hsa-miR-525-3p, hsa-miR-522, hsa-miR-520e, hsa-miR-518f, hsa-miR-518e:9.1, hsa-miR-518d-3p, hsa-miR-518c*, hsa-miR-518b, hsa-miR-518a-5p, hsa-miR-527, hsa-miR-517c, hsa-miR-517a, hsa-miR-517*, hsa-miR-516a-5p hsa-miR-516a-3p, hsa-miR-516b*, hsa-miR-515-3p, hsa-miR-513a-5p, hsa-miR-512-5p, hsa-miR-512-3p, hsa-miR-508-5p, hsa-miR-488*, hsa-miR-485-5p, hsa-miR-450b-3p, hsa-miR-449b, hsa-miR-423-5p, hsa-miR-412, hsa-miR-411*, hsa-miR-384, hsa-miR-380*, hsa-miR-380, hsa-miR-376b, hsa-miR-372, hsa-miR-371-5p, hsa-miR-371-3p, hsa-miR-369-5p, hsa-miR-367*, hsa-miR-346, hsa-miR-33b*, hsa-miR-33a*, hsa-miR-325, hsa-miR-30d*, hsa-miR-302d, hsa-miR-302c*, hsa-miR-302b*, hsa-miR-302b, hsa-miR-302a*, hsa-miR-300, hsa-miR-298, hsa-miR-297, hsa-miR-25*, hsa-miR-222*, hsa-miR-220c hsa-miR-218-1*, hsa-miR-216b, hsa-miR-202*:9.1, hsa-miR-202*, hsa-miR-19b-2*, hsa-miR-19a*, hsa-miR-196a*, hsa-miR-190, hsa-miR-18b*, hsa-miR-187*, hsa-miR-146b-3p, hsa-miR-144:9.1, hsa-miR-138-2*, hsa-miR-135a*, hsa-miR-1324, hsa-miR-1323, hsa-miR-1321, hsa-miR-130a*, hsa-miR-1305, hsa-miR-1304, hsa-miR-1297, hsa-miR-1289, hsa-miR-1286, hsa-miR-1284, hsa-miR-1267, hsa-miR-1263, hsa-miR-1262, hsa-miR-1257, hsa-miR-1254, hsa-miR-124a:9.1, hsa-miR-1243, hsa-miR-1238, hsa-miR-1233, hsa-miR-1226, hsa-miR-1225-5p, hsa-miR-1224-3p, hsa-miR-1208, hsa-miR-1206, hsa-miR-1205, hsa-miR-1184, hsa-miR-1183, hsa-miR-1181, hsa-miR-1180, hsa-miR-1179, HS_{—}97, HS_{—}93, HS_{—}9, HS_{—}85.1, HS_{—}52, HS_{—}48.1, HS_{—}303_a, HS_{—}280_a, HS_{—}279_a, HS_{—}268, HS_{—}264.1, HS_{—}25, HS_{—}244, HS_{—}239, HS_{—}231, HS_{—}228.1, HS_{—}219, HS_{—}216, HS_{—}203, HS_{—}202.1, HS_{—}199, HS_{—}19, HS_{—}176, HS_{—}170, HS_{—}160, HS_{—}145.1, HS_{—}138, HS_{—}128, HS_{—}122.1, HS_{—}121, HS_{—}119, HS_{—}114, HS_{—}106, HS_{—}105, HS_{—}101, and hsa-miR-1228* in the biological samples of the subject is indicative of the presence of the MSI tumor.

23. The method of claim 21, wherein the downregulation of 10, 20, 30, 40, 50 or more miRNAs selected from the group consisting of solexa-51-13984, solexa-499-2217, solexa-3126-285, solexa-2580-353, hsa-miR-99b, hsa-miR-99a, hsa-miR-96, hsa-miR-92a-1*, hsa-miR-891a, hsa-miR-886-3p, hsa-miR-874, hsa-miR-768-5p:11.0, hsa-miR-768-3p:11.0, hsa-miR-708, hsa-miR-675, hsa-miR-660, hsa-miR-652, hsa-miR-642, hsa-miR-638, hsa-miR-629*, hsa-miR-628-3p, hsa-miR-603, hsa-miR-598, hsa-miR-592, hsa-miR-582-5p, hsa-miR-577, hsa-miR-574-3p, hsa-miR-566, hsa-miR-558, hsa-miR-552, hsa-miR-548d-5p, hsa-miR-542-5p, hsa-miR-532-5p, hsa-miR-532-3p, hsa-miR-503, hsa-miR-502-3p, hsa-miR-500*, hsa-miR-501-3p, hsa-miR-500, hsa-miR-499-5p, hsa-miR-497, hsa-miR-494, hsa-miR-492, hsa-miR-490-5p, hsa-miR-490-3p, hsa-miR-455-3p, hsa-miR-454, hsa-miR-450b-5p, hsa-miR-450a, hsa-miR-432, hsa-miR-429, hsa-miR-425, hsa-miR-424*, hsa-miR-424, hsa-miR-421, hsa-miR-411, hsa-miR-409-3p, hsa-miR-378, hsa-miR-374a, hsa-miR-370, hsa-miR-365, hsa-miR-362-5p, hsa-miR-361-5p, hsa-miR-361-3p, hsa-miR-34c-5p, hsa-miR-34a*, hsa-miR-34a, hsa-miR-342-5p, hsa-miR-339-3p, hsa-miR-338-3p, hsa-miR-337-3p, hsa-miR-335*, hsa-miR-331-3p, hsa-miR-328, hsa-miR-326, hsa-miR-32*, hsa-miR-30e*, hsa-miR-30e, hsa-miR-30a*, hsa-miR-30a, hsa-miR-29c*, hsa-miR-29b-2*, hsa-miR-29b-1*, hsa-miR-29a*, hsa-miR-28-3p, hsa-miR-27b, hsa-miR-26b*, hsa-miR-26a-2*, hsa-miR-26a-1*, hsa-miR-24-1*, hsa-miR-224, hsa-miR-22, hsa-miR-215, hsa-miR-214*, hsa-miR-212, hsa-miR-20b, hsa-miR-20a*, hsa-miR-203, hsa-miR-200c*, hsa-miR-19b, hsa-miR-199b-5p, hsa-miR-198, hsa-miR-196b, hsa-miR-196a, hsa-miR-195, hsa-miR-193b, hsa-miR-193a-5p, hsa-miR-192*, hsa-miR-192, hsa-miR-191, hsa-miR-187, hsa-miR-186, hsa-miR-185, hsa-miR-181c, hsa-miR-181b, has, miR-181a-2*, hsa-miR-181a, hsa-miR-17-5p:9.1, hsa-miR-17, hsa-miR-16-2*, hsa-miR-15a, hsa-miR-154, hsa-miR-152, hsa-miR-151-3p, hsa-miR-151:9.1, hsa-miR-149, hsa-miR-148b, hsa-miR-146b-5p, hsa-miR-146a, hsa-miR-145*, hsa-miR-143*, hsa-miR-139-5p, hsa-miR-135b, hsa-miR-134, hsa-miR-133b, hsa-miR-133am, hsa-miR-132*, hsa-miR-132, hsa-miR-130b, hsa-miR-130a, hsa-miR-1291, hsa-miR-128, hsa-miR-1275, hsa-miR-127-3p, hsa-miR-125b-2*, hsa-miR-125a-5p, hsa-miR-1248, hsa-miR-10b, hsa-miR-10a, hsa-miR-106b, hsa-miR-106a:9.1, hsa-miR-106a, hsa-miR-101, hsa-miR-100, hsa-miR-1, hsa-let-7f-1*, hsa-let-7d, hsa-let-7c, HS_{—}76, HS_{—}31.1, HS_{—}303_b, HS_{—}287, HS_{—}282, HS_{—}257, HS_{—}221, HS_{—}209.1, HS_{—}192.1, HS_{—}147, hsa-miR-30d, hsa-miR-200a, hsa-miR-199a*:9.1, hsa-miR-126, and hsa-let-7g in the biological samples of the subject is indicative of the presence of MSI tumor.

24. The method of claim 21, wherein the biological sample is a tissue sample, a fecal sample or a blood sample.

25. A system for diagnosing a colorectal cancer (CRC) in a human subject comprising: a microRNA (miRNA) microarray comprising a plurality of miRNA probes on a solid support, wherein the miRNA probes detect an expression pattern of one or more complementary miRNAs in a tissue sample, a fecal sample, a blood sample, or all of a subject suspected of having the CRC.

26. The system of claim 25, wherein an upregulation, a downregulation or both of 10, 20, 30, 40, 50 or more miRNAs selected from the group consisting of HS_{—}78, hsa-miR-1826, hsa-miR-647, hsa-miR-603, hsa-miR-622, HS_{—}33, HS_{—}19, hsa-miR-300, HS_{—}111, hsa-miR-1238, hsa-miR-1290, HS_{—}276.1, hsa-miR-544, HS_{—}79.1, solexa-4793-177, hsa-miR-196a*, solexa-8048-104, HS_{—}149, hsa-miR-938, HS_{—}239, hsa-miR-1321, hsa-miR-1183, hsa-miR-583, hsa-miR-302b*, solexa-9578-86, HS_{—}128, hsa-miR-220b, HS_{—}22.1, hsa-miR-1184, solexa-7764-108, hsa-miR-940, hsa-miR-923, hsa-miR-1228*, HS_{—}120, hsa-miR-18b*, solexa-9655-85, hsa-miR-801:9.1, hsa-miR-302d, HS_{—}72, HS_{—}38.1, hsa-miR-512-5pm, HS_{—}215, hsa-miR-31, hsa-miR-423-5p, hsa-miR-576-3p, hsa-miR-612, HS_{—}43.1, hsa-miR-7-1*, hsa-miR-346, hsa-miR-1268, hsa-miR-892a, HS_{—}208, hsa-miR-623, HS_{—}86, HS_{—}170, hsa-miR-563, hsa-miR-1181, hsa-miR-1289, HS_{—}241.1, hsa-miR-183*, hsa-miR-1269, HS_{—}9, hsa-miR-512-3p, hsa-miR-587, HS_{—}202.1, HS_{—}37, hsa-miR-936, hsa-miR-1231, HS_{—}250, hsa-miR-202*:9.1, HS_{—}254, hsa-miR-518b, hsa-miR-19a*, HS_{—}116, hsa-miR-450b-3p, HS_{—}48.1, hsa-miR-591, hsa-miR-25*, hsa-miR-665, hsa-miR-654-3p, HS_{—}74, HS_{—}217, HS_{—}71.1, hsa-miR-550*, hsa-miR-1291, hsa-miR-371-3p, hsa-miR-1245, hsa-miR-520e, hsa-miR-135a*, HS_{—}51, hsa-miR-298, HS_{—}228.1, solexa-15-44487, HS_{—}110, hsa-miR-1255b, hsa-miR-1285, HS_{—}44.1, HS_{—}29, hsa-miR-198, hsa-miR-551a, solexa-9081-91, HS_{—}35, HS_{—}167.1, hsa-miR-1225-5p, HS_{—}56, hsa-miR-654-5p, hsa-miR-1207-3p, hsa-miR-631, hsa-miR-920, hsa-miR-515-3p, hsa-miR-661, hsa-miR-508-5p, hsa-miR-566, solexa-8926-93, HS_{—}65, hsa-miR-218-2*, HS_{—}2, hsa-miR-509-5p, hsa-miR-1254, HS_{—}163, hsa-miR-135b*, HS_{—}205.1, hsa-miR-31*, hsa-miR-1273, HS_{—}106, HS_{—}4.1, HS_{—}23, hsa-miR-1304, HS_{—}139, HS_{—}287, HS_{—}46, HS_{—}155, hsa-miR-187*, hsa-miR-193b*, HS_{—}147, HS_{—}187, HS_{—}17, HS_{—}87, hsa-miR-935, HS_{—}244, hsa-miR-1197, HS_{—}216, solexa-9124-90, hsa-miR-1324, hsa-miR-548g, hsa-miR-619, hsa-miR-302b, hsa-miR-632, hsa-miR-380*, hsa-miR-572, hsa-miR-668, hsa-miR-767-3p, hsa-miR-520d-5p, hsa-miR-1248, hsa-miR-380, HS_{—}101, HS_{—}150, solexa-578-1915, hsa-miR-549, HS_{—}189.1, HS_{—}80, HS_{—}264.1, hsa-miR-614, HS_{—}76, HS_{—}21, hsa-miR-182*, hsa-miR-1182, HS_{—}126, hsa-miR-1244, hsa-miR-1250, hsa-miR-602, hsa-miR-518a-5p, hsa-miR-527, hsa-miR-518f, hsa-miR-124a:9.1, hsa-miR-944, hsa-miR-517*, HS_{—}109, hsa-miR-1303, HS_{—}94, hsa-miR-1247, hsa-miR-588, hsa-miR-675, hsa-miR-645, hsa-miR-1300, hsa-miR-767-5p, hsa-miR-1180, HS_{—}68, hsa-miR-1204, hsa-miR-560:9.1, solexa-3044-295, hsa-miR-1295, hsa-miR-616, HS_{—}206, HS_{—}58, hsa-miR-671:9.1, solexa-5620-151, hsa-miR-519d, solexa-826-1288, hsa-miR-608, hsa-miR-509-3p, HS_{—}45.1, HS_{—}32, HS_{—}174.1, HS_{—}200, HS_{—}243.1, HS_{—}284.1, HS_{—}89, HS_{—}77, hsa-miR-1234, HS_{—}242, hsa-miR-663b, solexa-2952-306, hsa-miR-1274a, hsa-miR-890, hsa-miR-1243, hsa-miR-95, solexa-555-1991, hsa-miR-222*, HS_{—}121, hsa-miR-554, hsa-miR-1246, hsa-miR-1207-5p, solexa-3927-221, HS_{—}100, hsa-miR-574-5p, hsa-miR-1202, HS_{—}199, hsa-miR-1260, hsa-miR-943, HS_{—}262.1, solexa-5169-164, hsa-miR-129*, hsa-miR-101*, hsa-miR-138, hsa-miR-598, hsa-miR-490-3p, hsa-miR-29b-2*, hsa-miR-365, hsa-miR-30c-2*, hsa-miR-133b, hsa-miR-133a, hsa-miR-551b, hsa-miR-192*, hsa-miR-33′7-3p, hsa-miR-125b-2*, hsa-miR-20b*, hsa-miR-137, hsa-miR-214*, hsa-miR-582-3p, hsa-miR-132*, hsa-miR-582-5p, hsa-miR-24-1*, hsa-miR-130a, hsa-miR-149, hsa-miR-1, hsa-miR-656, hsa-miR-139-5p, hsa-miR-490-5p, hsa-miR-181c, hsa-miR-30a*, hsa-miR-187, hsa-miR-33b, hsa-miR-145*, hsa-miR-20b, hsa-miR-340, HS_{—}209.1, hsa-miR-363, hsa-miR-570, hsa-miR-9, hsa-miR-340*, hsa-miR-497, hsa-miR-579, hsa-miR-545, hsa-miR-744*, hsa-miR-30e, hsa-miR-142-5p, hsa-let-71*, hsa-miR-323-3p, hsa-miR-642, hsa-miR-99a, hsa-miR-195*, hsa-miR-181a-2*, hsa-miR-26b*, hsa-miR-362-5p, hsa-miR-885-5p, hsa-miR-26a-1*, hsa-miR-628-3p, hsa-miR-136, hsa-miR-148b, hsa-let-7g*, hsa-miR-135a, hsa-miR-338-3p, hsa-miR-376a*, hsa-miR-454, hsa-miR-106b, hsa-miR-154*, hsa-let-7f-1*, hsa-miR-148a*, hsa-miR-27b*, hsa-miR-381, hsa-miR-212, hsa-miR-153, hsa-miR-34a*, hsa-miR-577, hsa-miR-144*, hsa-miR-127-5p, hsa-miR-411, hsa-miR-590-3p, hsa-miR-519a, hsa-miR-487b, hsa-miR-455-3p, hsa-miR-345, hsa-miR-199b-5p, hsa-miR-92b, hsa-let-7e*, hsa-miR-361-3p, hsa-miR-548p hsa-miR-502-3p, hsa-miR-500*, hsa-miR-186, hsa-miR-151:9.1, hsa-miR-30a, hsa-miR-221*, hsa-miR-9*, hsa-miR-136*, hsa-miR-26a-2*, hsa-miR-143*, hsa-miR-140-5p, hsa-miR-189:9.1, hsa-miR-130b, hsa-miR-374a, hsa-miR-128, hsa-miR-616*, solexa-3126-285, hsa-miR-766, hsa-miR-548e, hsa-miR-154, hsa-miR-486-5p, hsa-miR-597, HS_{—}194, hsa-miR-361-5p, hsa-miR-421, hsa-miR-127-3p, hsa-miR-195, hsa-miR-99a*, hsa-miR-337-5p, hsa-let-7a*, solexa-2580-353, hsa-miR-409-5p, hsa-miR-34b*, hsa-miR-16-2*, hsa-miR-30d*, hsa-miR-10b, hsa-miR-499-5p, hsa-miR-548c-5p, hsa-miR-148b*, hsa-miR-193a-3p, hsa-miR-342-3p, hsa-miR-410, hsa-miR-425*, hsa-miR-29c*, hsa-miR-495, hsa-miR-330-3p, hsa-miR-219-5p, hsa-miR-185, hsa-miR-329, hsa-miR-592, hsa-miR-433, hsa-miR-181c*, hsa-miR-193a-5p, hsa-miR-34c-5p, hsa-miR-124, HS_{—}49, HS_{—}282, hsa-miR-100, hsa-miR-299-5p, hsa-miR-128a:9.1, hsa-miR-455-5p, hsa-miR-101, hsa-miR-409-3p, hsa-miR-326, hsa-miR-379*, hsa-miR-328, hsa-miR-539, hsa-miR-331-3p, hsa-miR-1272, HS_{—}168, hsa-miR-374b*, hsa-miR-548m, hsa-miR-378*, hsa-miR-202*, hsa-miR-339-3p, hsa-miR-660, hsa-miR-576-5p, hsa-miR-296-5p, hsa-miR-451, hsa-miR-17*, hsa-miR-141*, hsa-miR-190b, hsa-miR-511, hsa-miR-20a*, hsa-miR-204, hsa-miR-1185, hsa-miR-624*, hsa-miR-655, hsa-miR-34b, hsa-miR-411*, hsa-miR-505, hsa-miR-15a, hsa-miR-454*, hsa-miR-22*, hsa-miR-18b, hsa-miR-144:9.1, hsa-miR-99b, hsa-miR-100*, hsa-miR-873, hsa-miR-10a*, hsa-miR-1537, hsa-miR-19b-1*, hsa-miR-505*, hsa-miR-29a*, hsa-miR-147, hsa-miR-485-3p, solexa-539-2056, hsa-miR-193b, HS_{—}42, hsa-miR-218, hsa-miR-19b, hsa-miR-106a:9.1, hsa-miR-378, hsa-miR-376c, hsa-miR-24-2*, hsa-miR-32, hsa-miR-197, hsa-miR-744, hsa-miR-7-2*, hsa-miR-335, hsa-miR-627, hsa-miR-139-3p, hsa-miR-629, hsa-miR-15b*, hsa-miR-107, hsa-miR-383, hsa-miR-147b, hsa-miR-19a, HS_{—}108.1, hsa-miR-301a, hsa-let-7b*, hsa-miR-345:9.1, hsa-miR-331-5p, hsa-miR-552, hsa-miR-1271, hsa-miR-550, hsa-miR-1296, HS_{—}20, hsa-miR-487a, hsa-miR-491-5p, solexa-3695-237, hsa-miR-374a*, solexa-7534-111, hsa-miR-128b:9.1, hsa-miR-188-3p, hsa-miR-33a, hsa-miR-129-3p, hsa-miR-23b*, hsa-miR-362-3p, hsa-miR-496, HS_{—}40, HS_{—}64, HS_{—}201, hsa-miR-1227, hsa-miR-125a-3p, hsa-miR-99b*, hsa-miR-542-3p, hsa-miR-142-3p, hsa-miR-571, hsa-miR-376a*:9.1, hsa-miR-493, solexa-2526-361, hsa-miR-585, hsa-miR-93*, hsa-miR-502-5p, hsa-miR-30e*, hsa-miR-145, hsa-miR-126, hsa-miR-222, hsa-let-7e, hsa-miR-30d, hsa-miR-28-5p, hsa-miR-30c, hsa-miR-199a*:9.1, hsa-miR-29c, HS_{—}275, hsa-miR-143, hsa-miR-125b, hsa-miR-26a, hsa-miR-141, hsa-miR-140-3p, hsa-miR-30b, and hsa-miR-338-5p in the tissue sample, fecal sample or both of the subject is indicative of the presence of the CRC.

27. The system of claim 25, wherein the CRC comprises Lynch syndrome, sporadic microsatellite instability (MSI) tumors or microsatellite stable (MSS) tumors.

28. A system for detecting one or more colorectal cancers (CRC) in a human subject suspected of having the CRC comprising: a microRNA (miRNA) microarray comprising a plurality of miRNA probes on a solid support, wherein the miRNA probes detect an expression pattern of one or more complementary miRNAs in a biological sample of the subject suspected of having the CRC.

29. The system of claim 28, wherein the biological sample is a tissue sample or a fecal sample.

30. The system of claim 28, wherein an upregulation, a downregulation or both of one or more miRNAs is indicative of the presence of the CRC.

31. The system of claim 28, wherein the CRC types comprise comprises Lynch syndrome, sporadic microsatellite instability (MSI) tumors or microsatellite stable (MSS) tumors.

32. A method of identifying a subject suspected of having Lynch syndrome comprising the steps of:
obtaining one or more biological samples from the subject, wherein the biological samples are selected from the group consisting of a tissue sample, a fecal sample, a cell homogenate, and one or more biological fluids comprising blood, plasma, lymph, urine, cerebrospinal fluid, amniotic fluid, pus or tears; and
determining a differential expression signature for one or more MicroRNAs (miRNAs) in the biological samples using a microarray, wherein the one or more miRNAs are selected from the group consisting of hsa-miR-30a*, hsa-miR-16-2*, hsa-miR-362-5p, hsa-miR-486-5p, hsa-miR-337-3p, hsa-miR-642, hsa-miR-411, hsa-miR-214*, hsa-miR-187, hsa-miR-628-3p, hsa-miR-142-5p, hsa-miR-29b-1*, hsa-miR-361-3p, hsa-miR-501-3p, hsa-miR-139-5p, hsa-miR-192*, hsa-miR-128, hsa-miR-29b-2*, hsa-miR-26b*, hsa-miR-432, hsa-miR-92b, hsa-miR-502-3p, hsa-miR-34a*, hsa-miR-200c*, hsa-miR-130b, hsa-miR-598, hsa-miR-151:9.1, hsa-miR-130b*, hsa-miR-421, hsa-miR-1238, and hsa-miR-622, wherein an upregulation, a downregulation or both of the one or more miRNAs is indicative of the presence of Lynch syndrome in the subject.

33. The method of claim 32, wherein the upregulation of 10, 20, 30, 40, 50 or more miRNAs selected from the group consisting of hsa-miR-198, hsa-miR-31*, hsa-miR-183*, hsa-miR-935, hsa-miR-183, hsa-miR-891a, hsa-miR-182, hsa-miR-1275, hsa-miR-886-3p, hsa-miR-155*, hsa-miR-503, hsa-miR-664, hsa-miR-424*, HS_{—}303_b, hsa-miR-18a*, hsa-miR-594:9.1, hsa-miR-452*:9.1, hsa-miR-223, hsa-miR-625*, hsa-miR-29b-1*, hsa-miR-17-5p:9.1, hsa-miR-196b, hsa-miR-151-3p, solexa-51-13984, hsa-miR-200b*, hsa-miR-342-5p, hsa-miR-425, hsa-miR-203, hsa-miR-768-5p:11.0, hsa-miR-200a*, hsa-miR-30e*, hsa-miR-942, hsa miR-28-5p, hsa-miR-429, hsa-miR-30c, hsa-miR-126, hsa-miR-486-3p, hsa-let-7d, hsa-miR-382, hsa-miR-92a-1*, hsa-miR-224, hsa-miR-222, hsa-let-7e, hsa-miR-181a, hsa-miR-146b-5p, hsa-let-7c, hsa-miR-450b-5p, hsa-miR-370, hsa-miR-450a, hsa-miR-146a, hsa-miR-223*, hsa-miR-501-5p, hsa-miR-106b*, hsa-miR-181b, hsa-miR-134, hsa-miR-98, hsa-miR-106a, hsa-miR-889, hsa-miR-96, hsa-miR-132, hsa-miR-195, hsa-miR-1237, hsa-miR-451, hsa-miR-628-5p, hsa-miR-532-5p, hsa-miR-342-3p, hsa-miR-558, hsa-miR-10a, hsa-miR-215, hsa-miR-210, hsa-miR-10a*, hsa-miR-424, hsa-miR-432, hsa-miR-125a-5p, hsa-miR-500, hsa-miR-200c*, hsa-miR-130b*, hsa-miR-361-5p, hsa-miR-874, hsa-miR-374a, hsa-miR-32*, hsa-miR-335*, hsa-miR-100, hsa-miR-152, hsa-miR-652, hsa-miR-193a-5p, hsa-miR-34a, hsa-miR-10b, hsa-miR-15a, hsa-miR-106b, hsa-miR-574-3p, hsa-miR-455-3p, hsa-miR-499-5p, hsa-miR-335, hsa-miR-151:9.1, hsa-miR-23b*, hsa-miR-185, hsa-miR-941, hsa-miR-331-3p, hsa-miR-550, hsa miR-330-3p, hsa-miR-421, hsa-miR-744, hsa-let-7f-1*, hsa-miR-629, hsa-miR-433, hsa-miR-505*, hsa-miR-22*, hsa-miR-130b, hsa-miR-345, hsa-miR-532-3p, hsa-miR-542-5p, hsa-miR-339-5p, hsa-miR-193b, hsa-let-7d*, hsa-miR-199b-5p, hsa-miR-409-3p, hsa miR-148b, hsa-miR-190b, hsa-miR-18a, hsa-miR-29a*, hsa-miR-409-5p, hsa-miR-197, hsa-miR-708, hsa-miR-99a, hsa-miR-576-5p, hsa-miR-629*, hsa-miR-502-3p, hsa-miR-500*, hsa-miR-501-3p, hsa-miR-128, hsa-miR-19b-1*, hsa-miR-27b*, HS_{—}194, hsa-miR-92b, hsa-miR-130a, hsa-miR-577, HS_{—}108.1, hsa-miR-30e, hsa-miR-26a-1*, hsa-miR-32, hsa-miR-132*, hsa-miR-511, hsa-miR-145*, hsa-miR-221*, hsa-miR-454, hsa-miR-212, hsa-miR-34c-5p, hsa-miR-99b, hsa-miR-192*, hsa-miR-486-5p, hsa-miR-148a*, hsa-miR-30a, hsa-miR-16-2*, hsa-miR-107, hsa-miR-17*, hsa-miR-127-3p, hsa-let-7g*, hsa-miR-135a, hsa-miR-133a, hsa-miR-181a-2*, hsa-miR-101, hsa-miR-378*, hsa-miR-34a*, solexa-2580-353, hsa-miR-660, hsa-miR-154*, hsa-miR-497, hsa-miR-655, hsa-miR-144*, hsa-miR-362-5p, hsa-miR-339-3p, solexa-3126-285, hsa-miR-29c*, hsa-miR-30c-2*, hsa-miR-766, hsa-miR-26a-2*, hsa-miR-425*, hsa-miR-329, hsa-miR-323-3p, hsa-miR-338-3p, hsa-miR-186, hsa-miR-33b, hsa-miR-214*, hsa-miR-340, hsa-let-7i*, hsa-miR-598, hsa-miR-26b*, hsa-miR-125b-2*, hsa-miR-29b-2*, hsa-miR-411, hsa-miR-487b, hsa-miR-361-3p, hsa-miR-181c, hsa-miR-628-3p, hsa-miR-326, hsa-miR-139-5p, HS_{—}209.1, hsa-miR-642, hsa-miR-616*, hsa-miR-505, hsa-miR-365, hsa-miR-656, hsa-miR-154, hsa-miR-20b, hsa-miR-363, hsa-miR-340*, hsa-let-7a*, hsa-miR-582-5p, hsa-miR-328, hsa-miR-337-3p, hsa-miR-30a*, hsa-miR-9, hsa-miR-24-1*, hsa-miR-187, hsa-miR-149, hsa-miR-142-5p, hsa-miR-101*, hsa-miR-1, hsa-miR-133b, hsa-miR-490-3p, hsa-let-7f, hsa-miR-15b, hsa-miR-199a*:9.1, and hsa-miR-30d in the biological samples of the subject is indicative of the presence of Lynch syndrome.

34. The method of claim 32, wherein the downregulation of 10, 20, 30, 40, 50 or more miRNAs selected from the group consisting of hsa-miR-938, hsa-miR-1238, hsa-miR-1183, hsa-miR-892a, hsa-miR-622, solexa-7764-108, hsa-miR-1290, hsa-miR-623, hsa-miR-302d, hsa-miR-18b*, hsa-miR-603, hsa-miR-520e, hsa-miR-1268, HS_{—}217, hsa-miR-202*:9.1, HS_{—}202.1, hsa-miR-512-5p, hsa-miR-612, HS_{—}215, hsa-miR-302b*, HS_{—}111, hsa-miR-1197, HS_{—}149, hsa-miR-346, hsa-miR-1181, HS_{—}33, hsa-miR-647, HS_{—}78, hsa-miR-632, hsa-miR-1304, HS_{—}228.1, HS_{—}116, HS_{—}241.1, HS_{—}72, hsa-miR-196a*, HS_{—}276.1, hsa-miR-1184, hsa-miR-1225-5p, HS_{—}17, hsa-miR-654-3p, hsa-miR-124a:9.1, HS_{—}74, hsa-miR-518b, HS_{—}120, hsa-miR-654-5p, HS_{—}44.1, HS_{—}239 hsa-miR-380*, hsa-miR-1321, solexa-9081-91, hsa-miR-631, hsa-miR-423-5p, hsa-miR-936, hsa-miR-550*, hsa-miR-7-1*, HS_{—}37, HS_{—}79.1, hsa-miR-19a*, HS_{—}86, solexa-578-1915, hsa-miR-450b-3p, HS_{—}9, HS_{—}250, HS_{—}56, HS_{—}208, HS_{—}205.1, HS_{—}128, HS_{—}170, HS_{—}38.1, hsa-miR-576-3p, hsa-miR-583, hsa-miR-923, hsa-miR-940, HS_{—}19, hsa-miR-300, solexa-9655-85, hsa-miR-130a*, HS_{—}106, HS_{—}23, hsa-miR-220b, hsa-miR-187*, hsa-miR-1255b, hsa-miR-515-3p, hsa-miR-1289, solexa-15-44487, hsa-miR-563, hsa-miR-661, HS_{—}264.1, hsa-miR-135a*, hsa-miR-587, hsa miR-548g, HS_{—}51, hsa-miR-512-3p, hsa-miR-1254, HS_{—}71.1, hsa-miR-920, hsa-miR-371-3p, hsa-miR-665, hsa-miR-591, HS_{—}176, HS_{—}188, HS_{—}139, HS_{—}244, HS_{—}12, hsa-miR-1204, solexa-9578-86, hsa-miR-298, hsa-miR-551a, hsa-miR-520d-5p, hsa-miR-508-5p, hsa-miR-1231, hsa-miR-302b, HS_{—}101, HS_{—}48.1, hsa-miR-1228*, hsa-miR-498, hsa-miR-602, HS_{—}150, HS_{—}80, hsa-miR-518d-3p, HS_{—}216, hsa-miR-222*, hsa-miR-890, hsa-miR-1297, HS_{—}52, hsa-miR-554, HS_{—}93, hsa-miR-1243, hsa-miR-1202, HS_{—}97, hsa-miR-518e:9.1, hsa-miR-372, HS_{—}121, hsa-miR-1205, HS_{—}122.1, hsa-miR-525-5p, solexa-555-1991, hsa-miR-302c*, hsa-miR-1262, hsa-miR-518c*, hsa-miR-1233, hsa-miR-888, hsa-miR-33a*, hsa-miR-146a*, hsa-miR-412, hsa-miR-615-5p, hsa-miR-367*, hsa-miR-146b-3p, hsa-miR-1257, hsa-miR-1286, hsa-miR-609, hsa-miR-643, hsa-miR-519b-3p, hsa-miR-657, hsa-miR-384, hsa-miR-887, HS_{—}113, hsa-miR-1284, HS_{—}138, HS_{—}25, hsa-miR-488*, HS_{—}152, hsa-miR-1208, HS_{—}219, hsa-miR-607, hsa-miR-516a-3p, hsa-miR-516b*, hsa-miR-369-5p, hsa-miR-548b-3p, hsa-miR-548a-3p, hsa-miR-567, hsa-miR-1267, hsa-miR-578, HS_{—}184, hsa-miR-1206, hsa-miR-620, hsa-miR-186*, hsa-miR-596, hsa-miR-548c-3p, hsa-miR-1224-3p, hsa-miR-19b-2*, hsa-miR-218-1*, hsa-miR-1323, hsa-miR-876-3p, hsa-miR-1305, hsa-miR-1225-3p, hsa-miR-504, hsa-miR-650, hsa-miR-1179, hsa-miR-190, hsa-miR-376c, HS_{—}168, hsa-miR-144:9.1, hsa-miR-1826, and hsa-miR-544 in the biological samples of the subject is indicative of the presence of Lynch syndrome.

35. The method of claim 32, wherein the subject suspected of having Lynch syndrome may or may not demonstrate germline mutations in one or more DNA mismatch repair (MMR) genes.

36. The method of claim 32, wherein the biological sample is a tissue sample, a fecal sample or a blood sample.
